(19) United States
(12) Patent Application Publication
(10) Pub. No.: US 2014/0214709 A1
(43) Pub. Date: Jul. 31, 2014

(54) OCCUPATIONAL PERFORMANCE ASSESSMENT APPARATUSES, METHODS AND SYSTEMS

(71) Applicant: Assessment Innovation, Inc., New York, NY (US)

(72) Inventor: Kevin Gerard Greaney, New York, NY (US)

(73) Assignee: Assessment Innovation, Inc., New York, NY (US)

(21) Appl. No.: 14/149,668

(22) Filed: Jan. 7, 2014

Related U.S. Application Data
(60) Provisional application No. 61/749,894, filed on Jan. 7, 2013.
(60) Provisional application No. 61/890,155, filed on Oct. 11, 2013.
(60) Provisional application No. 61/913,758, filed on Dec. 9, 2013.

(51) Int. Cl. G06Q 10/10; G06F 19/00

(52) U.S. Cl. CPC G06Q 10/1053; G06F 19/363
USPC 705/321

(57) ABSTRACT

The OCCUPATIONAL PERFORMANCE ASSESSMENT APPARATUSES, METHODS AND SYSTEMS (“OPA”) transforms candidates occupational test answers and employers occupational goal inputs via OPA test intake, assessment and score components, into candidates occupational assessment outputs. In one embodiment, the OPA provides a computer-delivered technology-driven systems approach for occupational psychological assessment for talent identification, acquisition, management and support, which adapts to a user's responses to provide an individualized evaluation. The OPA may also be integrated with mobile technology and multi-touch interfaces.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY Claim

Applicant hereby claims priority under 35 USC §119 to provisional US patent applications Ser. No. 61/749,894, filed Jan. 7, 2013, entitled “OCCUPATIONAL PERFORMANCE ASSESSMENT APPARATUSES, METHODS AND SYSTEMS,” attorney docket no. ASIN-001/00US 318628-2001, and Ser. No. 61/890,155, filed Oct. 11, 2013, entitled “OCCUPATIONAL PERFORMANCE ASSESSMENT APPARATUSES, METHODS AND SYSTEMS,” attorney docket no. ASIN-001/01US 318628-2002, and Ser. No. 61/913,758, filed Dec. 9, 2013, entitled “OCCUPATIONAL PERFORMANCE ASSESSMENT APPARATUSES, METHODS AND SYSTEMS,” attorney docket no. ASIN-001/02US 318628-2003. The entire contents of the aforementioned applications are herein expressly incorporated by reference.

### FIELD

The present innovations generally address testing, and more particularly, include OCCUPATIONAL PERFORMANCE ASSESSMENT APPARATUSES, METHODS AND SYSTEMS.

### BACKGROUND

Cognitive psychology explores how people perceive, think, and solve problems. When hiring job candidates, employers review resumes and conduct interviews to assess candidates' qualifications.

### BRIEF DESCRIPTION OF THE DRAWINGS

The accompanying appendices and/or drawings illustrate various non-limiting, example, innovative aspects in accordance with the present descriptions:

FIG. 1A shows a logic flow diagram illustrating some embodiments of the OPA.

FIG. 1B shows a block diagram illustrating employer initiated assessment embodiments of the OPA.

FIGS. 1C-1E show screenshots of some illustrating reporting user interface in some embodiments of the OPA.

FIG. 2 shows a block diagram illustrating candidate initiated assessment embodiments of the OPA.

FIGS. 3A-3B shows logic flow diagrams illustrating employer and candidate initiated assessment embodiments of the OPA.

FIG. 4A shows a screenshot diagram illustrating motivational orientation attribute measurement user-interface of the OPA.

FIGS. 4B-C show exemplary tests in measuring the executive functioning attribute in some embodiments of the OPA.

FIGS. 4D-4E show exemplary tests in measuring the problem solving attribute in some embodiments of the OPA.

FIG. 4F shows a solution to the 4-disk Tower of Hanoi Task.

FIG. 4G shows an example interaction of critical thinking skills and means for their evaluation, in measuring the critical thinking attribute in some embodiments of the OPA.

FIG. 4H shows an example of the Wason Selection Trask in measuring the reasoning and bias attributes in some embodiments of the OPA.

FIG. 4I shows an exemplary test in measuring the search and recognition attributes in some embodiments of the OPA.

FIG. 4J shows a multiple flight path simulation from an air-traffic-control simulation game.

FIGS. 5A-5C show example gamification integrated assessment in some embodiments of the OPA.

FIG. 6 shows a block diagram illustrating an example response-to-feedback assessment mechanism in some embodiments of the OPA.

FIG. 7 shows a block diagram illustrating an example cognitive accessibility assessment mechanism in some embodiments of the OPA.

FIG. 8 shows a block diagram illustrating an example implicit assessment mechanism in some embodiments of the OPA.

FIG. 9 shows a block diagram illustrating an example attention probe assessment mechanism in some embodiments of the OPA;

FIGS. 10A-10E show screenshots of mobile implementation in some embodiments of the OPA;

FIG. 11 shows a block diagram illustrating embodiments of a OPA controller;

FIGS. 12-17 show question samples in assessing continuous performance attribute in some embodiments of the OPA.

FIGS. 18-32 show question samples in assessing belief and bias attribute in some embodiments of the OPA.

FIGS. 33-53 show question samples in assessing illusory correlation attribute in some embodiments of the OPA.

FIGS. 54-57 show question samples in assessing outcome bias attribute in some embodiments of the OPA.

FIG. 58 shows a question sample in assessing fairness attribute in some embodiments of the OPA;

FIGS. 59-63 show question samples in assessing ethical behavior attribute in some embodiments of the OPA;

FIGS. 64-72 show question samples in assessing regulatory focus attribute in some embodiments of the OPA;

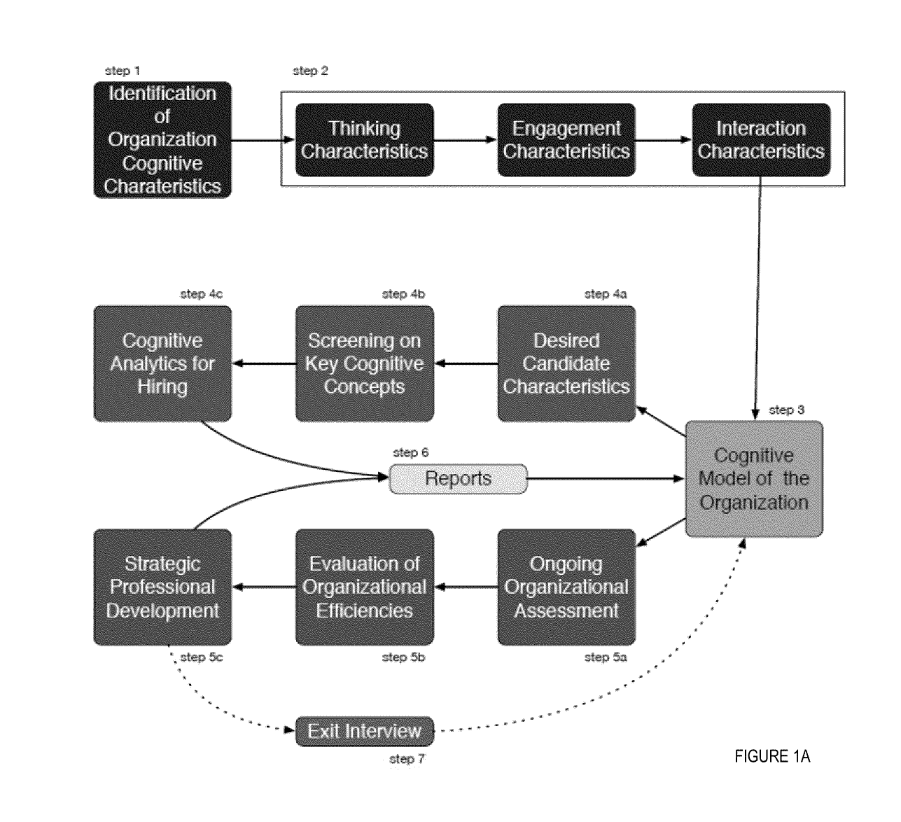

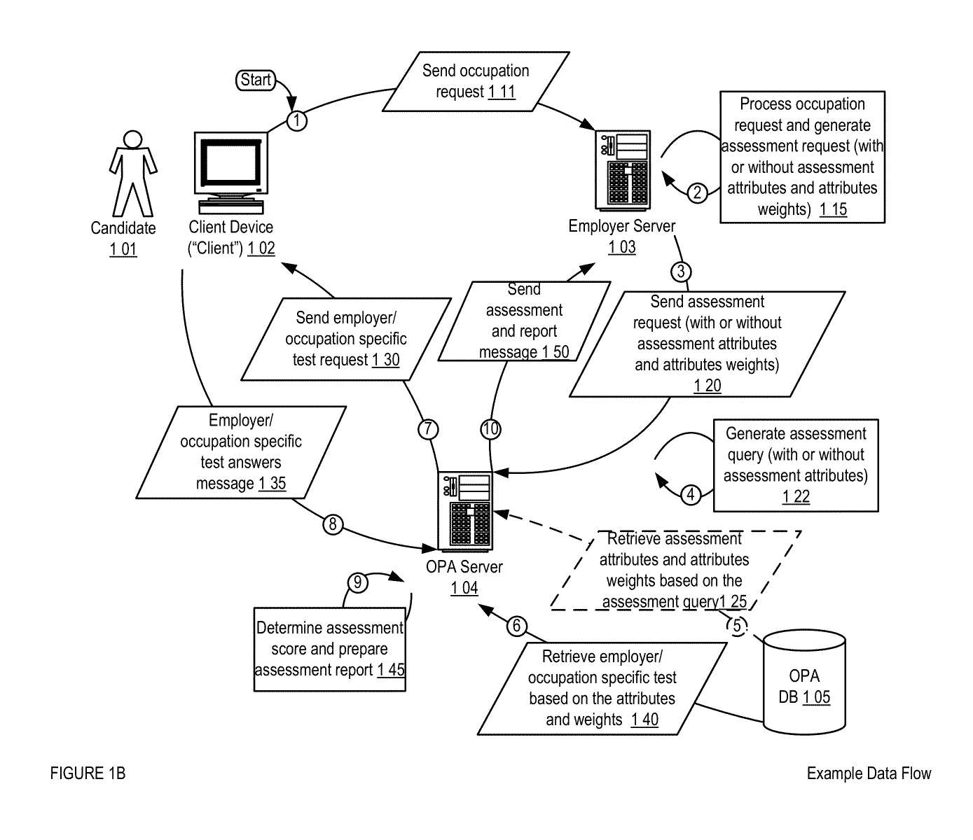

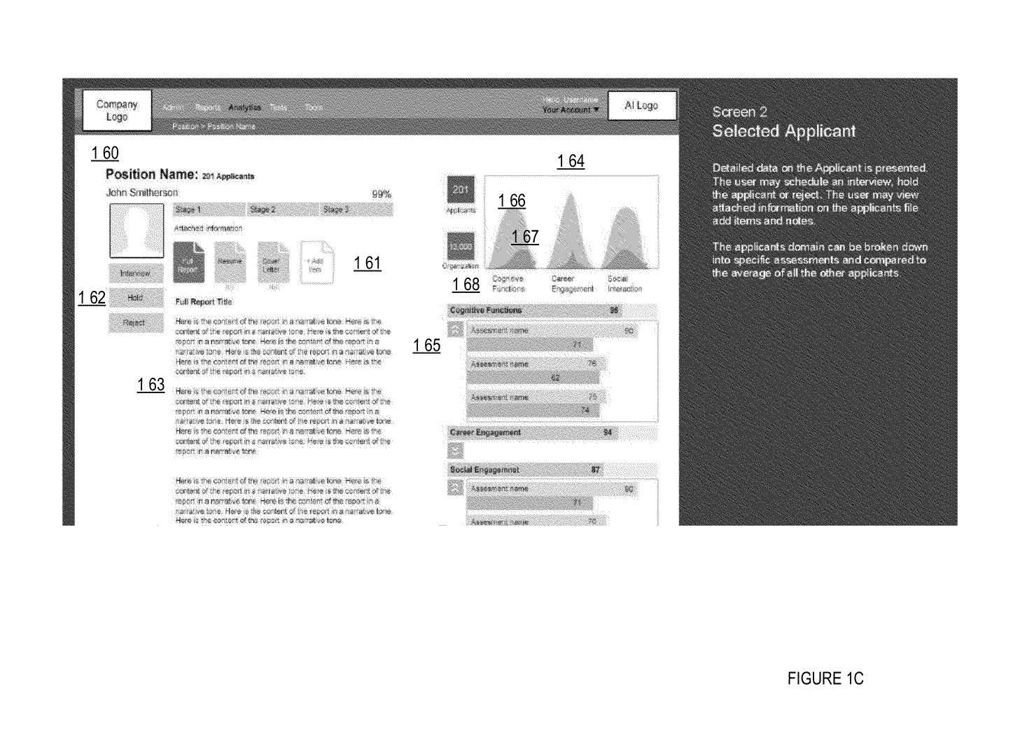

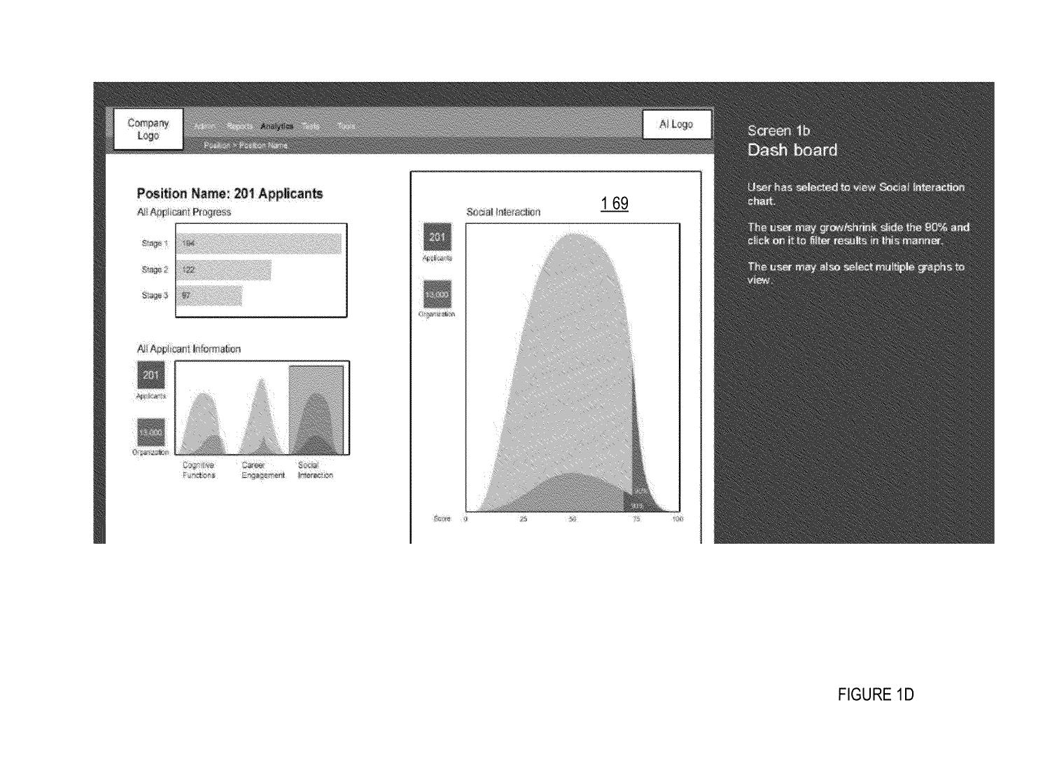

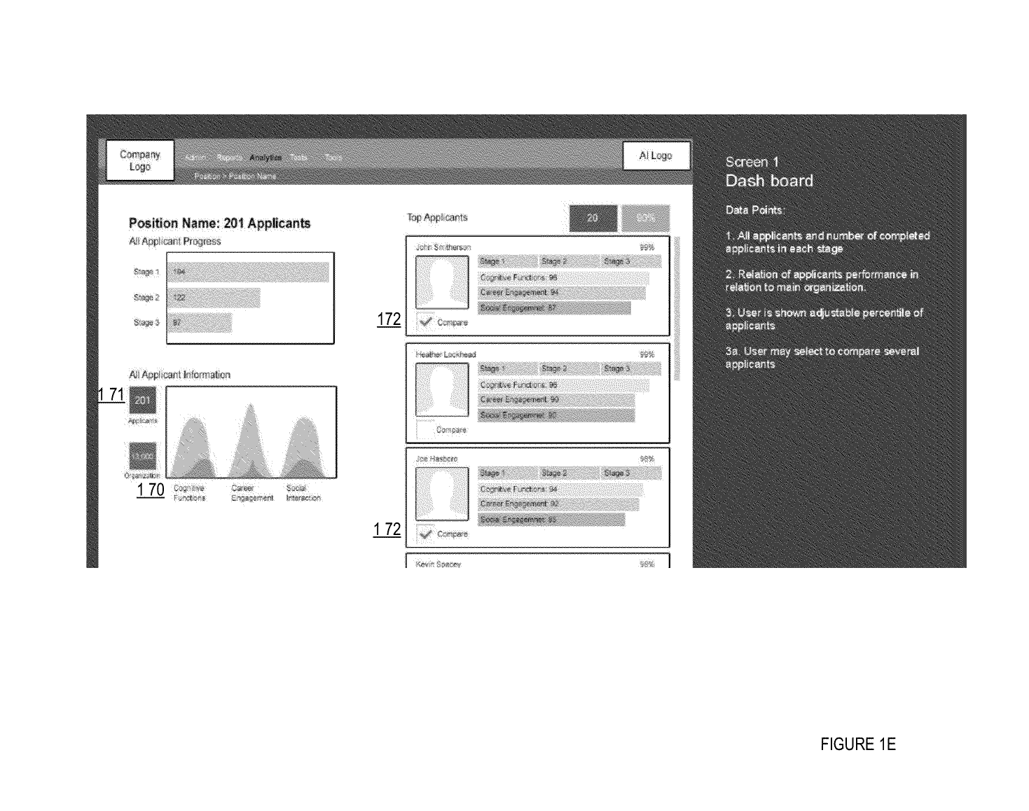

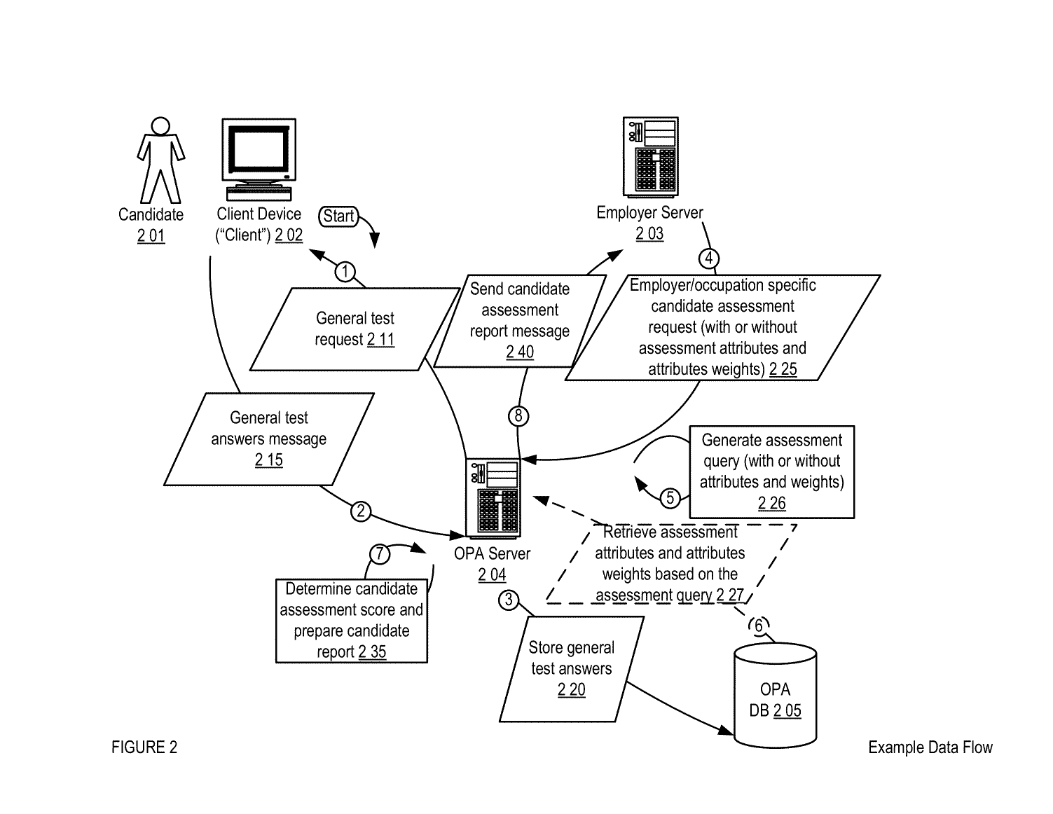

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Introduction

The OCCUPATIONAL PERFORMANCE ASSESSMENT APPARATUSES, METHODS AND SYSTEMS (“OPA”) transforms candidates occupational test answers and employers occupational goal inputs via OPA test intake, assessment and score components, into candidates occupational assessment outputs.

In one embodiment, the OPA provides a technology-driven systems approach to talent identification, acquisition, management and support. It may be based on theories in cognitive psychology. It creates a dynamic fit between individuals and organizations to increase productivity, efficiency, and effectiveness in the new economy.

In one embodiment, the OPA provides a computer-delivered assessment that adapts to a user's responses to provide an individualized evaluation. The OPA may also be integrated with mobile technology and multi-touch interfaces to create more realistic assessment paradigms. In one embodiment, social media may be used as an OPA marketing and product delivery tools. In one embodiment, cloud based servers and databases may be integrated to allow easily scalable solutions.

In one embodiment, the assessment attributes may include many different domains, such as critical thinking, cognitive competencies, team roles and dynamics, motivational orientation, planning and problem solving, attitudes and beliefs, decision making, cognitive biases, executive function, short-term and working memory, reasoning, search and recognition, social cognition, learning, creativity, and/or the like. Each domain may include multiple sub-domains. For example, the problem solving attribute may include creative problem solving, practical problem solving, and analytical problem solving. As a non-limiting example of creative problem solving, creative thinkers often see connections between things and trends that other individuals are less likely to recognize. As a non-limiting example of practical problem solving, practical abilities are concerned with what one achieves with his or her intelligence rather than with one's actual intellectual capacity. As a non-limiting example of analytical problem solving, analytical thinking requires using logic by assessing, being critical, and recognizing important attributes of a situation.

In one embodiment, the cognitive bias attribute may measure the tendency to make decisions based on ease of cognitive processing rather than evidence. Biases are constantly used to deal with incomplete data and uncertainty. Cognitive biases may have unintended and significant effects on decision-making. The cognitive bias attribute may include sub-domains such as attentional bias, endowment bias, anchoring bias, fundamental attribution bias, knowledge bias, overconfidence bias, zero risk bias, in group bias, and/or the like. A cognitive bias is the tendency to make decisions based on ease of cognitive processing rather than evidence.

In one embodiment, the motivational orientation attribute may identify an individual's preference to seek risk or avoid risk. It may use implicit measures to identify an individual's motivational orientation. By carefully analyzing a subject's responses to a variety of questions, the OPA may identify key factors that influence behavior and decision making. For example, for risk seeker, wins are experienced more intensely than losses. Motivation (or eagerness) increases after wins. For risk avoider, losses are experienced more intensely than wins. Motivation (or vigilance) increases after losses.

In one embodiment, the OPA may provide an integrated system for the entire process of talent identification, acquisition, management and support. For the talent recruitment, the OPA may use social media to reach candidates (e.g., LinkedIn), and prescreen potential candidates with a “quick assessment” to identify strengths and potential fits with job openings. For the talent assessment, the OPA may conduct thorough assessment of the key characteristics that are being sought after, remotely or in-house, and integrate structured interview data into the OPA system metrics. For the talent recruitment decision, the OPA may highlight candidates that demonstrate the abilities and characteristics that would be the best fit with the organization, and provide an online platform where key decision makers can collectively evaluate candidates. For the talent review, the OPA may perform ongoing review using assessment and ‘real world’ data (e.g., Salesforce pipeline data, portfolio performance), and maintain OPA Model to have organic database that can predict future job performance. For the talent exit process, the OPA may collect data during the exit interview to gain insights into why employees are leaving, and use this information to examine the dynamics within the organization.

In one embodiment, the OPA technology may be used in personal investing, healthcare industry. The OPA may individualize investments based on cognitive profiles. The OPA may be used in medication adherence. The OPA may individualize prescription regimens to include message framing.

In one embodiment, the OPA assessment process may start by OPA integration into employer's hiring process, or through referrals delivered through social networks, or search the OPA database for open positions. The OPA may receive candidate assessment request from an employer's server, a social network server, a candidate's server, or any other entity.

### OPA

FIG. 1A shows a logic flow diagram illustrating some embodiments of the OPA. In one embodiment, the OPA may first provide initial evaluation of the individual cognitive profiles and overall structure of the organization. The OPA may then determine the assessment of key cognitive domains (alternatively, assessment attributes). The OPA may develop a (optionally predictive) cognitive model of the organization, at the department, role, and/or individual-level. During the recruitment process, the OPA may identify needed capabilities, evaluate potential candidates, and provide decision-making platform for hiring. For talent improvement process, the OPA may evaluate individual progress, satisfaction, and fit, and evaluate department and organizational evaluation of efficiency, and develop individualized professional development strategies. The OPA may provide interactive reports delivered to individuals (within the organization and applying to the organization) and/or to departments. For those individuals leaving the organization, the OPA may provide an exit interview and evaluation. The OPA may also perform continuous modification to the “cognitive model of the organization” to identify return on investment and longitudinal analytics.

FIG. 1B shows a block diagram illustrating employer initiated assessment embodiments of the OPA. In one embodiment, a job candidate 101 may apply for a job opening from an employer by sending an occupation request in via its client device (e.g., computer, mobile device, etc.) 102 to an employer server 103. For example, a browser application executing on the candidate's client may provide, on behalf of the candidate, a (Secure) Hypertext Transfer Protocol (“HTTP(S)”) GET message including the occupation request details for the employer server in the form of data formatted according to the eXtensible Markup Language (“XML”). Below is an example HTTP(S) GET message including an XML-formatted occupation request message in for the employer server:

```
GET /occupationrequest.php HTTP/1.1
Host: www.employer.com
Content-Type: Application/XML
Content-Length: 1306
<?XML version = “1.0” encoding = “UTF-8”?>
<occupation_request>
  <request_ID>4NFU4RG94</request_ ID>
  <timestamp>2011-02-22 15:22:43</timestamp>
  <candidate_details>
    <candidate_ID>john.q.public@gmail.com</candidate_ID>
    <candidate_name>John Q. Public</candidate name>
    <candidate_address>123 Peace St., New York, NY
10036</candidate_address>
    <candidate_phone>123-456-7890</candidate phone>
    <candidate_education_background>Brown University MBA
2001</candidate_education_background>
  </candidate_details>
  <client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
  <occupation_details>
    <occupation_ID>JDHUI38</occupation_ID>
    <occupation_title>sales</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name> Big Sales Company</employer_name>
    <employer_email>recuiting@bigsalescompany.com</employer_email>
    <employer_recruiter >Firstname Lastname<employer_recruiter >
  </employer_details>
</occupation_reguest>
```

Below is another example HTTP(S) GET messages including an XML-formatted occupation request messages in for applying a librarian position from the employer server:

```
GET /occupationrequest.php HTTP/1.1
Host: www.employer.com
Content-Type: Application/XML
Content-Length: 1306
<?XML version = “1.0” encoding = “UTF-8”?>
<occupation_request>
  <request_ID>6RQU4RG94</request_ID>
  <timestamp>2010-05-01 15:22:43</timestamp>
  <candidate_details>
    <candidate_ID>john.q.public@gmail.com</candidate_ID>
    <candidate_name>John Q. Public</candidate_name>
    <candidate_address>123 Peace St., New York, NY
10036</candidate_address>
    <candidate_phone>123-456-7890</candidate_phone>
    <candidate_education_background>University of Chicago
BA</candidate_education_background>
  </candidate_details>
  <client_details>
    <client_IP>122.541.55.199</client_IP>
    <client_type>tablet computer</client_type>
    <client_model>iPad</client_model>
    <OS>iOS 7.0</OS>
    <app_installed_flag>true</app_installed_flag>
  </client_details>
  <occupation_details>
    <occupation_ID>UOID88</occupation_ID>
    <occupation_title>librarian</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name>Children's Hospital</employer_name>
  <employer_email>recuiting@childrenshospital.com</employer_email>
    <employer_recruiter >Firstname Lastname<employer_recruiter >
  </employer_details>
</occupation_request>
```

Below is another example HTTP(S) GET messages including an XML-formatted occupation request messages in for applying a air traffic controller position from the employer server:

```
GET /occupationrequest.php HTTP/1.1
Host: www.employer.com
Content-Type: Application/XML
Content-Length: 1306
<?XML version = “1.0” encoding = “UTF-8”?>
<occupation_request>
  <request_ID>9UCJ4RG55</request_ID>
  <timestamp>2010-05-01 15:22:43</timestamp>
  <candidate_details>
    <candidate_ID>Joe@gmail.com</candidate_ID>
    <candidate_name>Joe Doe </candidate_name>
    <candidate_address>77 House, Boston, MA
99999</candidate_address>
    <candidate_phone>789-012-5678</candidate_phone>
    <candidate_education_background>Colleage ABC
BS</candidate_education_background>
  </candidate_details>
  <client_details>
    <client_IP>155.345.88.642</client_IP>
    <client_type>laptop</client_type>
    <client_model>Chromebook</client_model>
    <OS>Andoid4.0</OS>
    <app_installed_flag>false</app_installed_flag>
  </client_details>
  <occupation_details>
    <occupation_ID>KKLO8</occupation_ID>
    <occupation_title>air traffic controller</occupation_title>
    <occupation_start_date>2012-01-01</occupation_start_date>
    <opening_close_date>2011-05-31</opening_close_date>
  </occupation_details>
  <employer_details>
    <employer_ID>AA934</employer_ID>
    <employer_name>American Airlines</employer_name>
    <employer_email>recuiting@aa.com</employer_email>
    <employer_recruiter >Firstname Lastname<employer_recruiter>
  </employer_details>
</occupation_request>
```

To be able to assess the candidate's qualification, the employer server may process the occupation request and generate a candidate assessment request 115. In one embodiment, in addition to a title of the job opening (e.g., sales representative), the candidate assessment request 115 may also include what attributes are needed for this occupation or job opening, and/or how important each attribute is for this occupation or job opening (e.g., attributes weights), specified by the employer. In another embodiment, the candidate assessment request 115 may only provide a title of the job opening, (e.g., sales representative), and does not need to specify which attributes is needed. In yet another embodiment, the candidate assessment request 115 may include a title of the job opening and the assessment attributes, while the attributes weights are not specified. The attributes may include, but not limited to, critical thinking, cognitive competencies, team roles and dynamics, motivational orientation, planning and problem solving, attitudes and beliefs, decision making, and/or the like. The attributes weight may be a percentage representing how important an attribute is among all attributes needed for a job opening. All attributes weights may be added to 100%. For example, if an employer is hiring a librarian, the attributes the employer would like the candidate to possess are analytical reasoning, punctuality, well organized, and patience. The analytical reasoning may be weighted 10% of the entire assessment, the punctuality may be weighted 30%, the well-organized attribute may be weighted 30%, and the patience may be weighted 30%. Therefore, adding all weights together generates 100%.

The employer server may send the candidate assessment request with or without the assessment attributes and attributes weights 120 to the OPA server 104. For example, the employer server may provide a HTTP(S) POST request 120 similar to the example below:

```
POST /assessmentrequest.php HTTP/1.1
Host: www.OPA.com
Content-Type: Application/XML
Content-Length: 788
<?XML version = “1.0” encoding = “UTF-8”?>
<assessment_request>
  <request_ID>4NFU4RG94</request_ID>
  <timestamp>2011-02-22 15:22:43</timestamp>
  <candidate_details>
    <candidate_ID>john.q.public@gmail.com</candidate_ID>
    <candidate_name>John Q. Public<candidate_name>
    <candidate_address>123 Peace St., New York, NY
10036</candidate_address>
    <candidate_phone>123-456-7890</candidate_phone>
    <candidate_education_background>Brown University MBA
2001</candidate_education_background>
  </candidate_details>
  <client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
  <occupation_details>
    <occupation_ID>JDHUI38</occupation_ID>
    <occupation_title>sales</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name>Big Sales Company</employer_name>
    <employer_email>recuiting@bigsalescompany.com</employer_email>
    <employer_ recruiter >Firstname Lastname<employer_ recruiter >
  </employer_details>
  <test_ID>ASDFHJE456</test_ID>
<optional>
  <test_time>20minutes</test_time>
  <confidence_level>80%</confidence_level>
</optional>
</assessment_request>
```

Below is another example wherein the employer server may provide a HTTP(S) POST request 120 for a librarian position:

```
POST /assessmentrequest.php HTTP/1.1
Host: www.OPA.com
Content-Type: Application/XML
Content-Length: 788
<?XML version = “1.0” encoding = “UTF-8”?>
<assessment_request>
  <request_ID>5YFU4RG94</request_ID>
  <timestamp>2009-02-22 15:22:43</timestamp>
  <candidate_details>
    <candidate_ID>john.q.public@gmail.com</candidate_ID>
    <candidate_name>John Q. Public</candidate_name>
    <candidate_address>123 Peace St., New York, NY
10036</candidate_address>
    <candidate_phone>123-456-7890</candidate_phone>
    <candidate_education_background>University of Chicago BA
</candidate_education_background>
  </candidate_details>
  <client_details>
    <client_IP>122.541.55.199</client_IP>
    <client_type>tablet computer</client_type>
    <client_model>iPad</client_model>
    <OS>iOS 7.0</OS>
    <app_installed_flag>true</app_installed_flag>
  </client_details>
  <occupation_details>
    <occupation_ID>UOID88</occupation_ID>
    <occupation_title>librarian</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name>Children's Hospital</employer_name>
  <employer_email>recuiting@childrenshospital.com</employer_email>
    <employer_recruiter >Firstname Lastname<employer_recruiter >
  </employer_details>
<optional>
  <test_time>20minutes</test_time>
  <confidence_level>80%</confidence_level>
  <assessment_score_threshold>95</assessment_score_threshold>
</optional>
</assessment_reguest>
```

Below is another example wherein the employer server may provide a HTTP(S) POST request 120 for an air traffic controller position with assessment attributes and attributes weights:

```
POST /assessmentrequest.php HTTP/1.1
Host: www.OPA.com
Content-Type: Application/XML
Content-Length: 788
<?XML version = “1.0” encoding = “UTF-8”?>
<assessment_request>
  <request_ID>00JU4RG94</request_ID>
  <timestamp>2005-01-07 15:22:43</timestamp>
  <candidate_details>
    <candidate_ID>Joe@gmail.com</candidate_ID>
    <candidate_name>Joe Doe </candidate_name>
    <candidate_address>77 House, Boston, MA
99999</candidate_address>
    <candidate_phone>789-012-5678</candidate_phone>
    <candidate_education_background>Colleage ABC
BS</candidate_education_background>
  </candidate_details>
  <client_details>
    <client_IP>155.345.88.642</client_IP>
    <client_type>laptop</client_type>
    <client_model>Chromebook</client_model>
    <OS>Andoid4.0</OS>
    <app_installed_flag>false</app_installed_flag>
  </client_details>
  <occupation_details>
    <occupation_ID>KKLO8</occupation_ID>
    <occupation_title>air traffic controller</occupation_title>
    <occupation_start_date>2012-01-01</occupation_start_date>
    <opening_close_date>2011-05-31</opening_close_date>
  </occupation_details>
  <employer_details>
    <employer_ID>AA934</employer_ID>
    <employer_name>American Airlines</employer_name>
    <employer_email>recuiting@aa.com</employer_email>
    <employer_recruiter >Firstname Lastname<employer_recruiter >
  </employer_details>
  <attributes>1
    <attributes_id>014</attributes_id>
    <attributes_name>critical thinking</attributes_name>
    <attributes_weights>10%</attributes_weights>
  </attributes>
  <attributes>2
    <attributes_id>010</attributes_id>
    <attributes_name>response time</attributes_name>
    <attributes_weights>40%</attributes_weights>
  </attributes>
  <attributes>3
    <attributes_id>008</attributes_id>
    <attributes_name>search and recognition</attributes_name>
    <attributes_weights>25%</attributes_weights>
  </attributes>
  <attributes>4
    <attributes_id>055</attributes_id>
    <attributes_name>decision making</attributes_name>
    <attributes_weights>25%</attributes_weights>
  </attributes>
</assessment_request>
```

In one embodiment, the OPA server may generate an assessment query including a title of the job opening (with or without the assessment attributes and/or the attributes weights) 122. If the candidate assessment request 120 does not include attributes or weights, the OPA server may send a query to the OPA database 105 and retrieve the attributes and weights based on the assessment query 125. Below is an example wherein the OPA server may receive a HTTP message 125 with attributes and weights for the librarian position:

```
POST /retrievattributes.php HTTP/1.1
Host: www.OPA.com
Content-Type: Application/XML
Content-Length: 788
<?XML version = “1.0” encoding = “UTF-8”?>
<attributes_retrieval>
  <request_ID>5YFU4RG94</request_ID>
  <timestamp>2009-02-22 15:22:43</timestamp>
  <candidate_details>
    <candidate_ID>john.q.public@gmail.com</candidate_ID>
    <candidate_name>John Q. Public</candidate_name>
    <candidate_address>123 Peace St., New York, NY
10036</candidate_address>
    <candidate_phone>123-456-7890</candidate_phone>
    <candidate_education_background> University of Chicago BA
</candidate_education_background>
  </candidate_details>
  <client_details>
    <client_IP>122.541.55.199</client_IP>
    <client_type>tablet computer</client_type>
    <client_model>iPad</client_model>
    <OS>iOS 7.0</OS>
    <app_installed_flag>true</app_installed_flag>
  </client_details>
  <occupation_details>
    <occupation_ID>UOID88</occupation_ID>
    <occupation_title>librarian</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name>Children′s Hospital</employer_name>
  <employer_email>recuiting@childrenshospital.com</employer_email>
    <employer_recruiter >Firstname Lastname<employer_recruiter >
  </employer_details>
  <attributes>1
    <attributes_id>014</attributes_id>
    <attributes_name>critical thinking</attributes_name>
    <attributes_weights>10%</attributes_weights>
    <attributes_time>2minutes</attributes_time>
  </attributes>
  <attributes>2
    <attributes_id>010</attributes_id>
    <attributes_name>response time</attributes_name>
    <attributes_weights>20%</attributes_weights>
    <attributes_time>4minutes</attributes_time>
  </attributes>
  <attributes>3
    <attributes_id>008</attributes_id>
    <attributes_name>search and recognition</attributes_name>
    <attributes_weights>35%</attributes_weights>
    <attributes_time>7minutes</attributes_time>
  </attributes>
  <attributes>4
    <attributes_id>022</attributes_id>
    <attributes_name>short-term and working
memory</attributes_name>
    <attributes_weights>35%</attributes_weights>
    <attributes_time>7minutes</attributes_time>
  </attributes>
</attributes_retrieval>
```

The OPA server may further query the OPA database and retrieve an employer or occupation specific test based on the assessment query, the attributes, and the attributes weights 140. In one implementation, the test may be specific to the job for which the candidate applies. In another implementation, the test may be specific to only the employer. The file format of the test may be straight html forms with multiple form field blanks for answers. It may also be more advanced adobe flash, html5, and/or the like, with multi-media components and submodules. For example, the OPA server may provide a HTTP(S) GET message including an XML-formatted employer/occupation specific test message 140 similar to the example below:

```
GET /specifictest.php HTTP/1.1
Host: www.OPA.com
Content-Type: Application/XML
Content-Length: 1306
<?XML version = “1.0” encoding = “UTF-8”?>
<test>
  <test_ID>ASDFHJE456</test_ID>
  <test_variation_flag>Y</test_variation_flag>
  <test_variation>sales</test_variation>
  <test_category_1>
    <category_name>problem solving</category_name>
    <question_1>Customer is unhappy about the product you sold.
What would you do?</question_1>
    <question_2> </question_2>
    ...
    <question_n> </question_n>
    <category_time>2 minutes</category_time>
  </test_category_1>
  <test_category_2>
    <category_name>Critical thinking</category_name>
    <question_1>What is the author′s main point of this
passage?</question_1>
    <question_2> </question_2>
    ...
    <question_n> </question_n>
    <category_time>10 minutes</category_time>
  </test_category_2>
</test>
```

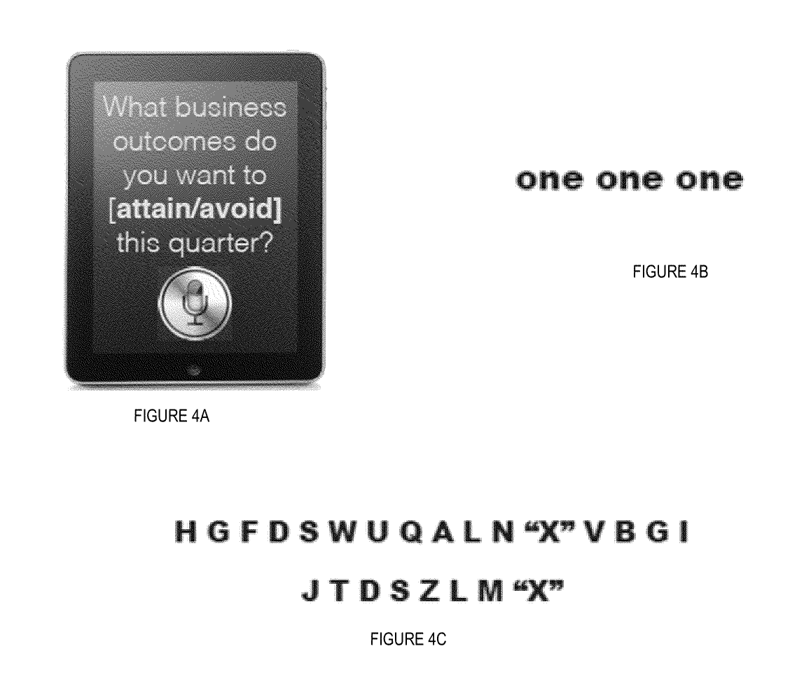

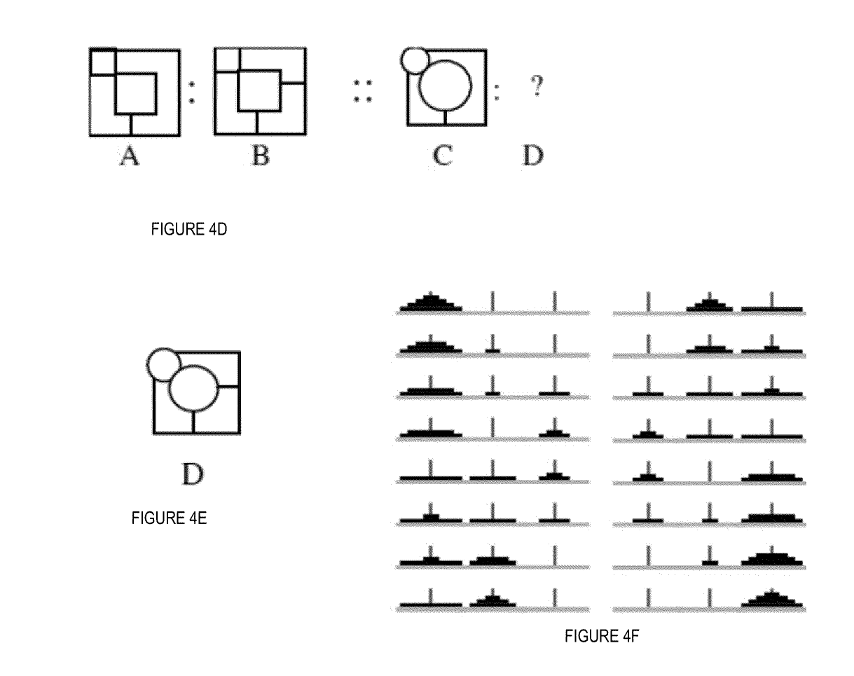

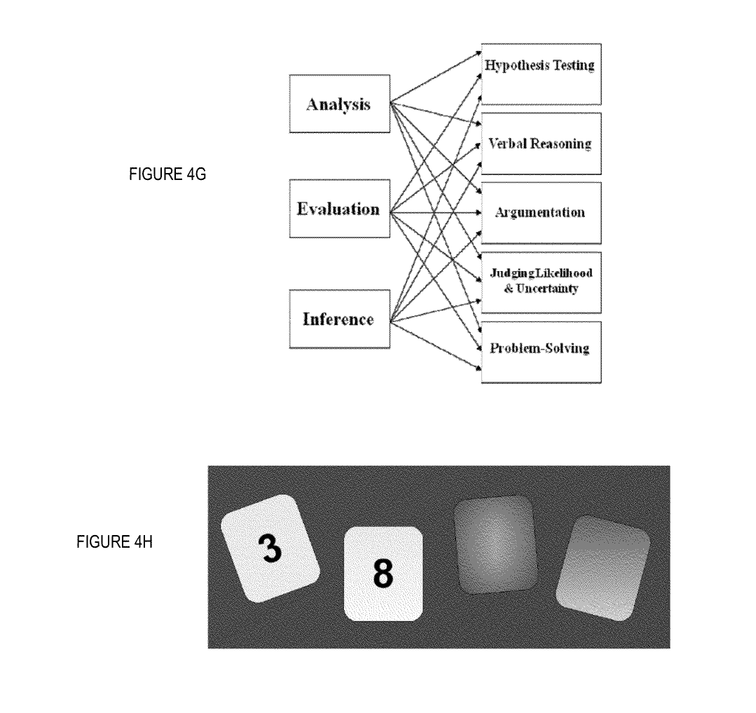

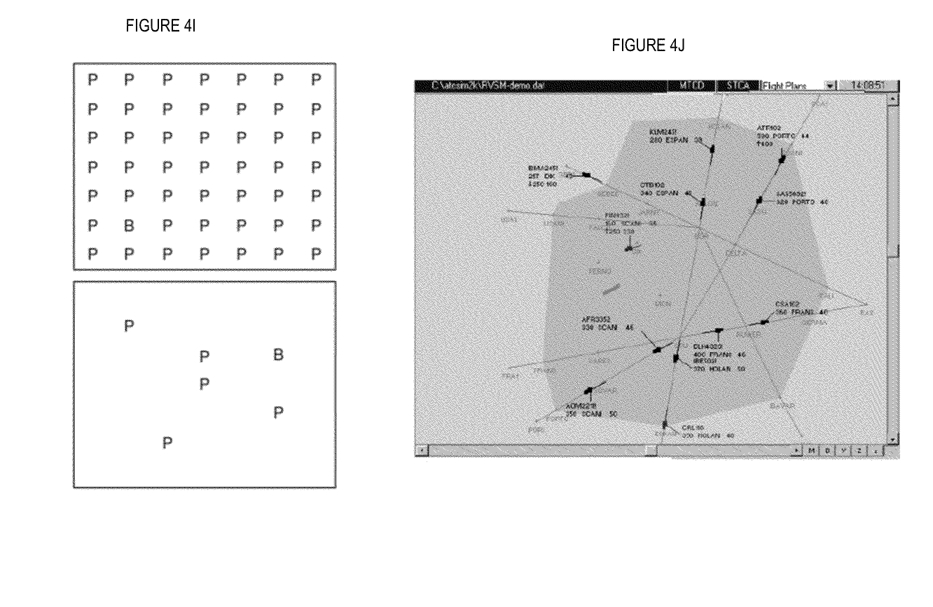

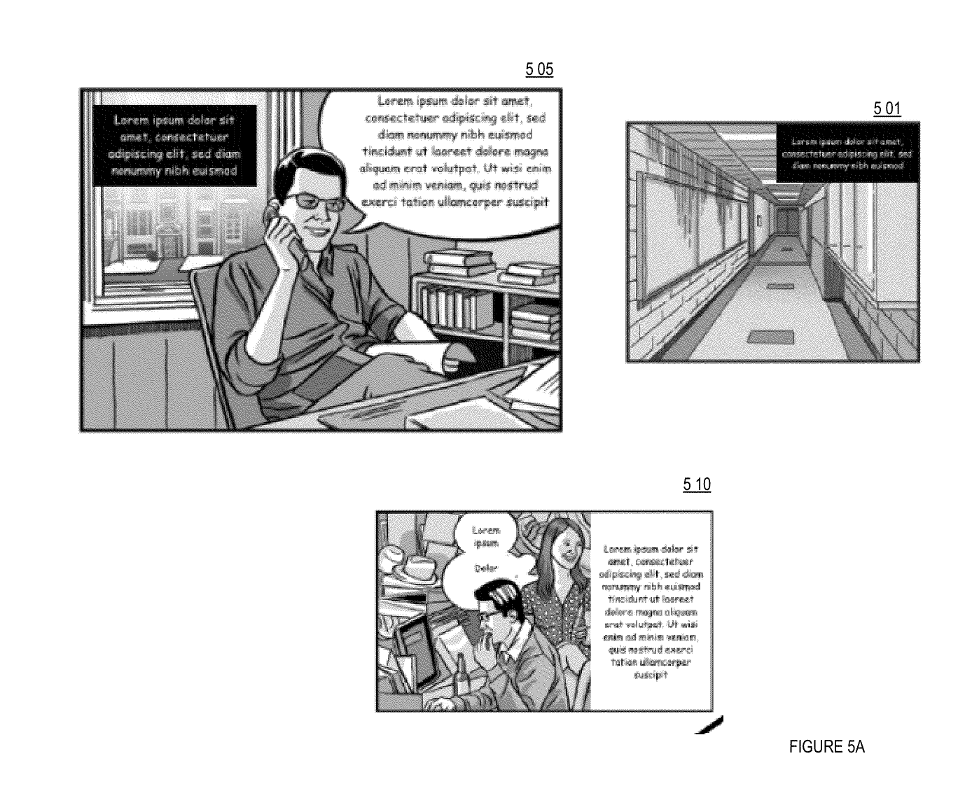

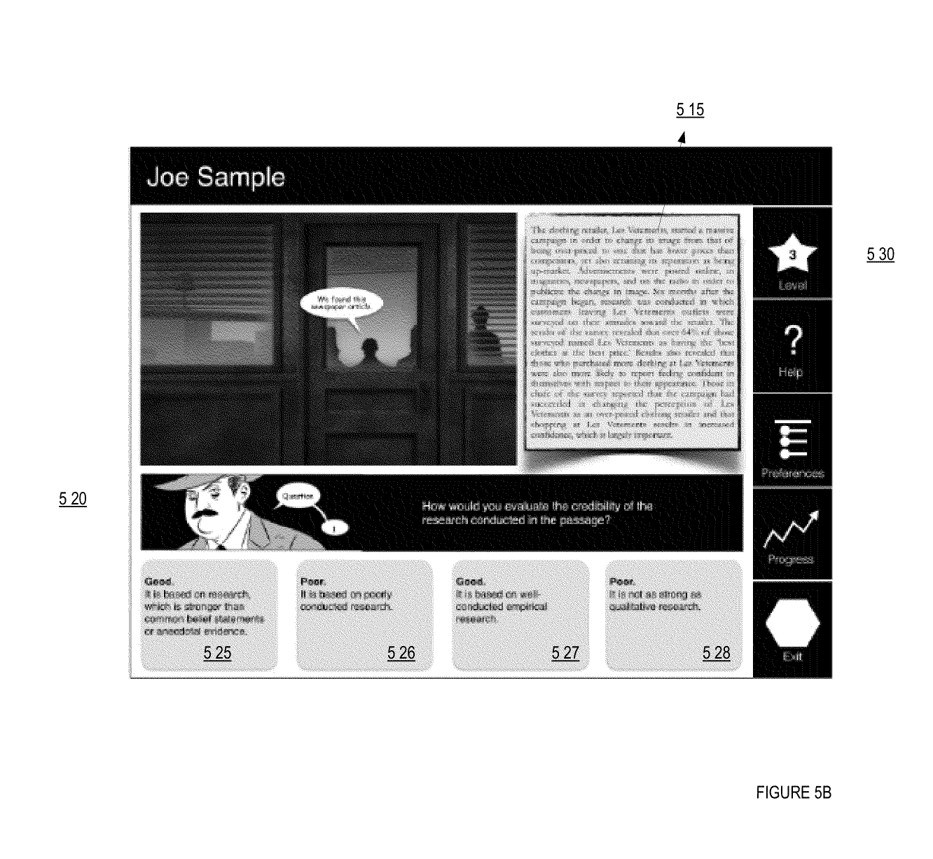

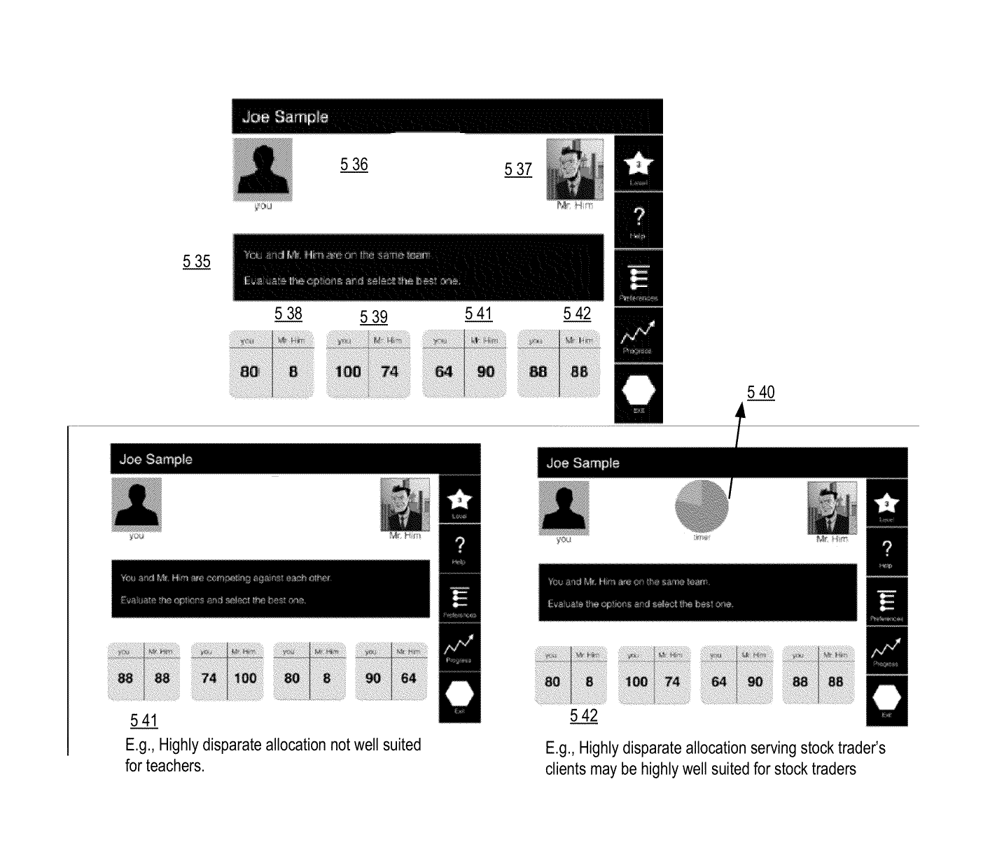

In one embodiment, for example, because critical thinking attribute is important for both a librarian and an air traffic controller, an assessment question as discussed in FIG. 5B may be provided. Because search and recognition is important for an air traffic controller, an assessment question as discussed in FIG. 4I may be provided only to the air traffic controller applicant, not to the librarian applicant.

The employer/occupation specific test request 130 may then be sent from the OPA server to the candidate client device. For example, the OPA server may provide a HTTP(S) POST request 130 similar to the example below:

```
POST /testrequest.php HTTP/1.1
Host: www.OPA.com
Content-Type: Application/XML
Content-Length: 788
<?XML version = “1.0” encoding = “UTF-8”?>
<test_request>
  <test_ID>ASDFHJE456</test_ID>
  <timestamp>2011-03-22 15:22:43</timestamp>
  <candidate_details>
    <candidate_ID>john.q.public@gmail.com</candidate_ID>
    <candidate_name>John Q. Public</candidate_name>
  </candidate_details>
  </client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
  <occupation_details>
    <occupation_ID>JDHUI38</occupation_ID>
    <occupation_title>sales</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name> Big Sales Company</employer_name>
    <employer_email>recuiting@bigsalescompany.com</employer
    email>
    <employer_ recruiter >Firstname Lastname<employer_ recruiter >
  </employer_details>
  <test_variation_flag>Y</test_variation_flag>
  <test_variation>sales</test_variation>
  <test_series_template_for>sales</test_series_template_for>
  <test_series>category 1 category 2</test_series>
  <test_category_1>
    <category_name>problem solving</category_name>
    <question_1>Customer is unhappy about the product you sold.
What would you do?</question_1>
    <question_2> </question_2>
    ...
    <question_n> </question_n>
  </test_category_1>
  <test_category_2>
    <category_name>Critical thinking</category_name>
    <question_1>What is the author′s main point of this
passage?</question_1>
    <question_2> </question_2>
    ...
    <question_n> </question_n>
  </test_category_2>
  <predetermined_confidence_level>80%</predetermined_confidence_
  level>
</test_request>
```

The candidate may provide input to answer the employer and/or occupation specific test answers message 135, which may be stored in the OPA database 140. For example, the OPA server may provide a HTTP(S) GET message including an XML-formatted employer/occupation specific test answers message 135 similar to the example below:

```
GET /specifictestanswers.php HTTP/1.1
Host: www.OPA.com
Content-Type: Application/XML
Content-Length: 1306
<?XML version = “1.0” encoding = “UTF-8”?>
<test_answer>
  <answer_ID>56JK9</answer_ID>
  <test_ID>ASDFHJE456</test_ID>
  <timestamp>2011-03-31 15:22:43</timestamp>
  <candidate_details>
    <candidate_ID>john.q.public@gmail.com</candidate_ID>
    <candidate_name>John Q. Public</candidate_name>
  </candidate_details>
  </client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
  <occupation_details>
    <occupation_ID>JDHUI38</occupation_ID>
    <occupation_title>sales</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name> Big Sales Company</employer_name>
    <employer_email>recuiting@bigsalescompany.com</employer_
    email>
    <employer_recruiter >Firstname Lastname<employer_recruiter >
  </employer_details>
  <test_variation_flag>Y</test_variation_flag>
  <test_variation>sales</test_variation>
  <test_category_1>
    <category_name>problem solving</category_name>
    <answer_1>choice b</answer_1>
    <answer_2>...</answer_2>
    ...
    <answer_n></answer_n>
  </test_category_1>
  <test_category_2>
    <category_name>Critical thinking</category_name>
    <answer_1>choice c</answer_1>
    <answer_2>...</answer_2>
    ...
    <answer_n></answer_n>
  </test_category_2>
</test_answer>
```

Based on the candidate provided test answers, the OPA server may determine an assessment score and prepare a corresponding assessment report 145 and provide to the employer 150. For example, the OPA server may provide a HTTP(S) POST assessment message 150 similar to the example below:

```
POST /assessmentmessage.php HTTP/1.1
Host: www.OPA.com
Content-Type: Application/XML
Content-Length: 788
<?XML version = “1.0” encoding = “UTF-8”?>
<assessment_message>
  <assessment_ID>56RWJE456</assessment_ID>
  <test_ID>ASDFHJE456</test_ID>
  <answer_ID>56JK9</answer_ID>
  <candidate_details>
    <candidate_ID>john.q.public@gmail.com</candidate_ID>
    <candidate_name>John Q. Public</candidate_name>
  </candidate_details>
  <assessment_details>
    <category_1_weight>0.5</category_1_weight>
    <category_2_weight>0.9</category_2_weight>
    <algorithm>linear regression</ algorithm >
  </assessment_details>
  <occupation_details>
    <occupation_ID>JDHUI38</occupation_ID>
    <occupation_title>sales</occupation_title>
    <occupation_start_date>2012-01-01</occupation_start_date>
    <opening_close_date>2011-05-31</opening_close_date>
  </occupation_details>
  <test_category_1>
    <category_name>problem solving</category_name>
    <question_1>Customer is unhappy about the product you sold.
What would you do?</question_1>
    <answer_1>choice b</answer_1>
    <score_category_1>85</score_category_1>
  </test_category_1>
  <test_category_2>
    <category_name>Critical thinking</category_name>
    <question_1>What is the author′s main point of this
passage?</question_1>
    <answer_1>choice c</answer_1>
    <score_category_2>98</score_category_2>
  </test_category_2>
  <assessment_details>
    <category_1_weight>0.5</category_1_weight>
    <category_2_weight>0.9</category_2_weight>
    <algorithm>linear regression</ algorithm >
    <assessment_weighted_score>83/100</assessment_weighted_score>
    <ranking_percentile_based_on_current_employees>92%
</ranking_percentile_based_on_current_employees>
  <employer_assessment_score_threshold>95</employer_assessment_
score_threshold>
    <average_assessment_score>69</average_assessment_score>
  </assessment_details>
</assessment_message>
```

In one embodiment, the OPA reporting mechanisms allows an HR manager to (1) view aggregate information about all participants who have applied for an open position; (2) compare a target individual against (a) another candidate, (b) a group of candidates, (c) all other candidates, and/or (d) all current employees in a comparable position within the organization; and (3) a detailed report for the individual candidate that highlights specific strengths and weaknesses in graphical and narrative formats.

FIGS. 1C-1E show screenshots of some illustrating reporting user interface in some embodiments of the OPA. With reference to FIG. 1C, a report of an individual applicant may be selected and displayed. The report may list a basic profile of the application, for example, the position name 160, the applicant's name, the picture. It may also include relative documents, for example, the resume, the conver letter, the transcript, and the full assessment report 161. The assessment report may also be viewed directly in the user interface (“UI”) 163. The report may also provide an comparison of this selected applicant and all applicants interested in this position 164. In one embodiment, the assessment may be categorized into three assessment domains 168, for example, cognitive factors, career engagement, and social interaction. The report may generate a comparison graph illustrating how this selected applicant 167 is compared to all applicants who have applied to this position 166 in all three assessment domains. A zoom-in graph 169 for each assessment domain and detailed information about the comparison may be viewed, as shown in FIG. 1D. A decision may be given to the selected applicant based on the assessment. A decision may be that scheduling an interview, hold for further discussions, reject the application, and/or the like 162. The assessment may also be viewed in other report formats. For example, with reference to FIG. 1E, an aggregated data may be viewed for each position. The report may show the assessment in each assessment domain for all current employees with the positions in the organization 170, and for all applicants applying for the same positions 171. The report may also allow one to select applicants and compare their assessments 172.

FIG. 2 shows a block diagram illustrating candidate initiated assessment embodiments of the OPA. In one embodiment, a candidate 201 may submit its profile through a third party job hub (e.g., Monster, CareerBuilder, etc.). When an employer has a job opening, the employer may go to the third party job hub to search for qualified candidates based on the profile they submitted. In one implementation, the OPA server may send a general test request 211 to the candidate's device 202. The general test request include questions in all categories for assessment, instead of part of categories that may be specific to the employer or an occupation, as illustrated in FIG. 1B. In one implementation, an applicant may desire to pursue a field different from its last occupation. For example, if an applicant was a sales person and he wants to change career and pursue a job in advertising. The OPA server may retrieve and send to the applicant test templates for people in advertising field. For example, the OPA server may provide a HTTP(S) POST request 211 similar to the example below:

```
POST /generaltestrequest.php HTTP/1.1
Host: www.OPA.com
Content-Type: Application/XML
Content-Length: 788
<?XML version = “1.0” encoding = “UTF-8”?>
<general_test_request>
  <test _ID>FHJE916</test_ID>
  <timestamp>2011-03-22 15:22:43</timestamp>
  <candidate_details>
    <candidate_ID>john.q.public@gmail.com</candidate_ID>
    <candidate_name>John Q. Public</candidate_name>
  </candidate_details>
  </client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
  <desired_job_title/field>Advertising</desired_job_title/field>
  <test_variation_flag>Y</test_variation_flag>
  <test_series_template_for>Advertising</test_series_template_for>
  <test_series>category 1 category 5</test_series>
  <test_category_1>
    <category_name>problem solving</category_name>
    <question_1>Customer is unhappy about the product you sold.
What would you do?</question_1>
    <question_2> </question_2>
    ...
    <question_n> </question_n>
  </test_category_1>
  <test_category_5>
    <category_name> team work </category_name>
    <question_1>Do you like to work in a team?</question_1>
    <question_2> </question_2>
    ...
    <question_n> </question_n>
  </test_category_5>
<OPTIONAL>
  <occupation_details>
    <occupation_ID>JDHUI38</occupation_ID>
    <occupation_title>Advertising</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name> Big Sales Company</employer_name>
    <employer_email>recuiting@bigsalescompany.com</employer_
    email>
    <employer_recruiter >Firstname Lastname<employer_recruiter >
  </employer_details>
</OPTIONAL>
</general_test_request>
```

The candidate may provide answers to the general test 215, which may then be stored 220 in the OPA database 205. For example, the OPA server may provide a HTTP(S) GET message including an XML-formatted general test answers message 215 similar to the example below:

```
GET /generaltestanswers.php HTTP/1.1
Host: www.OPA.com
Content-Type: Application/XML
Content-Length: 1306
<?XML version = “1.0” encoding = “UTF-8”?>
<general_test_answer>
  <answer_ID>56JK9</answer_ID>
  <test _ID>FHJE916</test _ID>
  <timestamp>2011-03-31 15:22:43</timestamp>
  <candidate_details>
    <candidate_ID>john.q.public@gmail.com</candidate_ID>
    <candidate_name>John Q. Public</candidate_name>
  </candidate_details>
  </client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
  <desired_job_title/field>Advertising</desired_job_title/field>
  <test_variation_flag>Y</test_variation_flag>
  <test_series_template_for>Advertising</test_series_template_for>
  <test_series>category 1 category 5</test_series>
  <test_category_1>
    <category_name>problem solving</category_name>
    <answer_1>choice b</answer_1>
    <answer_2>...</answer_2>
    ...
    <answer_n>...</answer_n>
  </test_category_1>
  <test_category_5>
    <category_name> team work </category_name>
    <answer_1>choice c</answer_1>
    <answer_2>...</answer_2>
    ...
    <answer_n>...</answer_n>
  </test_category_5>
<OPTIONAL>
  <occupation_details>
    <occupation_ID>JDHUI38</occupation_ID>
    <occupation_title>Advertising</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name> Big Sales Company</employer_name>
    <employer_email>recuiting@bigsalescompany.com</employer_
    email>
    <employer_ recruiter >Firstname Lastname<employer_ recruiter >
  </employer_details>
</OPTIONAL>
</general_test_answer>
```

In one implementation, an employer server 203 may send a employer/occupation specific candidate assessment request (with or without assessment attributes and attributes weights) 225 to the OPA server to recruit candidates that may be appropriate for the employer and/or the occupation. For example, the OPA server may provide a HTTP(S) GET message including an XML-formatted employer/occupation specific candidate assessment request 225 similar to the example below:

```
GET /specific_candidate_assessment_request.php HTTP/1.1
Host: www.OPA.com
Content-Type: Application/XML
Content-Length: 1306
<?XML version = “1.0” encoding = “UTF-8”?>
<specific_candidate_assessment_request>
  <candidate_request_ID>4NF4RG94</candidate_request_ID>
  <timestamp>2011-02-22 15:22:43</timestamp>
  <occupation_details>
    <occupation_ID>JDHUI38</occupation_ID>
    <occupation_title>Advertising</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name> Big Sales Company</employer_name>
    <employer_email>recuiting@bigsalescompany.com</employer_
    email>
    <empl oyer_ recruiter >Firstname Lastname<employer_ recruiter >
  </employer_details>
<Optional>
  <candidate_requirement_1>problem solving</candidate_requirement_
  1>
  <candidate_requirement_1_weight>0.7
solving</candidate_requirement_1_weight>
  <candidate_requirement_5> team work </candidate_requirement_2>
  <candidate_requirement_5_weight>0.9
solving</candidate_requirement_5_weight>
</Optional>
</specific_candidate_assessment_request>
```

The OPA server may generate an assessment query with or without the attributes and weights 226 and determine candidate assessment score and prepare a candidate report 235. If the employer does not provide the assessment attributes and the weights in 225, the OPA server may optionally retrieve the assessment attributes and attributes weights based on the assessment query 227. For example, the OPA server may provide a HTTP(S) GET message including an XML-formatted assessment attributes and attributes weights 227 similar to the example below:

```
GET /specificrules.php HTTP/1.1
Host: www.OPA.com
Content-Type: Application/XML
Content-Length: 1306
<?XML version = “1.0” encoding = “UTF-8”?>
<candidate_rules>
  <candidate_request_ID>4NF4RG94</candidate_request_ID>
  <timestamp>2011-02-22 15:22:43</timestamp>
  <occupation_details>
    <occupation_ID>JDHUI38</occupation_ID>
    <occupation_title>Advertising</occupation_title>
    <occupation_start_date>2012-01-01</occupation_start_date>
    <opening_close_date>2011-05-31</opening_close_date>
  </occupation_details>
  <employer_details>
    <employer_ID>he876OP </employer_ID>
    <employer_name> Big Sales Company</employer_name>
    <employer_email>recuiting@bigsalescompany.com</employer_
    email>
    <employer_ recruiter >Firstname Lastname<employer_ recruiter >
  </employer_details>
  <candidate_requirement_1>problem solving</candidate_requirement_1>
  <candidate_requirement_1_weight>0.7
solving</candidate_requirement_1_weight>
  <candidate_requirement_5> team work </candidate_requirement_5>
  <candidate_requirement_5_weight>0.9
solving</candidate_requirement_5_weight>
</candidate_rules>
```

The OPA server may determine an assessment score for each candidate who has profiles on file 235. In one implementation, The OPA server may sort all candidates from high assessment score to low assessment score and provide only information of candidates who have the assessment scores higher than the employer specified threshold. The OPA server may further send the candidate assessment report to the employer 240. For example, the OPA server may provide a HTTP(S) POST candidate assessment report message 240 similar to the example below:

```
POST /candidateassessmentreport.php HTTP/1.1
Host: www.OPA.com
Content-Type: Application/XML
Content-Length: 788
<?XML version = “1.0” encoding = “UTF-8”?>
<candidate_assessment_report>
  <cadidate_request_ID>56RWJE456</candidate_request_ID>
  <candidate_details>
    <candidate_ID_1>john.q.public@gmail.com</candidate_ID_1>
    <candidate_name_1>John Q. Public</candidate_name_1>
    <candidate_score_1>99/100</candidate_score_1>
    <candidate_ranking_based_on_all_applicants_1>100%</
candidate_ranking_based_on_all_applicants_1>
    <candidate_ID_2>joe.q.public@gmail.com</candidate_ID_2>
    <candidate_name_2>Joe Q. Public</candidate_name_2>
    <candidate_score_2>92/100</candidate_score_2>
    <candidate_ranking_based_on_all_applicants_2>98%</
candidate_ranking_based_on_all_applicants_2>
  </candidate_details>
  <occupation_details>
    <occupation_ID>JDHUI38</occupation_ID>
    <occupation_title>Advertising</occupation_title>
    <occupation_start_date>2012-01-01</occupation_start_date>
    <opening_close_date>2011-05-31</opening_close_date>
  </occupation_details>
  <candidate_rules>
    <candidate_requirement_1>problem
solving</candidate_requirement_1>
    <candidate_requirement_1_weight>0.7
solving</candidate_requirement_1_weight>
    <candidate_requirement_5>team work</candidate_requirement_5>
    <candidate_requirement_5_weight>0.9
solving</candidate_requirement_5_weight>
    <algorithm>linear regression</ algorithm >
  </candidate_rules>
</candidate_assessment_report>
```

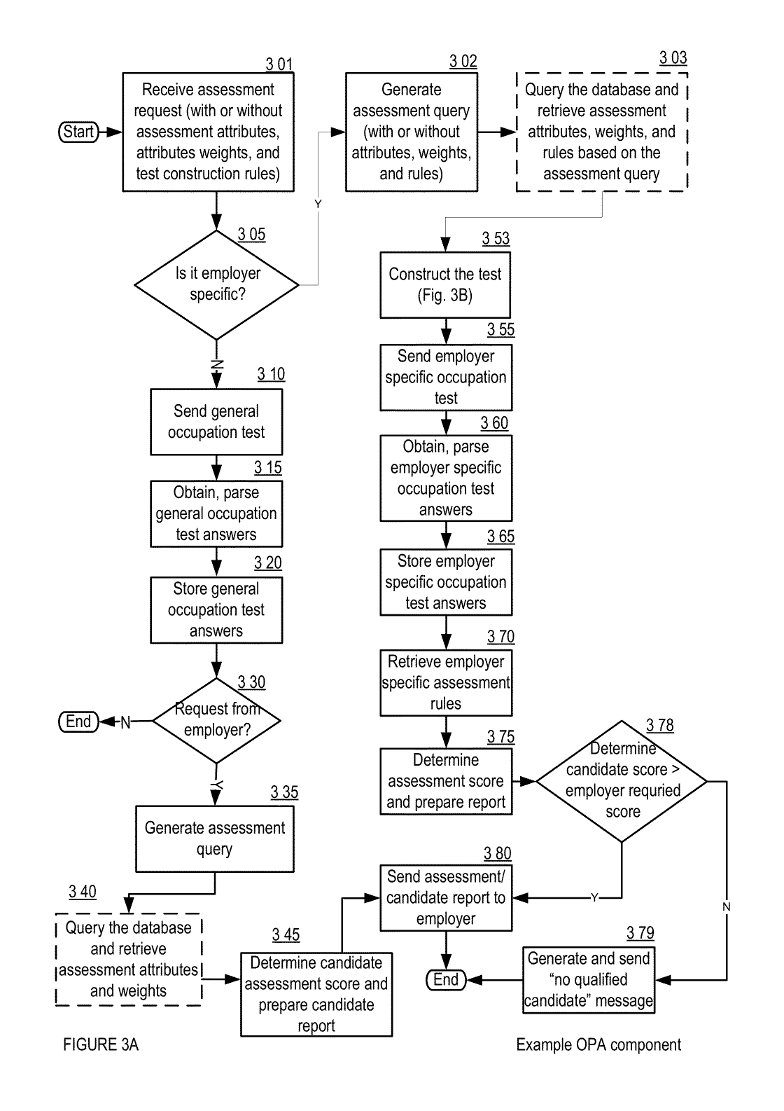

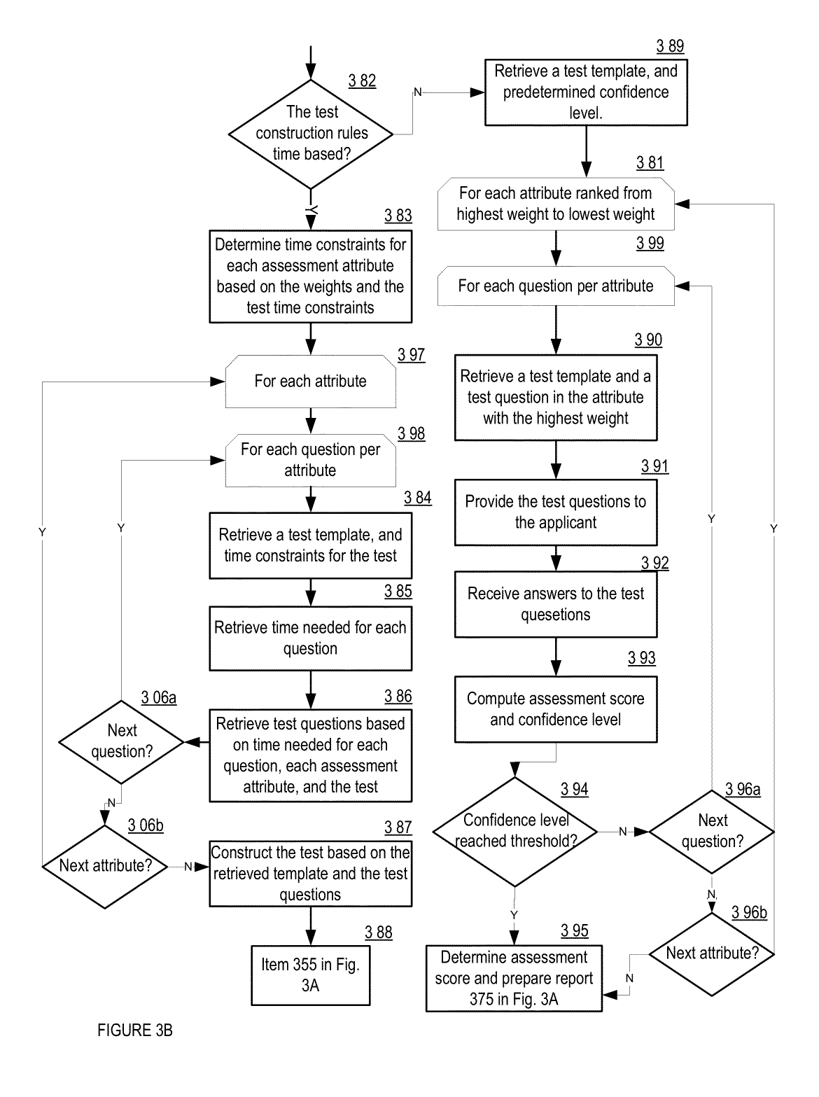

FIGS. 3A-3B show logic flow diagrams illustrating employer and candidate initiated assessment embodiments of the OPA. In one embodiment, the OPA server may receive an assessment request with or without assessment attributes, attributes weights, and the rules to construct the test 301. The OPA server may determine whether the request is from the employer or from the candidate, i.e., whether or not it is employer specific 305. In one embodiment, if the request is not employer specific, the OPA server may send a general occupation test 310 to the candidate. Upon receiving the answers to the test 315, the OPA server may parse the answers to retrieve candidate's profile information, such as, but not limited to, name, address, education background, experiences, answers to each question in each category, and/or the like. The information may be stored in the OPA database 320. If no further action takes place, the process ends. Upon receiving a query from the employer 330 for recruiting the right applicant(s) for a specific position or generally for the employer, the OPA server may generate an assessment query 335 and query the OPA database and retrieve assessment attributes and weights based on the assessment query 340. The OPA may determine a candidate assessment score, and prepare a assessment report 345. The report may be sent to the employer 380.

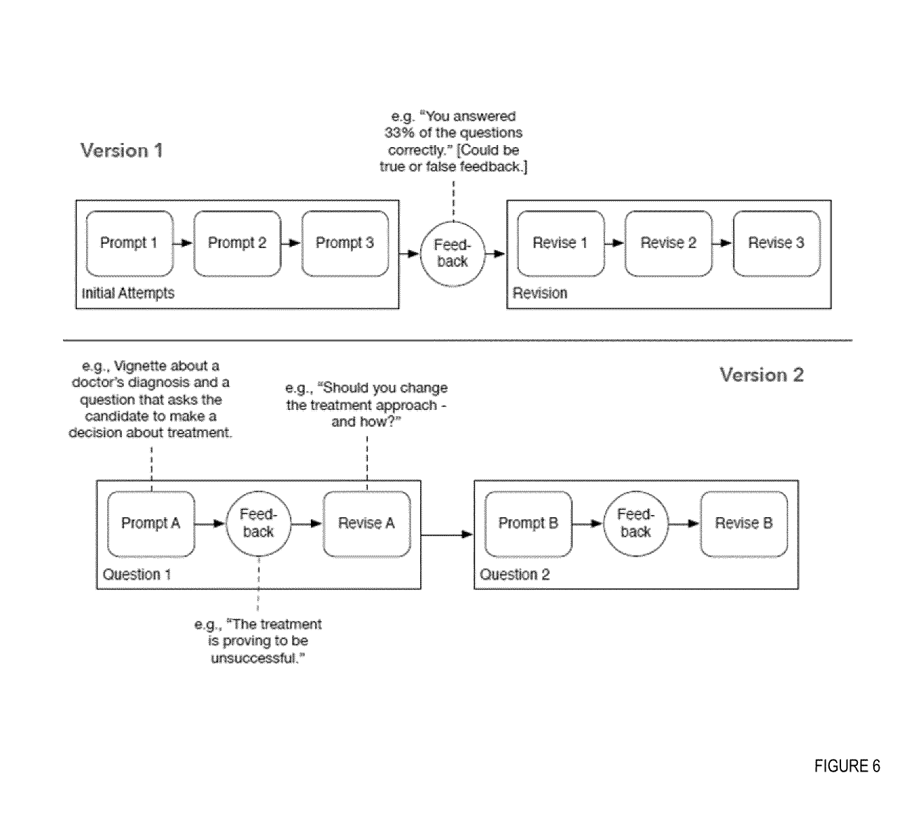

In one embodiment, if the request is employer specific, and/or sent from a specific employer 305, the OPA server may generate an assessment query 302 and query the OPA database and retrieve the attributes and weights based on the query 303. The OPA may further construct the test 353 (details discussed in FIG. 3B) and send to candidates 355. Upon obtaining answers to the test, the OPA server may parse the employer/occupation specific test answers 360, which may then be stored in the database 365. The OPA server may retrieve employer and/or occupation specific rules (different weights for different assessment category 370 and determine an assessment score 375. The OPA server may package a test to provide to the candidate. For example, in one implementation, the OPA server may adjust the difficulty of the test to determine the limits of the candidate's knowledge in a filed. For example, if the initial sets of questions are answered correctly by the candidate, the OPA server may increase the difficulty of the questions and continue increasing it until the candidate fails the test to determine a skill level; alternatively, if the initial sets of questions are answered incorrectly by the candidate, the OPA server may decrease the difficulty of the questions and continue decreasing it until the candidate answers it correctly to determine the skill level. The results may further be used as a feedback to provide to the candidate to improve on their specific skills. The candidate's response to the feedback may be examined and assessed by the OPA to provide further assessment about the candidate. Details about the response to feedback assessment are discussed in FIG. 6. If the candidate assessment score is higher than the employer required threshold 378, the OPA server may send an assessment report and/or score of this candidate to the employer 380. If no candidate assessment score is higher than the employer required score, the OPA server may generate and send a “no qualified candidate” message 379.

In one embodiment, the OPA server may be implemented to determine candidates' assessment for both employer specific occupation request or general occupation test. For example, the decision of whether the test request is employer specific or not (e.g., 305) may not be needed.

With reference to FIG. 3B, in one embodiment, the rules to construct the test may be time based or confidence level based. If the test construction rules are time based 382, the length of the test may be predetermined (e.g., the test takes 20 minutes to finish). The time needed to finish each assessment domain may be equally divided (e.g., if there are 4 assessment domains, each domain may take 5 minutes to finish.) Alternatively, the time needed to finish each assessment domain may be propotionally to the attribute weights, (e.g., if the attribute weights for the 4 domains are 10%, 20%, 30%, and 40%, the time needed to finish each assessment domain questions may be 2 minutes, 4 minutes, 6 minutes, and 8 minutes, respectively.) If the test construction rules are time based 382, The OPA server may determine time constraints for each assessment attribute based on the weights and the test time constraints 383. For each attribute 397, and for each question of the attribute 398, the OPA server may retrieve a test template, and the time constraints for the test 384. The OPA server may further retrieve time needed for each question 385, and retrieve test questions based on time needed for each question, each assessment attribute, and the test 386. The OPA server may determine if another question is needed to satisfy the time constraints 306a. If so, the OPA server may perform the task from 398 again by retrieving a test template 384. If no, the OPA server may determine if another attribute is needed to satisfy the time constraints 306b. If so, the OPA server may perform the task for the next attribute 397 by retrieving a test template for each question 398. If not, the OPA server may further construct the test based on the retrieved template and the test questions 387. The OPA server may continue to item 355 in FIG. 3A. The time constraints may be determined by the OPA server, or provided by the employer and/or the applicant.

If the test construction rules are confidence level based 382, the test may be constructed adaptively until a predetermined confidence level is reached. For example, the questions in the most important assessment domain (in one implementation, this may be the assessment domain with the highest weight) may be provided first to the applicant. Upon receiving the answers, an assessment score may be computed. The OPA server may provide further questions in this domain and other assessment domains until a predetermined confidence level about the assessment score is reached. For example, if a predetermined confidence level is 80% and the computed score of the applicant assessment is 95 out of 100 when 80% confidence level is reached, which means there will be 20% chance that the score of the applicant assessment may be higher or lower than 95, the OPA server may terminate the test and provide the assessment score and the confidence level to the employer. In one embodiment, the OPA server may retrieve a test template, and predetermined confidence level 389. The OPA server may, for each attribute starting from the highest weight 381, and for each question per attribute 399, retrieve a test template and test questions in the assessment attribute 390. The OPA server may provide the test question to the applicant 391. Upon receiving answers 392, the OPA server may compute an assessment score and the confidence level 393. If the confidence level has reached the pre-determined threshold 394, the OPA server may determine 395 the assessment score and prepare the assessment report, as discussed in 375 of FIG. 3A. If the confidence level has not reached the pre-determined threshold 394, the OPA server may determine if another question is needed to satisfy the confidence level 396a. If so, the OPA server may perform the task from 399 again by retrieving a test template 390 for each question. If no, the OPA server may determine if another attribute is needed to satisfy the confidence level 396b. If so, the OPA server may perform the task for the next attribute 381 by retrieving a test template for each question 390 If not, the OPA server may calculate the final assessment score and prepare a report to return to item 375 in FIG. 3A.

FIG. 4A shows a screenshot diagram illustrating motivational orientation attribute measurement user-interface of the OPA. In one embodiment, the motivation orientation attribute may be measured as the time taken to answer a question. For example, a shorter response time to answer one question over the other indicates greater accessible. More accessible cognitions are more likely to influence behavior and decision making. Consider two responses: “I hope to meet my sales goals this year!” with 0.5 second latency, and “Um, I do not want to miss my sales goals this year” with a 5.0 second latency.

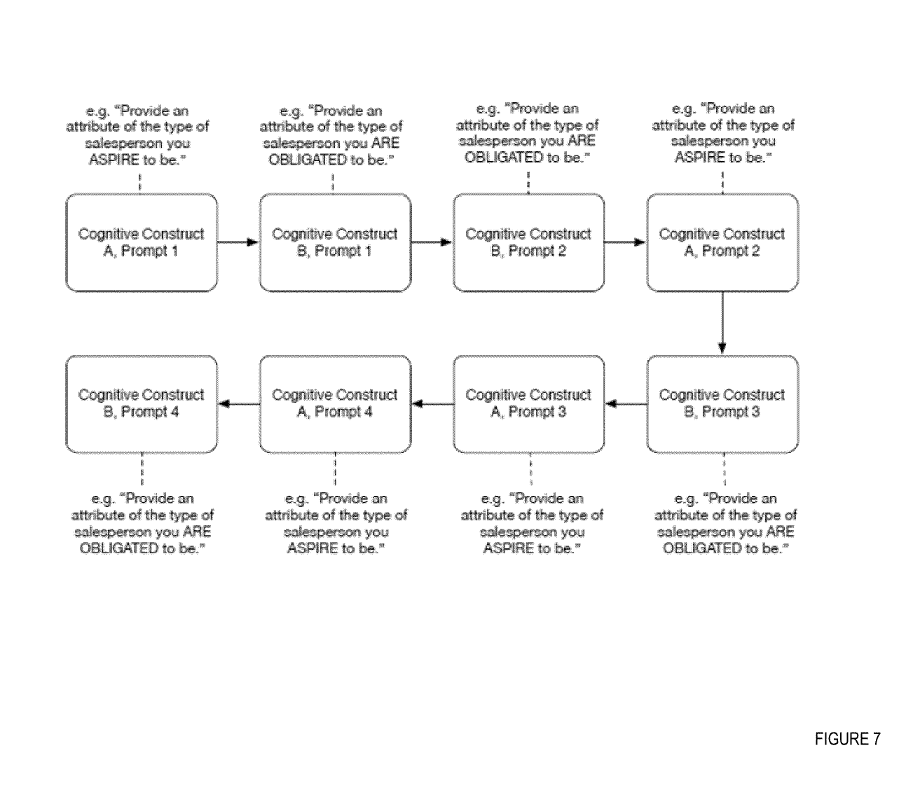

In one embodiment, the OPA may collect information about the accessibility of specific cognitions that may influence a behavior and decision making. More accessible cognitions are identified through faster response times when answering questions. FIG. 7 shows a block diagram illustrating an example cognitive accessibility assessment mechanism in some embodiments of the OPA. For example, participants are presented with a series of prompts and are asked to respond to each prompt as quickly as possible. Responses can be provided via voice, keyboarding, or forced response paradigms. Prompts are designed to address specific cognitive structures, such as specific motivations, attitudes, preferences, affects, etc. Shorter response times to specific questions/prompts are indicative of more accessible cognitions that have the ability to influence, and possibly bias, an individual's behavior and decision making. Response times to answer the prompts to the two cognitive constructs are compared for each individual (treated as a “within participant” variable). Significantly faster response times indicate more accessible cognitive constructs that are likely to influence the candidate's thoughts, behaviors, and decisions.

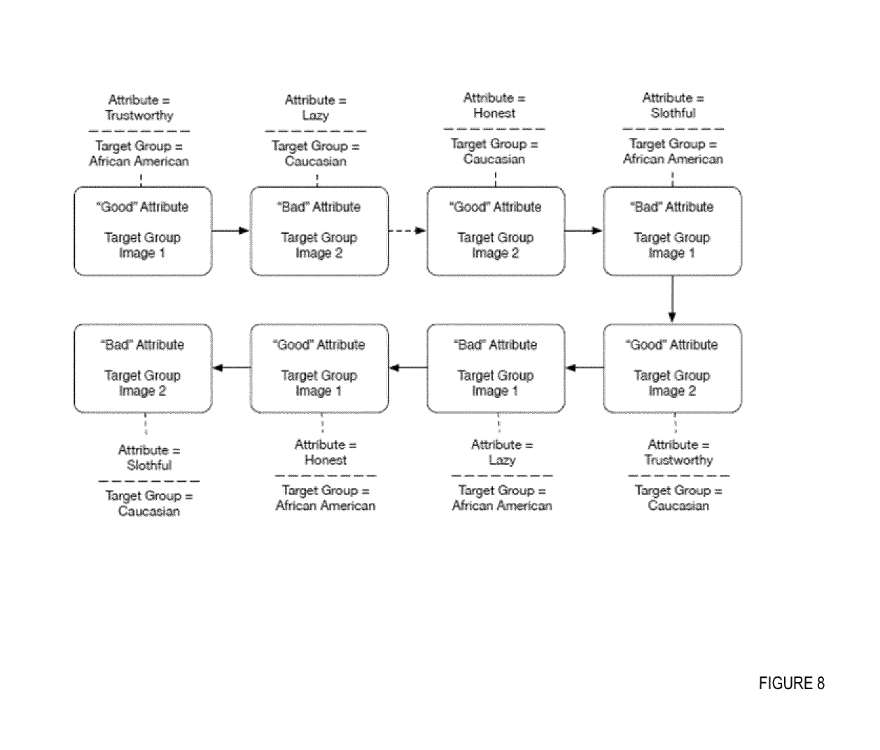

Certain attitudes and beliefs (e.g., prejudices, self-esteem, moral decisions, ethics) are difficult to measure because of the pressures of socially desired expectations. In one embodiment, the implicit assessment mechanism may use response times to collect information about attitudes that an individual might not be willing to share or aware of. FIG. 8 shows a block diagram illustrating an example implicit assessment mechanism in some embodiments of the OPA. For example, participants are asked to make a series of rapid decisions and categorize/classify stimuli according to specific criteria. The stimuli are chosen to be representative of specific cognitive constructs that can be indicative of specific attitudes/beliefs. Through an examination of response times to the questions, cognitive structure that identify specific attitudes/beliefs can be created. Through this paradigm, attitudes/beliefs about the individual, the organization, the field of industry, etc. Participants are instructed to either (1) press the space bar as quickly as possible for items belonging to either of the labeled categories, or (2) do nothing for items that did not belong. Response times are calculated to examine the implicit attitudes the individual might hold.

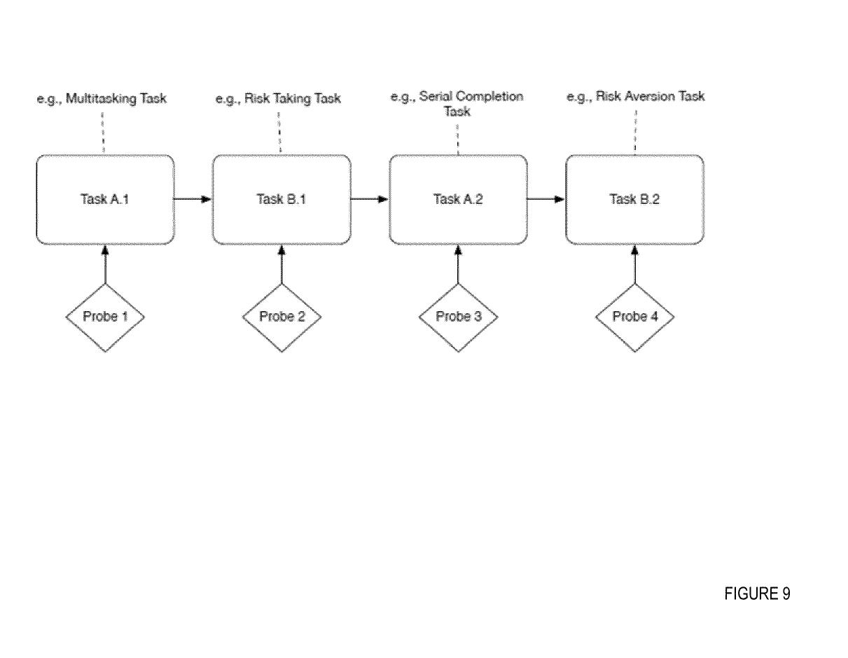

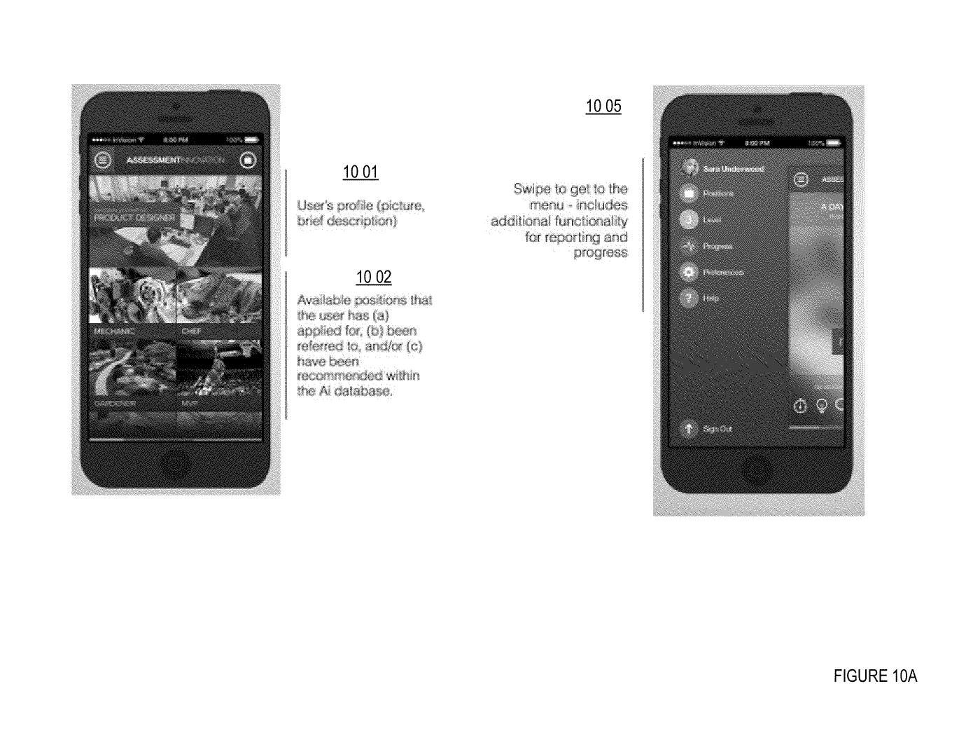

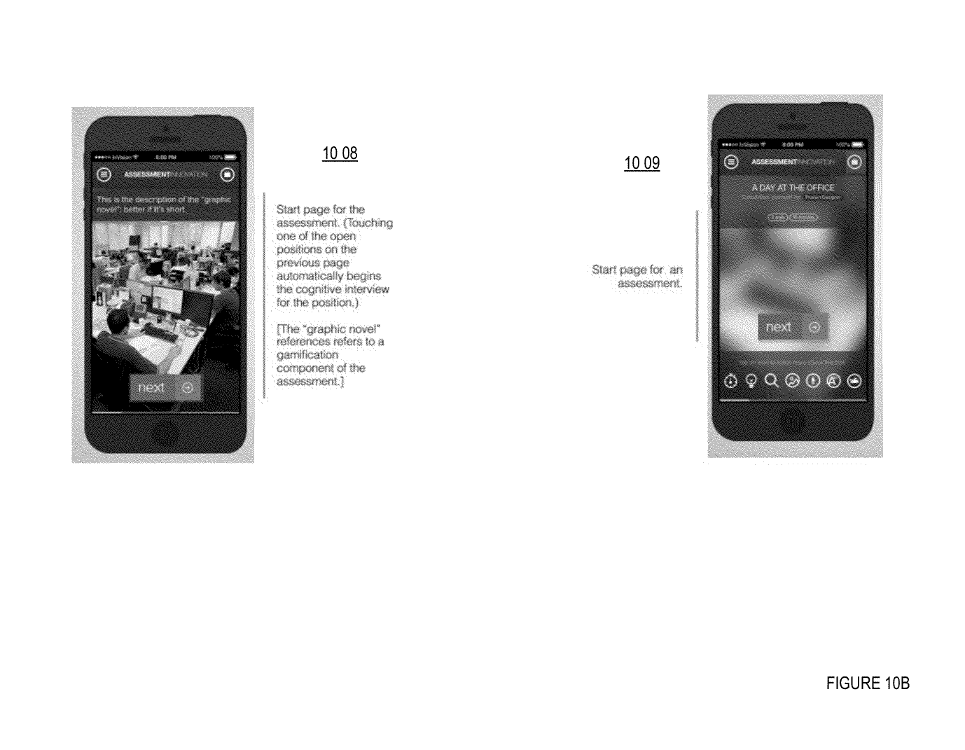

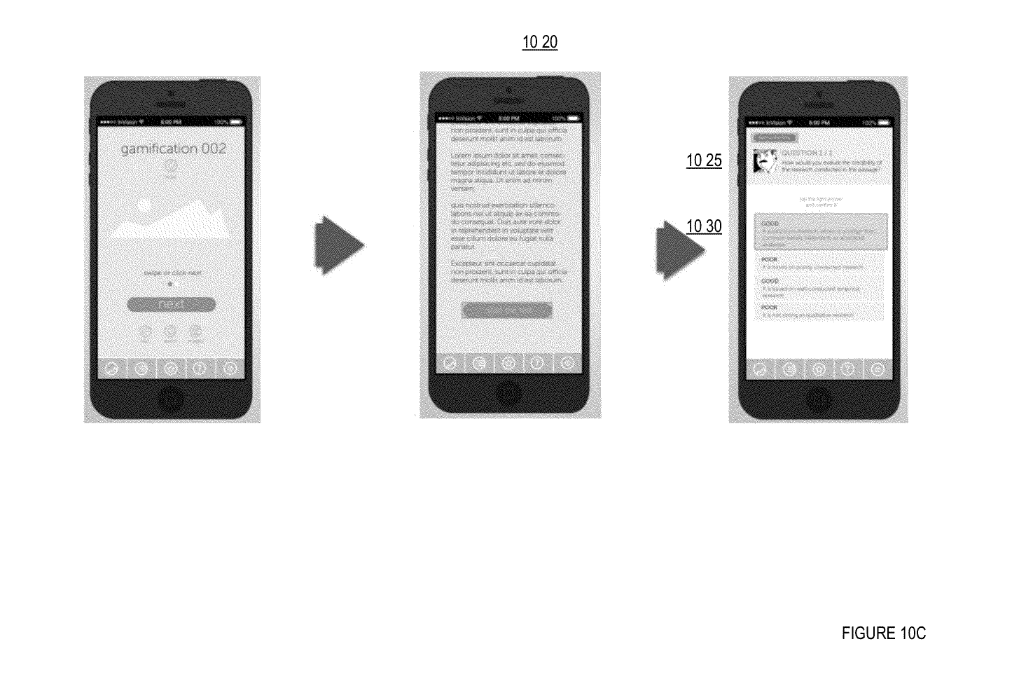

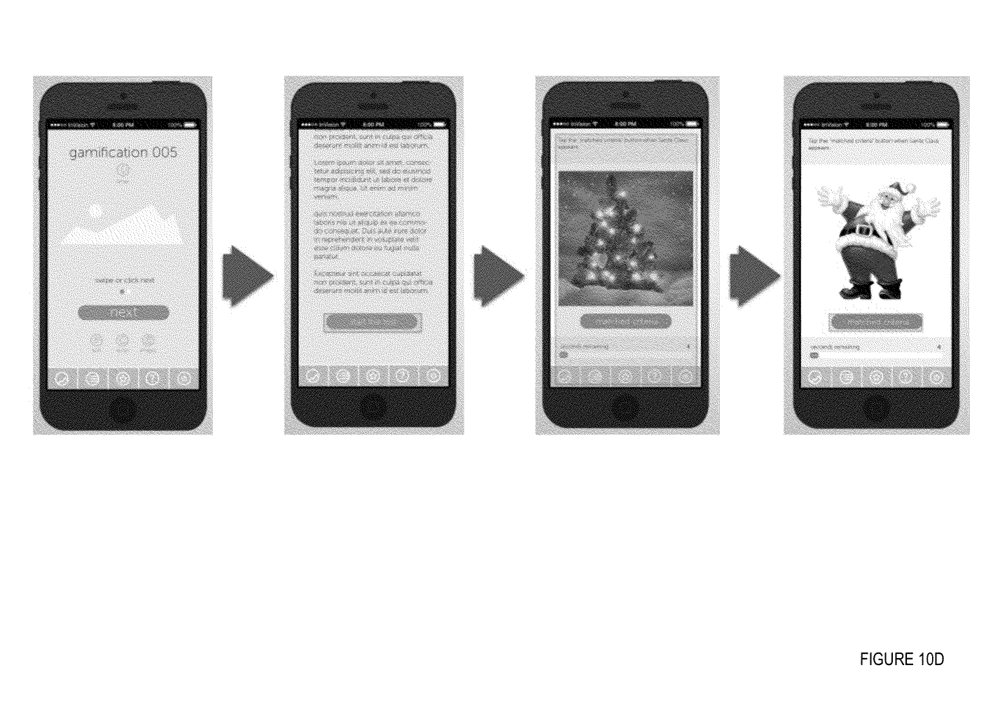

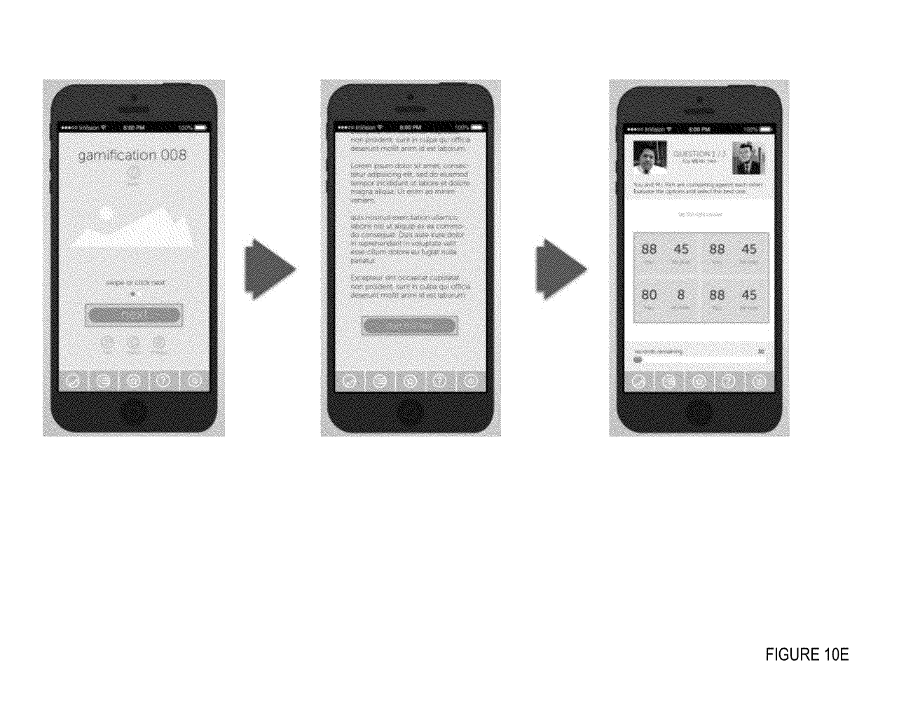

In one embodiment, the OPA may use attention probe assessment to examine an individual's engagement in an activity and helps to determine natural inclinations and preferences. FIG. 9 shows a block diagram illustrating an example attention probe assessment mechanism in some embodiments of the OPA. For example, prior to starting the assessment, the participant is told to provide a specific response anytime a signal is emitted—e.g., “hit the spacebar when you hear a beep.” Participants then engage in a number of different tasks that address various types of work-related activities (e.g., multitasking, computations, reading, etc). The signal (probe) is then delivered on a predetermined basis as the participants engages in the tasks. Longer response times are indicative of the participants being more cognitively engaged (e.g., intrinsically rewarding—or—more challenging) in the target activity.

In one embodiment, the following attributes may be used to assess both generalized as well as occupational cognitive capability:

(1) Executive Function (EF)

(2) Short-Term and Working memory (STWM)

(3) Problem Solving (PS)

(4) Critical Thinking (CT)

(5) Reasoning and Bias (RB)

These 5 aspects of cognition may be measured using a variety of tasks and assessments, employing different response measures and the precise tasks and assessments, as well as measures and their validation may be described in subsequent sections. Measures may allow us to derive a Generalized Cognitive Capabilities Index (GCC Index) consisting of normalized values with resolution dependent upon the number of assessments taken for each of the 5 aspects. Normalization may be based upon the score located relative to a derived normal distribution of scores on the task concerned (see validations). This is typically expressed as z and ranges from minus to positive values, where positive values are higher than average performance and negative values are lower than average performance). Raw scores may also be given. A typical GCC Index might look like this (for convenience, assumes means of 0.5 and standard deviations of 0.15 are assumed):

TABLE 1

| | GCC | z(GCC) |
|---|---|---|
| EF | 0.63 | 0.83 |
| STWM | 0.38 | −0.8 |
| PS | 0.75 | 1.67 |
| CT | 0.88 | 2.53 |
| RB | 1.0 | 3.33 |

In addition, the Index scores would also generate a brief 200-500 word narrative report that would include the implications of scores on all 5 aspects. Mapping scores to report would be achieved by merging pre-prepared texts.

In one embodiment, the Occupational Cognitive Capabilities Index (OCC Index) includes the same core index aspects as the GCC Index but differs from the GCC Index in the nature of the assessments: in

this instance assessments may be designed to be specific to the occupation or profession being assessed and would be designed in consultation with industry specialists. There are 2 additional aspects of cognition included in the OCC Index as well as additional measures of Learning, Motivation and Creativity, in these instances, assessment may be occupationally specific (Search and Recognition, Social Cognition and Learning) or more generalized in nature (Motivation and Creativity). Taken together the OCC Index comprises measures of:

(1) Executive Function (EF)

(2) Short-Term and Working Memory (STWM)

(3) Problem Solving (PS)

(4) Critical Thinking (CT)

(5) Reasoning and Bias RB)

(6) Search and Recognition (SR)

(7) Social Cognition (SC)

(8) Learning (LN)

(9) Motivation (MO)

(10) Creativity (CR)

Note that items additional to the core items are designed to be optional. For instance, it may not be necessary for a health services manager to be assessed on Search and Recognition, more suited to an air-traffic controller, for whom, in turn, it might not be necessary to measure creativity.

Aside from a more detailed and descriptive narrative report of the OCC Index, analysis may also focus on the relationship between GCC and OCC indices. So, for example and with reference to the indices above, this test participant scores lower on occupational equivalents of the GCC index in almost all areas, although the differences are small [on average d(z)=0.67]. This would suggest the test participant is performing below their true potential in the occupation concerned, performance which recommends appropriate training to improve occupational performance indexed by these aspects.

Returning back to FIGS. 4B-C which show exemplary tests in measuring the executive functioning attribute in some embodiments of the OPA. In one embodiment, the executive functioning attribute may measure mechanism(s) that regulate, control, and manage cognitive processes. The term includes reference to attention, inhibition, mental flexibility, multi-tasking, and initiation and is involved in the planning, monitoring of working memory, reasoning and problem solving. Executive function may be involved in managing novel situations as well as those requiring cognitive effort or control. Several tests may be used to measure the executive function attribute.

The Color-Word Interference or ‘Stroop’ Test: this test measures ability to inhibit a dominant and automatic verbal response and typically employs the colored names of different colors. This test is considered to measure selective attention and is used as a tool in the evaluation of executive functions in so far as it is an index of the degree to which the test participant can inhibit an immediate response option in favor of an alternative. A variant, proposed here is the Number-Word Interference (NWI) Test, using number words. The test requires reporting either the number of words presented or the numerical value of the words, as shown in FIG. 4A. The number of words and the numerical value can be either congruent or incongruent with one another. In order to give correct answer in incongruent situations it is required to focus on the required aspect of the stimulus and suppress the irrelevant aspect to which the correct response is the number of words, so ‘three’. In alternate conditions, the written number, or a neutral, non-number word requires report. The NWI Test measures report accuracy and reaction time (RT).

The Continuous Performance Task (CP) is a neuropsychological test which measures a person's sustained attention and impulsivity. A test participant is told that they may see or hear the numbers “1” or “2” and that they are to click the mouse when presented with a visual or auditory “1” and not respond when presented with a “2”. In “high demand” test blocks, the ratio of targets to non targets is set to 7:1. This creates a continuous response set such that when the test-taker is suddenly presented with a foil, he or she may find it difficult to inhibit response. Thus, the high demand sections encourages “errors of commission”, or impulsivity. A “low demand” block encourages 23 “errors of omission” or inattentiveness because targets are presented infrequently (1:7), and the inattentive test-taker is likely to lose focus and drift off, thus missing the target when it appears. The CPT measures report accuracy and RT.

The Continuous Performance Error Detection Task (CPED) is a novel variant of the CP Task above in which low demand is varied in the presence of distractor letters presented at varying probabilities to encourage inattentiveness. Test participants may be presented diotically with two letter streams presented asynchronously at varying rates of between 5 and 0.5 Hz to one ear after another. They may be asked to respond to the relatively frequent presence of one letter in one stream by depressing one mouse key and to depress a second mouse button to a relatively infrequent target presented to the other ear. The combination of rapid presentation and infrequent presentation of the target may encourage the test participant to favour selection of the more frequent response. If, however, they retrospectively register (detect) their error, they indicate by pressing any computer key.

A Working-Memory-Based Go-No Go Task (GNG) is proposed in which, analogous to performance in the CPT test participants are asked to respond by button press to one target letter with one hand and a second target letter with another. This is given certain conditions related to the letter composition of a preceding sequence of letters (presented as a rapid serial auditory stream at 1 Hz). As shown in FIG. 4C, test participants may be asked, for instance to respond to an “X” target with the left hand if preceded by between 1 and 7 letters in the previous stream of 12 letters and a “Y” with the right hand if preceded by a second set of letters. An incongruent sequence requires no response. The task may be made more or less difficult by varying the number of letters (working memory capacity) and co-varying letter sets (presence of distractors on attention and working memory) so for example test participants may be asked to respond if “D” “G” and “U” are presented before “X” which is easier than the set “J” “F” “D” “G” “U”. A typical continuous stream might appear as in FIG. 4C, wherein a left hand response is required and then to the second “X” no response is required. The GNG Task measures response accuracy.

An example of an applied (OCC) variation on this task is as follows. This example task involves classification of emails into “YES” or “REMOVE” categories, both of which require dispatch to one of two alternative email addresses. The assessee is informed that their company has contacted 100,000 people with a view to their inclusion in a mailing list, replies are asked to replace the subject line of the invitation with either YES, if they wish or REMOVE if they don't wish to be included, however, typically, some people leave the subject line as is and type YES or REMOVE in the body of the email (usually either at the top or bottom). The mailing list needs to be successfully populated rapidly as it refers to information on an event occurring later that day. Most replies may be successfully formatted and the email system is designed such that these may automatically be forwarded on to the relevant email address without entering the inbox. The task here is to scan emails arriving in the inbox for YES and REMOVE and forward on appropriately. The screen should show a simulated email programme with folders to one side, the inbox and a window allowing the body of emails arriving in the inbox to be viewed. The programme should be configured such that the assessee can forward on emails to one or other of two alternative email addresses without typing an email address in. Their job is simply to scan (classify contents) and respond. The adaptive element of this task is that the programme changes the rate of income emails according to performance. Starting at a rate of 1 email per second, every 20 seconds the proportion of emails correctly handled is calculated (i.e. the number correctly forwarded relative to the number arriving, incorrect forwards are also counted). In the event that the proportion is between 0.875-1.0 the rate is increased by some amount, say multiplied by 1.25 (we can modify this during testing). If the proportion falls below this in the range 0.75-0.8749 it remains as is (modified by addition or subtraction of one or two emails per 20 second randomly determined) and if it is less than 0.749 it is reduced by 0.75 (rounding may have to apply at some stage of course). There are (at least) 12 20 second trials lasting 4 minutes (this is as far as assessment is concerned, the assessee may not be aware of anything other than changes in the rate of incoming emails. This assessment gives information (i) on what is the optimal rate at which emails can be classified and correctly managed (i.e. the rate at which performance stabilizes in the range 0.75-0.875 so well above chance and accounting for natural error) as well as (ii) the rate of information presentation at which classification and response breaks down (the highest rate at which performance stops improving and starts decreasing, so where performance shifts from 0.75+% correct to less than 0.749% correct. Also (iii), the rate at which information processing capacity is reached (similar to (ii) but indexed by the number of emails managed at all relative to those coming in). In this latter case, we measure a performance ceiling and on this basis it can be argued, our measure is relevant to performance for which additional training can be required. This is a very basic scenario which can be modified in various ways to increase complexity and thus measure different types of cognitive performance. For example, spam can be included to see to what extent distracting information influences classification (can a response to this be inhibited—would they trash these mails or just leave them). Alternatively, emails requesting more information (and/or not urgent), so how can the assessee deal with 3 categories instead of 2.

In one embodiment, the short-term and working memory attribute may actively holds the multiple pieces of temporary information required for on-going cognitive processing. Typically, working memory holds higher level information of the sort required for reasoning, calculation and problems solving. Short-term memory (or “primary” or “active memory”) is the capacity for holding a small amount of information in mind in an active, readily available state for a short period of time. The duration of short-term memory (when rehearsal or active maintenance is prevented) is believed to be in the order of seconds. A commonly cited capacity is 7±2 elements. Unlike short-term memory, working-memory tasks concern the active manipulation of information or behaviors and are generally contributive to completion of specific cognitive tasks in settings of interference and/or distraction. Working memory is related to the executive and attentional control of short-term memory, which permits interim integration, processing, disposal, and retrieval of information; however it is also measured independently. Cognitive Load is a concept derived from the most current “time-based resource sharing model” of working memory, which assumes that representations in working memory decay unless they are refreshed. Refreshing requires an attentional mechanism that is also needed for any concurrent processing task. When there are small time intervals in which the processing task does not require attention, this time can be used to refresh memory traces. The theory therefore predicts that the amount of forgetting depends on the temporal density of attentional demands of the processing task—this density is called “cognitive load”. The cognitive load depends on two variables, the rate at which the processing task requires individual steps to be carried out, and the duration of each step.

Short-Term Memory Capacity (STMC) may be examined using a free-recall task for words controlled for frequency and word length. To control for recency effects, to-be-remembered words may be presented in lists padded with distractors. As an additional measure distractors may be varied in frequency to assess susceptibility to word frequency during recall. Words may be selected from a standardized corpus such as the Celex database. Note that in the OCC index, an additional measure of “chunking” (a process by which a person organizes material into meaningful groups) may be examined, using occupationally-specific information. In one embodiment, the STMC Task measures the number of items correctly recalled.

Short-Term Memory Duration (STMD) may be examined using a variant on the task above in which, recall is delayed over a variety of several-second intervals. In one embodiment, the STMD Task measures the number of items correctly recalled.

Working Memory Capacity (WMC), ordinarily defined as 4 chunks may be assessed using a “complex span” task in which test participants may be asked to read a number of sentences (usually between 2 and 6) and try to remember the last word of each sentence. At the end of the list of sentences, they repeat back the words in their correct order. In one embodiment, the WMC Task measures the number of items correctly recalled and orders of items recalled correctly.

Cognitive Load (CL) may be assessed by adding digits presented serially at particular rates (2 Hz-0.125 Hz) and of increasing amounts. Having to add another digit every half second places a higher cognitive load on the system than having to add another digit every two seconds. Adding larger digits takes more time than adding smaller digits, and therefore cognitive load is higher when larger digits may be added. In one embodiment, the CL Task measures the number of items correctly recalled. Note that a highly accurate picture of working memory performance can be derived from the corresponding analysis of short-term and working-memory performance alongside performance in executive function, problem-solving and learning tasks.

FIGS. 4D-4E show exemplary tests in measuring the problem solving attribute in some embodiments of the OPA. In one embodiment, problem solving attribute may be a desire to achieve a definite goal from any given current condition that either is (i) not of itself able to achieve that goal; (ii) is not proximal to the goal state; or (iii) needs a non-trivial logic for discovering the unspecified conditions or steps toward the goal (Robertson, 2001). Problem solving is thus the end part of a more general process that includes defining current and goal states and discovering the intervening steps or pathway to goal resolution. In the GCC index 3 aspects of problem solving performance may be measured: “Insight”, “Analogy” and “Means-Ends Analysis”. Because occupational or professional performance frequently demands strong analytical problem solving skills, detailed analyses of problem solving in situated contexts are proposed—and generally these may take the form of a means for advanced and highly detailed means-end analysis. These tasks may measure success in overall goal completion as well as intermediate goal completion; they may use path analysis as well as task completion times as additional measures. An “troublesome repair” example is given as follows.

As manager of the workshop in an auto dealership you deal mainly with servicing and repairing crash damaged vehicles. You have been contacted by telephone by the owner of a vehicle damaged in a collision; they inform you that not only was the collision not their fault, but their vehicle requires repairs to the front right wing and front passenger door (the functional damage is an inability to lower or raise the window, the door is lockable). They are fully insured. In the following you may be asked to choose in several steps from several alternative courses of action. From time to time new information may be provided to guide your choice of action. Your dealership prides itself on “Getting the Job Done!” as well as high levels of customer satisfaction. However business is slack due to the recession and some belt tightening has been recommended by the franchise owner (the boss!).

Your task is to maintain as high a level of customer satisfaction as possible, with it in mind that any additional cost may displease your boss. Best performance is when customer satisfaction remains high and boss satisfaction is not lowered, worst performance is when both customer and boss satisfaction are at their lowest.

Variables: Job done score (JDS)=0; Customer satisfaction score (CSS)=1; Boss satisfaction score (BSS)=1; No of steps (NS)=0; Red Flag variable (RF)=0;

1. The customer calls you and asks you what to do next. You advise the customer to:

A) bring the car to our workshop for an assessment of the damage (CSS *=1.5) (go to 1.1.1) (Show total CSS)

B) seek an independent assessment of (assessor for) the damage (go to 3.1.1) (Show total CSS)

C) contact the insurance company to arrange an independent assessment (CSS*=1.5) (go to 3.1.1.1) (Show total CSS) (JDS+=0.25)

NS+=1

1.1.1 The customer arrives with the car, you:

A) have one of your mechanics look at it (go to 1.1.2)

B) advise the customer to seek an independent assessment of (advisor for) the damage (CSS *=0.75) (go to 3.1.1) (Show total CSS)

C) advise the customer to contact the insurance company to arrange an independent assessment (CSS *=0.85) (go to 3.1.1.1) (Show total CSS) (JDS+=0.25)

D) arrange an independent assessment of the damage (go to 2.1.1) NS+=1

1.1.2 The mechanic reports on the damage, the right hand front wing and front passenger door needs to be replaced, you:

A) authorise your mechanic to carry out repairs (CSS *=1.2) (go to 5.1.1) (RF=1)

B) advise the customer to seek an independent assessment of (advisor for) the damage (CSS *=0.75) (go to 3.1.1) (Show total CSS)

C) advise the customer to contact the insurance company to arrange an independent assessment (CSS *=0.75) (go to 3.1.1.1) (Show total CSS) (JDS+=0.25)

D) arrange an independent assessment of the damage (go to 2.1.1) NS+=1

2.1.1 The independent assessor informs you that he may be commissioned by the insurance company directly and on the request of the customer, you advise the customer

A) to contact the insurance company to arrange an independent assessment (CSS *=0.75) (go to 3.1.1.1) (Show total CSS) (JDS+=0.25)

B) to bring the car to our workshop for an assessment of the damage (CSS *=1.5) (go to 1.1.1) (Show total CSS)

C) to seek an independent assessment of (advisor for) the damage (CSS *=0.75) (go to 3.1.1) (Show total CSS)

NS-F=1

3.1.1 The customer contacts you mentioning that they had contacted an independent assessor to be told they should contact the insurance company to arrange independent assessment (CSS *=0.75) (Show total CSS). They have since arranged via the insurance company to have the vehicle assessed and you receive the assessment details from the assessor (JDS+=0.25), as well as details, hitherto unknown, of the insurance company. You discover it is a company you have dealt with 14 times over the previous 12 months and who have yet to pay for 7 repairs. The boss may be unhappy because business is not good and money is not coming in as it should

(or)

3.1.1.1 The customer arranges via the insurance company to have the vehicle assessed and you receive the assessment details from the assessor (JDS+=0.25), as well as details, hitherto unknown, of the insurance company. You discover it is a company you have dealt with 14 times over the previous 12 months and who have yet to pay for 7 repairs. The boss may be unhappy because business is not good and money is not coming in as it should

Given this situation you:

A) authorize your mechanic to carry out repairs irrespective to the risk that you may not receive payment in time (CSS *=1.25) (go to 5.1.1)

B) inform the customer of the circumstances and decline to repair (CSS *=0.25) (end of scenario JDS=0) (Show total CSS) (go to 7.1.1)

C) wait for payment for at least half of the outstanding repair payments to cover you in the event that payment for this repair is also late (go to 4.1.1)

NS+=1;

4.1.1 After 2 weeks and non-payment of outstanding repair bills from the insurers the customer calls anxious to schedule the repair, you:

A) authorize your mechanic to carry out repairs irrespective to the risk that you may not receive payment in time (CSS *=1.15) (go to 5.1.1)

B) inform the customer of the circumstances and decline to repair (CSS *=17.1s) (end of scenario JDS=0) (Show total CSS) (go to 7.1.1)

NS+=1;

5.1.1 You order parts from the main national parts distributor and are given a 1 week delivery estimate. One week passes and while the wing is delivered, the door remains undelivered. You make an enquiry to learn that due to industrial action at embarkation ports in Japan, door delivery is delayed (with an uncertain but lengthy delay likely). There are second and third options to source parts from S America (guaranteed delivery in in one week) or, in the mean-time use the door from a forecourt vehicle, decommissioning that vehicle until an alternative can be found. In the second case the part is immediately available but costs 125% of the sum proposed by the assessor and agreed with the insurance company. In the third case the vehicle cannot be sold until a door becomes available, there are 2 vehicles available. Do you:

A) decommission a forecourt vehicle and fit the door onto the damaged vehicle (CSS *=2) (end of scenario JDS=1) (Show total CSS) (BSS *=0.5) (go to 8.1.1)

B) Source the door from S. America and fit when available (CSS *=1.5) (end of scenario JDS=1) (Show total CSS) (BSS *=0.75) (go to 9.1.1)

C) continue to wait for the door from Japan, delivery is estimated in 1-2 months (CSS *=0.25) (Show total CSS) (go to 6.1.1)

D) inform the customer of the circumstances and decline to repair (CSS *=0.05) (end of scenario JDS=0) (Show total CSS) (go to 7.1.1)

NS+=1;

6.1.1 The customer is now somewhat irate and points out that they require the vehicle for a long distance journey, for which, they would prefer it not to be in a damaged state. Do you:

A) decommission a forecourt vehicle and fit the door onto the damaged vehicle (CSS *=2) (end of scenario JDS=1) (Show total CSS) (BSS *=0.5) (go to 8.1.1)

B) Source the door from S. America and fit when available (CSS *=1.5) (end of scenario JDS=1) (Show total CSS) (BSS *=0.15) (go to 9.1.1)

C) continue to wait for the door from Japan, delivery is estimated in 1-2 months (CSS *=0.25) (Show total CSS) (go to 10.1.1)

D) inform the customer of the circumstances and decline to repair (CSS *=0.05) (end of scenario JDS=0) (Show total CSS) (go to 7.1.1)

NS+=1;

7.1.1 The customer is entirely dissatisfied and takes the vehicle for repair elsewhere, informing the insurance company who are now dealing directly with your boss on the issue (BSS *=0.25).

If RF=0;

8.1.1 The customer is probably as happy as they can be, at the end of the day you have come through for them and they are grateful for your flexibility and ability to find a solution. The next car they buy may be from your dealership. Your boss is not so pleased mind you.

9.1.1 At the end of the day the customer is satisfied and the job is finally done, your boss grumbles a little about the extra cost.

10.1.1 At last the door is delivered from Japan and fitted by your mechanic. It cannot be said that the customer is particularly pleased (CSS *=0.25) (end of scenario JDS=1) but you are spared the wrath of your boss who has incurred no loss.

If RF=1;

8.1.1 You find the insurance company may not pay because they were not approached for damage assessment (i.e. to send out the assessor). The customer is probably as happy as they can be, at the end of the day you have come through for them and they are grateful for your flexibility and ability to find a solution. The next car they buy may be from your dealership. Your boss is furious and talks about the cost of the repair coming out of your wages (BSS=0).

9.1.1 You find the insurance company may not pay because they were not approached for damage assessment (i.e. to send out the assessor). At the end of the day the customer is satisfied and the job is finally done. Your boss is furious and talks about the cost of the repair coming out of your wages (BSS=0).

10.1.1 You find the insurance company may not pay because they were not approached for damage assessment (i.e. to send out the assessor). At last the door is delivered from Japan and fitted by your mechanic. It cannot be said that the customer is particularly pleased (CSS *=0.25) (end of scenario JDS=1), However unfortunately and in spite of all of your efforts, your boss is furious and talks about the cost of the repair coming out of your wages (BSS=0).

Analogical Problem Solving (APS): measuring efficiency in problem solving by analogy is very common and has a long history in the literature. Typically test participants are either presented with vignettes or not and then asked to solve a problem analogous to the vignette. Analysis of analogy-problem solution can be adapted to computer presentations by using geometric analogy problems. In these tasks test participants rate the distance or relatedness of paired analogy terms. Geometric, proportional analogies are comparisons between two collections of geometric figures, called the source and target, with ratings allowing us to establish which transformations between images the test participant is sensitive to.

For example, a simple geometric analogy may be of the form A:B::C:D, where A, B & C are given and D is derived from applying the transformation obtained from A to B, to C. We read such an analogy as A is-to B as C is-to D. Typically, the source domain (A:B) identifies some transformation(s),which may then be applied to C, yielding D, as shown in FIG. 4D. For example, the analogy in FIG. 4D centers on partitioning the polygon to the right of part A to produce part B. This partitioning transformation may then be applied to part C. FIG. 4E illustrates a solution. Selecting the correct solution from amongst several candidate solutions consistently may allow us to conclude that the analogy transformation is understood by the test participant. Geometric analogies can be varied in the complexity of transformations, allowing information on the test participant's capability for analogy-based problem solving. The APS task measures how many correct solutions the test participant selects from small sets of 4 or more possible solutions, while varying transformational complexity.

Insight Problem Solving (IPS): is related to creativity (below) and thus serves as a related measure. Typical insight problems include connecting 9 dots in a 3×3 dot lattice using 3 lines (using spatial ability); and the Remote Associates Test requires the test participant to think of a word that connects three, seemingly unrelated words 21 (for example, “desk, “mountain” and “tree” all combine with “top” when one applies verbal ability).

Variants of both types of test may be used, providing measures of spatial and verbal ability. In the latter case, words may be controlled for frequency and responses assessed for meaning and relevance using a detailed pattern-matching protocol. Problem solution (solved/not solved) within a test period may be measured.

Means-Ends Analysis (MEA): may be carried out using computerized versions of the Tower of Hanoi Task (TOHT). FIG. 4F shows a solution to the 4-disk Tower of Hanoi Task. The task typically consists of three rods, and a number of disks of different sizes which can slide onto any rod. The tasks starts with the disks in a neat stack in ascending order of size on one rod, the smallest at the top, thus making a conical shape; the objective of the puzzle is to move the entire stack to another rod, obeying a set of rules. Typically with three disks and three rods the task is easily soluble but with increases in the number of either, the complexity of the solution increases exponentially. A measure of the efficiency and speed of means-ends analysis can be derived by tracking the moves made by the testee as well as recording the overall task and defined sub goal completion times for 4 or more disk variants. Sophisticated and situated but less formalized variants of procedural problem scenarios may be developed for the OCC indices to measure means-ends analysis in occupationally-specific problem solving (an example is given above regarding “the troublesome repair” test). Note that in the “the troublesome repair” test example the layout of response options also allows for an analysis of mouse trajectories allowing for an additional measure of response confidence.

FIG. 4G shows an example interaction of critical thinking skills and means for their evaluation, in measuring the critical thinking attribute in some embodiments of the OPA. In one embodiment, critical thinking is metacognitive process that consists of a number of sub-skills (i.e. analysis, evaluation and inference) that, when used appropriately, increases the chances of producing a logical solution to a problem or a valid conclusion to an argument. The development of CT skills may allow test participants to transcend lower-order, memorisation-based learning strategies to gain a more complex understanding of the information or problems they encounter. “Analysis”, “Evaluation” and “Inference” may be the core skills necessary for successful CT, evaluable on five different facts or applications illustrated in FIG. 4G. These are 9 “Hypothesis Testing”; “Verbal Reasoning”; “Argumentation”; “Judging Likelihood and Uncertainty”; and “Problem-Solving”. The OPA CT assessment asks short, open-ended questions (that are quantitatively scored), which allow test-takers to demonstrate their ability and mayingness to conduct CT. Test-takers are assessed on the five different applications (i.e. hypothesis testing; verbal reasoning; argumentation; judging likelihood and uncertainty; or problem-solving). In each application, test participants may be presented with a passage of text and the time required to read each of the five passages may be recorded. Six open-ended questions may be used to assess the three core CT skills (i.e. two “Analysis” questions, two “Evaluation” questions and two 18 “Inference” questions) and one open-ended question may assess how well these skills have been employed for each application. When a question appears on the screen it may be accompanied by five blank lines. Test-takers are required to type in their answers on the lines provided. The passage may remain on the screen during the question-answering phase (i.e. over the duration of six questions) and the amount of time required to answer each questions may also be recorded, as may their data regarding characters per minute typed. Responses may be subsequently quantified and assessed for meaning and relevance using a detailed pattern-matching protocol. The assessment consists of 35 overall items. Examples relevant to the OCC Index are given as follows. Note that problem solving performance may be compared against performance in the PS tasks described previously.

Here is an example of hypothesis testing of critical thinking Suppose that you are the CEO of the clothing retailer Les Vêtements, which has started a massive campaign in order to change its image from that of being over-priced to one that has lower prices than competitors, yet also retaining its reputation of being up-market. Advertisements posted online, in magazines, newspapers, and on the radio were used to publicize the change in image. Six months after the campaign began, research was conducted in which the local communities in proximity to Les Vêtements stores were surveyed, by asking customers leaving the store: “Which clothing retailer do you think has the best clothes at the best price?” The results revealed that over 64% of those who answered the question named Les Vêtements. Those in charge of the survey reported to you that the campaign had succeeded in changing the perception in communities in proximity of Les Vêtements stores as an over-priced clothing retailer.

Analysis

1. Why is it important that this research is being conducted?

2. What type of source is this information coming from?

Evaluation

3. What can you say about the credibility of the source of this information?

4. Is there any potential for bias in this passage?

Inference

5. What can be inferred from the results reported in the passage?

6. Given any pre-existing knowledge, might you infer something different to what is reported in the passage?

Hypothesis Testing

7. Would you be content with regards to whether the results indicated that the campaign worked? If so, please explain why. If not, what questions would you ask regarding the results and how they were obtained; and what changes would you make in order to find out whether the campaign worked?

Verbal Reasoning

You notice that there has been unrest in your place of work, as people have been irritable of late. You open your email and see that a petition had been forwarded to you and to the entire company regarding inappropriate behavior. The petition could potentially change company policy. It states that: “Good morale in our company is of utmost importance; and in order to ensure this, we may eliminate behaviors that disrupt morale and productivity. Thus, any employee who engages in inappropriate behavior on company grounds may be terminated immediately y.”

Analysis

1. What is the reason for this petition?

2. What can you say about the structure of the email?

Evaluation

3. Are there any propositions included in the passage that you feel are irrelevant?

4. Would you consider the source of this email important in this context? Why or why not?

Inference

5. What can you conclude from this passage?

6. Is there any alternative conclusion that might be drawn, in the event that you were provided further information?

Verbal Reasoning

7. Would you sign this petition? Why or why not?

Argumentation

A popular view is that individuals have extraordinary abilities while under hypnosis, such as supernormal memory. When hypnosis helps a person to recall information that he or she did not previously recall, this is termed ‘hypnotic hyperamnesia’. Many clinicians and their clients also believe that hypnosis can improve memory. This notion has received support from documented cases in which law enforcement agents have obtained useful evidence from eyewitnesses who, prior to hypnosis, had difficulty recalling details of the crimes they witnessed. For example, after some of these successes in refreshing memory with hypnosis, police departments began to use hypnosis as an investigative tool in the 1960s. Research by Smith (1983) cites a number of cases in which hypnosis has later improved memory of events and crimes that were observed under non-hypnotized (awake) conditions but were not well remembered prior to hypnosis. However, an experiment by Mingay found that hypnotized subjects were not more accurate than non-hypnotized subjects in recalling meaningful visual material. Furthermore, other research has shown that what looks like a ‘hyperamnesic’ effect in fact may not be due to hypnosis. Research by Erdelyi and Becker indicated that with repeated attempts at recall, even without hypnosis, subjects remember things that they did not previously recall. As many early studies examined memory initially without hypnosis and then under hypnosis, improved recall attributed to hypnosis actually may have been due simply to repeated attempts at recall.

Since the time of Freud, hypnosis has also been used as a method for helping people with psychological problems to recall traumatic or anxiety-provoking events from their pasts, in which those under hypnosis could regress to an earlier age when given a suggestion to imagine that they were back at an earlier time. However, when researchers have checked such people's memories of events from previous times, they found that age-regressed subjects did not accurately remember details (Nash, Drake, Wiley, Khalsa, & Lynn, 1986). In fact, through hypnotic age regression, subjects may recall incidents that they actually may have constructed based on other experiences. Spanos et al. (1991) found that subjects who were hypnotized and age-regressed often recalled such memories; however, these recollections were frequently based on historical figures with whom they were familiar.

Furthermore, some research has indicated that a hypnotized person may be given a false suggestion while trying to recall some event and may incorporate this false suggestion into memory, thus creating a pseudomemory). According to a literature review by Spanos, Burgess and Burgess, people who form pseudomemories of being abducted by aliens often do so within the context of hypnotic and structured interviews that create demands for the reporting of such experiences, which people then come to interpret as actual memories of abduction. In addition, Coons studied the case of a woman interviewed by police who used a particularly suggestive interrogative technique. This led to the woman's confessing to a crime she did not commit and developing symptoms of multiple personality disorder created by the suggestions.

Analysis 1. Are the reasons that support this claim well-balanced with those that object to the claim? 2. What type of source does the main objection to the central claim come from? Evaluation 3. Are there any reasons or objections that lack credibility, based on their sources? 4. Are there any propositions included in the argument that you feel are irrelevant? Inference 5. What can you conclude from this passage, based on what the author has presented you? 6. Based on your own assessment of this passage, what alternative conclusion can you draw? Argumentation 7. Explain your position on the use of hypnosis. Judging Likelihood & Uncertainty

John is sitting in a reception room awaiting a job interview. He has come dressed in a three-piece suit and brought along a brief-case. There are eight other people there, seven of which are female. The man sitting next to John, also awaiting an interview, is not wearing a suit. John pours himself a cup of water from the water cooler and smiles. John realizes that he is very likely going to get the job. Upon arriving, John assessed that he had a 12.5% chance of getting the job based on the fact alone that he showed up to the interview. He also assessed that he has a 50% chance of being interviewed by a woman. In the event that he is interviewed by a woman, he believes that he has an 87.5% chance of landing the position. In the event that he is interviewed by another man, John believes that he has at least a 50% chance of getting the job, given that the other applicants can only be better qualified than or less qualified than him; and the law of averages dictates that there may be a natural spread with respect to qualification levels. Once again taking into account that he may either be interviewed by a man or woman, John averages his two assessments (i.e. those in the case of being interviewed by a man or a woman) and deduces that he has a 68.75% of landing the position, assuming that he can perform fair in the interview.

Analysis

1. What is the main idea in this passage?

2. From what type of source is the information in this passage derived?

Evaluation

3. Are there any irrelevant propositions in this passage?

4. How would you evaluate the logic behind why John has a 50% chance of landing the job if he is interviewed by a man?

Inference

5. Why would you conclude that if John is being interviewed by a woman that he has an 87.5% chance of getting the job?

6. What can you conclude from this passage? Judging Likelihood & Uncertainty

7. What is your best estimate of John succeeding in acquiring the position with respect to a percentage? Please explain your thinking.

Problem-Solving

You have been contracted to investigate a building site in which the foundation was suspected of lacking integrity. You are to make the decision of what is supposed to be done in order to ensure the integrity of the foundation. Before you arrive on site, your colleagues identified faults and identified underpinning as a plausible solution. This was recommended to you upon your arrival. After your investigation, you find: severe honeycombing of the concrete is visible on both sides of the foundation. Hence, the reinforcing steel is exposed and highly corroded. The underlying soil is generally of an adequate bearing capacity, but one corner of the building is founded on a pocket of highly compressible fill material. The building is a rectangular shaped domestic dwelling and there is no roof attached. Analysis1. What is your primary goal in this context?2. Are there any sub-goals that need to be achieved in order to reach your primary goal? Evaluation

3. Is there any information presented that is irrelevant? 4. Is there any potential bias to consider in this passage? Inference 5. What conclusion was drawn in this scenario? 6. Can you infer an alternative solution? Problem-Solving

7. Based on your investigation, would you agree the underpinning is the correct option? If you agree, what type of underpinning would you use and why? If you do not agree, please explain why.

In one embodiment, reason, is the capacity for reaching conclusions that are logical, unbiased and rational. It is sometimes, but not always procedural in nature and when it is uses mental rules. It can differ in outcome according to the amount of information available and the predispositions of the reasoner—in other words reasoning may be subject to bias of one form or another.

Looking at logical categorizations of different types of reasoning the traditional main division made in philosophy is between deductive reasoning and inductive reasoning. Formal logic has been described as the science of deduction. The study of inductive reasoning is generally carried out within the field known as informal logic or critical thinking.

In Psychology, reasoning is believed to be carried out either by an associative or rule-based system. The associative system (System 1) uses temporal and/or similarity relations as well as using estimated probabilities to draw inferences, similar to the activities of a statistician and akin to inductive reasoning. The rule-based system (System 2) is systematic in that it relies upon applying rules to conditions to bring about procedures and is, in character, more deductive. Given both methods of reasoning are now believed to be presentation of different heuristics of the same underlying cognitive system we may assess the capabilities of both associative and rule-based reasoning systems.

Both Associative Reasoning (AR) and Rule-Based Reasoning (RBR): may be measured by examining Matching Bias using variants of the Wason Selection Task, a task which generalizes well to situational contexts by simply changing variables.

Matching bias is a non-logical heuristic, described as a tendency to use lexical content matching of the statement about which one is reasoning to be seen as relevant information and do the opposite as well, ignore relevant information that doesn't match. It mostly affects problems with abstract content. It doesn't involve prior knowledge and beliefs but it is still seen as a System 1 heuristic that competes with the logical System 2.

FIG. 4H shows an example of the Wason Selection Trask in measuring the reasoning and bias attributes in some embodiments of the OPA. You are shown a set of four cards placed on a table, each of which has a number on one side and a colored patch on the other side. The visible faces of the cards show 3, 8, red and brown. Which card(s) may you turn over in order to test the truth of the proposition that if a card shows an even number on one face, then its opposite face is red?

Responses may be made by using point and click responses to test images (in this instance the cards displayed on computer monitor, this design also allows for the tracking and analysis of mouse trajectories). The Wason selection task provides evidence for the matching bias and the test is designed as a measure on a person's logical thinking ability, upon which performance is sensitive to the content and context with which it is presented. If you introduce a negative component into the conditional statement of the Wason Selection Task, e.g. “If there is an A one side of the card then there is not a 3 on the other side”, there is a strong tendency to choose cards that match the items in the negative condition to test, regardless of their logical status. Changing the test to be a test of following rules (i.e. a test of System 2) rather than truth and falsity is another condition where the participants may ignore the logic because they may simply follow the rule, e.g. changing the test to be a test of a police officer looking for underage drinkers. The original task is more difficult because it requires explicit and abstract logical thought from System 2, and the police officer test is cued by relevant prior knowledge from System 1.

AR and RBR may be measured on the success and time taken to complete System 1 and System 2 variants of the Wason Selection Task.

A cognitive bias is a systematic deviation in judgment leading to perceptual distortion, inaccurate judgment or illogical interpretation. There is a continually evolving and long list of cognitive biases related to motivation, decision-making and attentional allocation. Biases may be typically measured using specially designed step-through decision vignettes with multiple choice alternative solutions, measures may be the end state and it's relation to potential, bias alternatives presented in the vignette.

Search and recognition principally concerns mechanisms of focalised attention and their efficiency in visual environments of varying complexity. It can also be used to refer to an auditory analog, this being the detection of key sounds within noisy sound streams. Assessing search efficiency is relatively straightforward: target items are presented in displays with distracter items varying in number and similarity to the target. In displays in which target and distractors differ (do not share 1 or more features), search may be as efficient in displays with fewer distracters as it would be in displays which include more distracters. However where targets and distracters share common features, even where these features are parts of more complex objects search becomes more and more effortful, requiring the deployment of focal attentional mechanisms for the serial examination of items in the display to establish which are and which are not the target. A similar paradigm may be used to establish whether or not moving targets are likely to collide with stationary or moving distracters.

FIG. 4I shows an exemplary test in measuring the search and recognition attributes in some embodiments of the OPA. B and P differ only in one feature. The more distracter P's in the display, the harder it is to find the B.

Visual Search and Recognition (VSR): can be assessed using visual search displays requiring target search and classification in distracter displays of varying densities. Target-distracter similarity can also be varied to vary task difficulty. In applied settings, either static displays or displays including multiple moving distracters as well as a moving target may be used with the task of assessing likely collisions. In these displays the number of items and number of potential collisions can be varied to vary task difficulty. An example OCC application is in air-traffic control where realistic air traffic scenarios can be created. Visual search tasks typically use reaction time with errors as a secondary measure. FIG. 4J shows a multiple flight path simulation from an air-traffic-control simulation game.

Auditory Discrimination (AD): would be assessed by embedding a target tone or other sound in noise of varying qualities. Noise may be colored to resemble the target while the target-noise relationship can be varied in a number of sound scenarios, including dichotic listening tasks in which one channel includes verbalised information of varying semantic quality while a second channel includes qualitatively similar noise. Using the latter design can provide a measure of semantic embeddedness, the easier it is to report a target is a measure of how familiar of how well learned the target is.

Auditory discrimination tasks may use psychophysics methods for data acquisition and signal-detection-theoretic methods for analysis.

In one embodiment, much occupational cognitive capability is grounded in social information processing and interpersonal skills. We may use social cognitive approaches to assess honesty, team working, and entrepreneurial capacity.

Honesty (H): is a core social value and one that people in everyday conversations seek to live up to. Nevertheless, people do not always tell the truth, whether that be in their private lives or at the workplace. As dishonesty can lead to negative consequences in interpersonal relationships and in the work environment, it has long been the goal of psychologists to measure honesty and dishonesty, respectively. Importantly, honestly varies between people and contexts. With regard to individual differences between people in honesty and integrity Murphy reasons that dishonest people are, for example, likely to report dishonest behavior, that they tend to make excuses for such behavior, and that they evaluate such dishonest behaviors as acceptable. Interestingly, dishonest people have less impulse control and are more punitive towards themselves and others.

A measure of honesty would integrate these disparate dimensions. Some dimensions can be measured via self-reports (e.g., excuses regarding past events) while others can be measure more indirectly (e.g., revenge tendencies towards others after frustrations). The honesty and integrity measure may comprise a 40-item questionnaire, with approximately ten items for each of the dimension described above. A different, complementary, approach is the consideration of the social context in which people operate. For example, as outlined by Grover (, inconsistency between individual and organizational values, multiple roles of an individual in an organization, and time pressure contribute to more dishonesty. To predict people's honesty in organizations, a measure should thus consider individual differences in honesty as well as organizational variables contributing to dishonesty. A measure of organizational structures and people's fit to these structures would consist of approximately fifty items. Essentially, both individual differences and the organizational structures need to be taken into account when predicting people's likelihood to be honest and to behave with integrity in the occupational context.

An Honesty index score may be derived from questionnaire responses.

Team working (TW): is a complex social situation, and the ability to engage in teamwork relates to a variety of contextual and psychological variables. Important in this respect is perspective taking and the ability to understand people's behavior as a function of their roles. In addition to established measures of perspective taking and empathy, perspective taking can be easily assessed by asking a person to write words in a variety of ways so that other looking form different perspectives can read the word. A very promising approach is to examine what Stevens and Campion call the KSA: knowledge, skill and ability patterns, relating to interpersonal KSA (conflict resolution, collaborative problem solving, and communication) and self-management KSA (goal-setting and performance, planning and task coordination). These abilities may be measured in two scenarios relating to each of the KSA requirements for teamwork. And additional important component of teamwork is co-operation. People's individual differences in co-operation can be measured directly and via solutions to social dilemma games (e.g., the prisoner's dilemma).

Entrepreneurial Capacity (EC): relates to a range of personality features, people's skills, preferences, creativity, and risk taking. Entrepreneurial intentions and capacities are positively correlated with scores on the proactive personality scale. Further, cognitive flexibility and creativity appear to be central as they measure people's ability to transform existing knowledge to novel situation. Different occupations call for different levels of entrepreneurial risk taking, however, in most occupations, including the entrepreneurial context, any extreme risk behavior and false assessment of objective risks is most likely to be detrimental for the job at hand. Similarly important is the more or less objective assessment of values and outcomes of decisions (e.g., investments). Based on the above we may use a three-dimensional approach to measure entrepreneurial capabilities, consisting of two cognitive dimensions and one attitudinal-trait dimension.

The first measure of entrepreneurial capability may assess people's capabilities of processing probabilities and risks as well as their assessment of objective values and outcomes. People tend to transform objective values into subjective values (losses loom larger than gains, diminishing marginal utility), which often leads to significant errors in decision making. People who are relatively good in processing these objective qualities are likely be better in making entrepreneurial decisions than other people. We may use performance on tasks designed to measure Base Rate Neglect; Conservatism; Exaggerated Expectation and Neglect of Probability (listed in Reasoning and Bias above) combined with a measure of Risk Aversion to index Dimension 1 of Entrepreneurial Capability. People have limitation in assessing objective probabilities and risks as well as objective values and outcomes. With regard to probabilities, people often use mental shortcuts (heuristics) and they tend to neglect base rate information and conditional probabilities. People who are relatively good in processing probabilities and risks are likely to be better in assessing these qualities when making entrepreneurial decisions than other people.

A second cognitive dimension important for entrepreneurial decisions is cognitive flexibility and creativity. To Index Dimension 2 of Entrepreneurial capability we may develop entrepreneurial scenarios that capture cognitive flexibility and creativity in decision making (i.e. as derivations of the measures proposed in Critical Thinking and Creativity, described above and below respectively), and may validate these measures against traditional tests of flexibility (e.g., Wisconsin Card Sorting Test) and creativity.

Finally, besides these cognitive capacities, we may assess attitudinal qualities and personality differences. Specifically, we may develop scenarios that reflect openness to experiences, appreciation of change in behavior and context, and decision makers' future orientation in the entrepreneurial context. These scenarios may be validated against existing measures that capture these qualities such as openness to new experiences (Big Five), the proactive personality scale, and the scale measuring consideration of future consequences.

In one embodiment, the learning attribute refers to acquisition of new knowledge or modification of the existing knowledge. It involves processes of encoding, storage and retrieval of information. Because storage is an essential part of learning and the process of encoding is essential part of memory, learning and memory are intrinsically related. As a result, any test for examining learning and long-term memory are very similar. Learning theories are more concerned about the process of encoding and the conditions surrounding the learning. The content of learning can be information about facts and events in which case learning is classified as declarative learning. When the content of learning includes skills and habits it is classified as procedural learning. In the occupational context both declarative and procedural learning/knowledge plays an important role. Declarative learning/knowledge is measured by such tasks as recall and recognition memory, while procedural information is measured by simple performance tasks, such as mirror reading, and sequence reaction time (RT) tasks, as well as complex tasks, such as artificial grammar learning, complex stimulation tasks, and stimulus covariation.

TABLE 2
Summary of GCC and OCC Tests and Assessments

| | | | | | |
|---|---|---|---|---|---|
| GCC | Executive | Short-Term and | Problem Solving | Critical Thinking | Reasoning and |
| | Functioning (EF) | Working | | | Bias |
| | | Memory | | | |
| | Number-Word | Short-Term | Analogical | Various | Associative |
| | Interference | Memory | Problem | assessments of | Reasoning (AR) |
| | (NWI) task | Capacity | Solving (APS) | Evaluation, | task |
| | Continuous | (STMC) | task | Analysis and | Rule-Based |
| | Performance | assessment | Insight | Inference using | Reasoning |
| | (CP) task | Short-Term | Problem | hypothesis | (RBR) task |
| | Continuous | Memory | Solving (IPS) | testing, verbal | Various |
| | Performance | Duration | task | reasoning, | Reasoning Bias |
| | Error Detection | (STMD) | Means-Ends | argumentation, | assessments |
| | (CPED) task | assessment | Analysis (MEA) | likelihood and | |
| | Go-No Go | Working | assessment | uncertainty | |
| | (GNG) task | Memory | | judgment and | |
| | | Capacity | | problem solving | |
| | | (WMC) | | | |
| | | assessment | | | |
| | | Cognitive Load | | | |
| | | (CL) | | | |
| | | assessment | | | |
| OCC | Search and | Social | Leaning (LN | Motivation | Creativity (CR) |
| | Recognition | Cognition and | | (MO) | |
| | (SR) | Interpersonal | | | |
| | | skills (SC) | | | |
| | Visual Search | Honesty (H) | Paired - | Regulatory | Divergent |
| | and | assessment | Associated | Strength (RS) | Thinking (DT) |
| | Recognition | Team working | (PAT) test | assessment | test |
| | (VSR) test | (TW) | Recall (RCL) | Regulatory | Non-verbal |
| | Auditory | assessment | task | Engagement | (NVT) tasks |
| | Discrimination | Entrepreneurial | Recognition | (RE) | Convergent |
| | (AD) test | Capacity (EC) | (RCG) task | assessment | Thinking (CT) |
| | | assessment (3 | Events (ET) | | assessment |
| | | dimensions) | task | | |
| | | | Serial Reaction | | |
| | | | Time (SRT) | | |
| | | | task | | |
| | | | Mirror | | |
| | | | reading/writing | | |
| | | | (MRWT) task | | |
| | | | Weather | | |
| | | | prediction | | |
| | | | (WPT) task | | |

In one embodiment, the OPA components may review and obtain feedback to alter OPA's assessment parameters, and to further adjust candidate's assessment score. For example, after a candidate is hired, a test may be reapplied at work place and evaluations may be used to provide feedback correlating workplace evaluations to test scores and score weighting compositions, so that future test results will better track and/or predict success for a given role. The OPA may use the responses-to-feedback assessment to examine how participants respond to feedback and their propensity to change decisions and/or pursue different actions/strategies when provided with cognitive framing feedback. FIG. 6 shows a block diagram illustrating an example response-to-feedback assessment mechanism in some embodiments of the OPA. In this example, participants are asked to respond to a number (one or more) of prompts. After responding to these prompts, the participant receives cognitive framing feedback and is given the ability to go back and revise their original response. The nature and the magnitude of the changes are recorded and evaluated to identify the cognitive structures. Feedback can be true (e.g., describes the actual performance of the individual on the task) or false (e.g., predetermined feedback that all participants receive regardless of feedback). Feedback can be structured to identify “tipping points,” i.e., amount of information needed to modify a response, through incremental changes in how the feedback is framed.

In one embodiment, the OPA server may reassess candidate's qualifications for promotions.

In one embodiment, the OPA may collect various environmental indicators from the job candidates as data inputs for the assessment. For example, the OPA may record video of the job candidates when they are taking the employer and/or occupation specific tests, during job interviews, performing a task, and/or the like. In one embodiment, the video may be recorded by the OPA server. In another embodiment, the video may be recorded by the camera on the candidate's mobile phone and uploaded to the OPA server. The OPA server may analyze, for example, the job candidates' facial expressions, body gestures, body movements, eye movements, pulse rate, time it takes to answer a question, the trajectory of a mouse pointer, and/or the like, as indictors to the candidate's occupation performance. For example, if a job candidate moves the mouse very quickly when he answers the test questions compared to the average candidates, it might indicate that this job candidate is a quick decision maker and may be suitable for jobs that requires quick decision making. If there is a lot of eye movement of a job candidate during a job interview, it might indicate that the job candidate is easy to get nervous and may not be suitable for a client-facing task.

In one embodiment, the OPA may track the job candidate's career path and use this information to correlate tests with occupation. For example, a few years after the job candidate take the OPA's test, he may work as a sales person. The OPA may correlate the sales occupation with the questions asked in the test, or the test itself, and determine which questions/test have a high correlation with a sales occupation.

In one embodiment, the OPA's behavior assessment test may also be used in industries such marketing, dating, military, finance, business and/or the like. For example, the marketing industry may use OPA″s behavior assessment test to determine if a customer would want to purchase a product, or which product a customer is more likely to purchase.

In one embodiment, rather than templates associated with cognitive model or tied to position and/or role, individual template or test may be similarly linked. For example, the timer shown in FIG. 5C item 540 may be pressure or stress test for positions like air traffic controller, stock trader, and/or the like, and removed for those positions under stress that is not critical, for example, librarian or teacher. These individual widgets may be stored in template database. In one embodiment, different characteristics of the OPA may work as widgets with the whole system and may plug and play. For example, if one desires to add an assessment parameter (e.g., critical thinking), one can drag and drop so that this assessment parameter will be taken into account for the whole assessment. For another example, one may desire to add timing characteristic when candidates perform the survey. The clock widget, as discussed in FIG. 5C, may be added to assess how long it takes for the candidate to respond to a certain question, or the whole survey. Other widgets (e.g., report, environmental indicators, eye tracking, response time, self feedback, recruit, assess, decide, advance, review, exit, cognition, engagement, interaction, critical thinking, practical thinking, analytical thinking, creative thinking, executive functioning, decision making, comfort with risk, multitasking, regulatory fit, self-regulation, satisfaction, group dynamics, implicit attitudes, character, integrity, negotiations, management style, and/or the like) may be added and/or removed conveniently. The base template may be the same for different occupations. However, the assessment score may be varied for each occupation. Different user interface widgets may be layered and retrieved into templates to test for occupation related attributes. For example, adding a timer to introduce time pressure into the test may provide a time pressure assessment of an applicant.

In one embodiment, gamification may be used as a survey for personal or occupational assessment. For example, a candidate may be asked to play in a car racing game. Depending on how the candidate performs, for example, how soon he finishes the game, how he responses to turns, or other cars, and/or the like, certain characteristics like decision making, response time, self-regulation, about the candidate may be determined, which may be further used in the candidate's overall assessment. The OPA may create an engaging experiences that encourages long-term and frequent usage of the assessment. Incorporation of gaming devices, such as: leveling up, collecting achievements, sharing results, competing with others, story lines, etc.

FIGS. 5A-5C show example gamification integrated assessment in some embodiments of the OPA. With reference to FIG. 5A, the applicant (or candidate, or testee) may be provided with different environments for the test to take place in. For example, the applicant may stand in a hallway 501 with multiple rooms on both sides of the hallway. The applicant may enter any room to take the test. Each room is situated with different environments, and the intention is to assess how applicant performs in, and reacts to different environments. One of the rooms may be a person's office 505 and the person is speaking on the phone. Another room may be a shared office with people doing different activities 510. FIG. 5B shows an example gamification integrated critical thinking assessment question in some embodiments of the OPA. An applicant may be presented with a passage 515 describing a research, and may be asked with a question “how would you evaluate the creditability of the research conducting in the passage?” 520. The applicant may choose among answers of “good with reason 1” 525, “poor with reason 2” 526, “good with reason 3” 527, “poor with reason 4”, 528. The theme of the question may be changed depending on the occupation the applicant applies for. For example, if the applicant is applying in legal industry, the theme of the passage may be in mystery and thriller. If the applicant is applying in healthcare industry, the theme of the passage may be a situation a doctor may face when examining a patient. In one embodiment, points 530 may be given to the applicant as a reward for all the correct answers answered previously. FIG. 5C shows another example gamification integrated fairness assessment question in some embodiments of the OPA. The game may be competed between you 536 and another person 537. The question goes “imagine you are playing a video game with another person. This person and you are competing against each other. You find gold and it is up to you to decide how it is split. The numbers below refer to gold in ounces. Which split would you prefer?” 535 The applicant is given answer choices of “80 and 8” 538, “100 and 74” 539, “64 and 90” 541, and “88 and 88” 542. Based on the answer, the applicant's fairness attribute is assessed. The game may be taken place under a limited time. A clock widget 540 may be added to assess the applicant's response time. In different occupations, fairness is viewed differently. The requirement for the ability to work under time pressure is different as well. For example, when comparing a teacher with a stock trader, the teacher may need to portion things evenly 541, while a stock trader may portion things as unfairly as possible to be fair to their clients 542. Also, a stock trader may need to be decisive under time pressure, and therefore a clock widget is needed 540, while a teacher may not be needed to perform under time pressure.

In one embodiment, cognition may be assessed in laboratory tasks using explicit performance measures indexing, for example, correct performance or number of moves to completion (in memory, reasoning, critical thinking, search and recognition tasks). Where such measures are employed in OPA, task environments may be designed in close analogy to the laboratory-task environments used in conventional empirical studies of the aspect of cognition concerned (and described above). On this basis we can assume construct validity. It may be necessary in signal detection theory to assume reliability based on the mean and standard deviation of performance on at least 80 repetitions of a given task condition and within experimental participants. It is not unusual to find less than 10 participants supplying high resolution data of this sort for a given task described in the experimental psychological literature. Validation of all appropriate GCC measures may adopt this rule of thumb for at least 100 participants thereby aiming to provide normative performance measures well in excess of those typically published. With OCC measures it is important that there are performance correlations between GCC the derivative OCC tasks (which are likely to include less than 80 repetitions of a given task condition due to the more limited scope of possible occupationally specific variants of the GCC task) and within a suitably sized test population, with the number of participants decided upon in prior consultation with industry partners as well as the Society for Human Resource Management.

In one embodiment, Response Time (RT) as well as mouse trajectory data may be relatively free from bias and can give a clearer picture of performance than can either questionnaires or even tasks for which explicit responses (“did you detect or not detect”) are recorded. As with this latter class of tasks—for which signal detection measures are frequently calculated, RT measures may be recorded in task designs closely matching those reported in the literature. Aside from search and recognition in which RT is a primary measure, in all other tasks RT provides a secondary measure of task efficiency in which the speed of task completion or response is important. Generally, RT distributions are stable over 30 measures and this is the number of repetitions to be employed in establishing the reliability of the RT measures for each task. As mentioned above RT can be measured in a variety of memory, problem solving, critical thinking and reasoning tasks and is a simple, theoretically neutral measure of how long it takes to do a task or subgoal of a task. Given that in GCC some of these tasks may be novel or modifications of those found in the literature, while all may be novel in CC it is proposed to establish a basis for reliability and eventual test validity by the construction of generalized performance distributions derived from the performance of 100 test participants for each task.

A similar procedure may be used to establish the validity of mouse trajectory measures. Specifically to recruit 100 test participants to establish normative measures of mouse trajectories from which subsequent test measures would be compared. Note that typically, in both RT and the motor planning tasks from which mouse trajectory analysis derives, 10-15 experimental participants would be typical and so our aim is to establish very reliable and robust performance norms with which to compare subsequent performance on appropriate OPA tests.

In one embodiment, the OCC Creativity Index may correlate with fluid intelligence defined as the ability to reason and to solve new problems independently of previously acquired knowledge. Measures of fluid intelligence may be derived by using the Raven's Advanced Progressive Matrices (RAPM) test, set II as well as the short version of the Bochumer Matrizen-Test (BOMAT).

Regarding validation of motivation and in particular the RFT measures OPA may construct validity of the assessment by examining more “real world” variables. In this instance measures that look at actual behavior and judgments in the workplace. Consequently, OPA may validate RFT directly in the context of real world occupational settings, benchmarking directly against performance.

OPA tests may be additionally validated relative to an established and reliable measure of intelligence and at levels appropriate to the cognitive levels of assessment proposed. At this stage, correlations may be examined for each scale and the item structure of scales that do not correlate well with the TAT would be revisited and redeveloped if necessary. In this way TAT measure can be shown to validate the GCC Index and subsequently allow for its marketing as well as marketing the OCC index. It is important to stress that although scales included in GCC Index should correlate with general intelligence the narrative report may give a description of test participant's behavior in a sense that can be relevant for occupational behaviour. Similarly, given some overlap between test items across different test categories, it is possible to validate a limited number of items on one index relative to items on others: in particular between reasoning and bias, problem solving, critical thinking and creativity, but also between executive function and working memory.

In one embodiment, a subset of GCC-Index tests may be used as a social networking application through sites such as Facebook as well as accessible via professional networking sites such as Linkedln, both of which would refer to a dedicated web site. In this way we can acquire a large number of additional participants whose scores can be analyzed for correlations between different measures and against TAT. Using these data and referencing both these data as well as pilot data against datasets presented for each of the tests for which there is a literature, OPA may assess whether or not the OPA tests are reliable and valid instances of the given test and if there are significant performance differences, OPA may revisit test design, redesign and retest in order to standardize the test relative to existing test design.

### OPA Controller

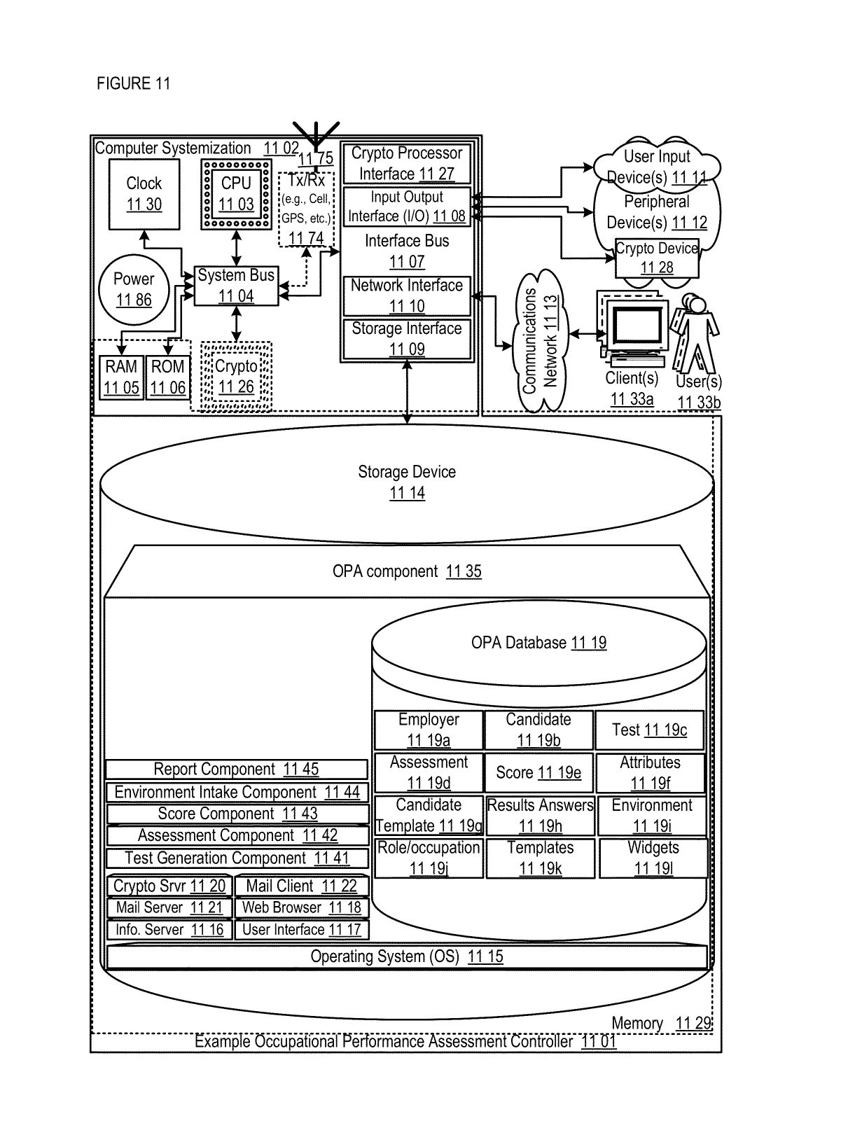

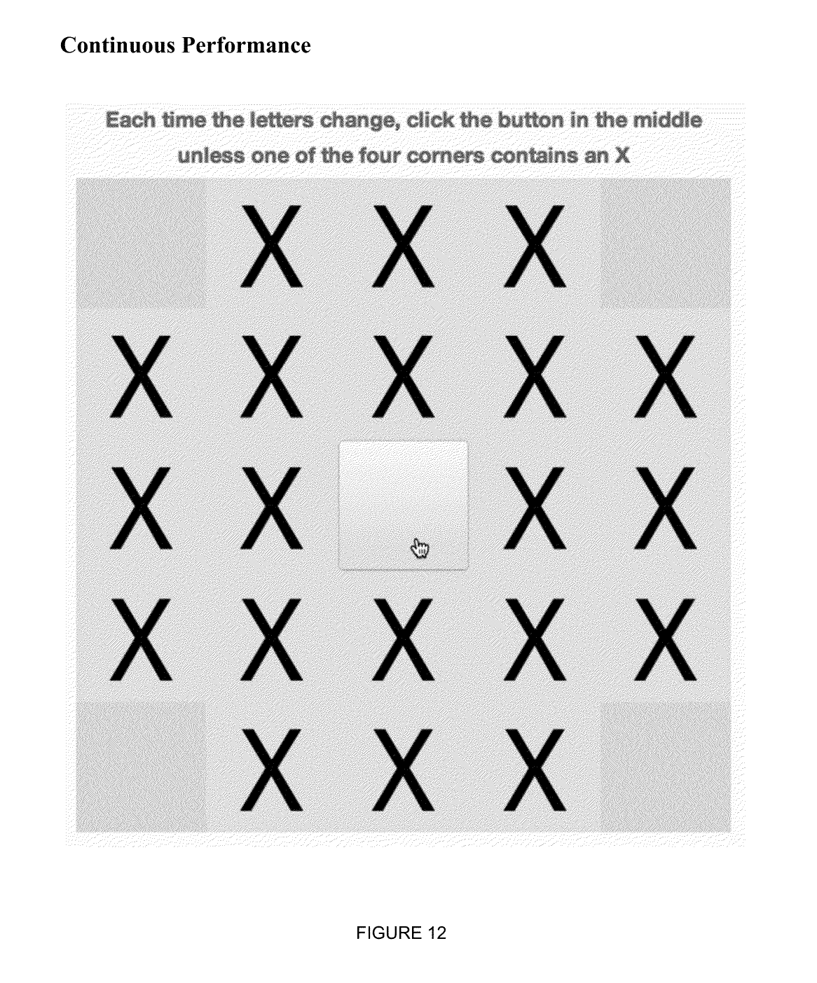

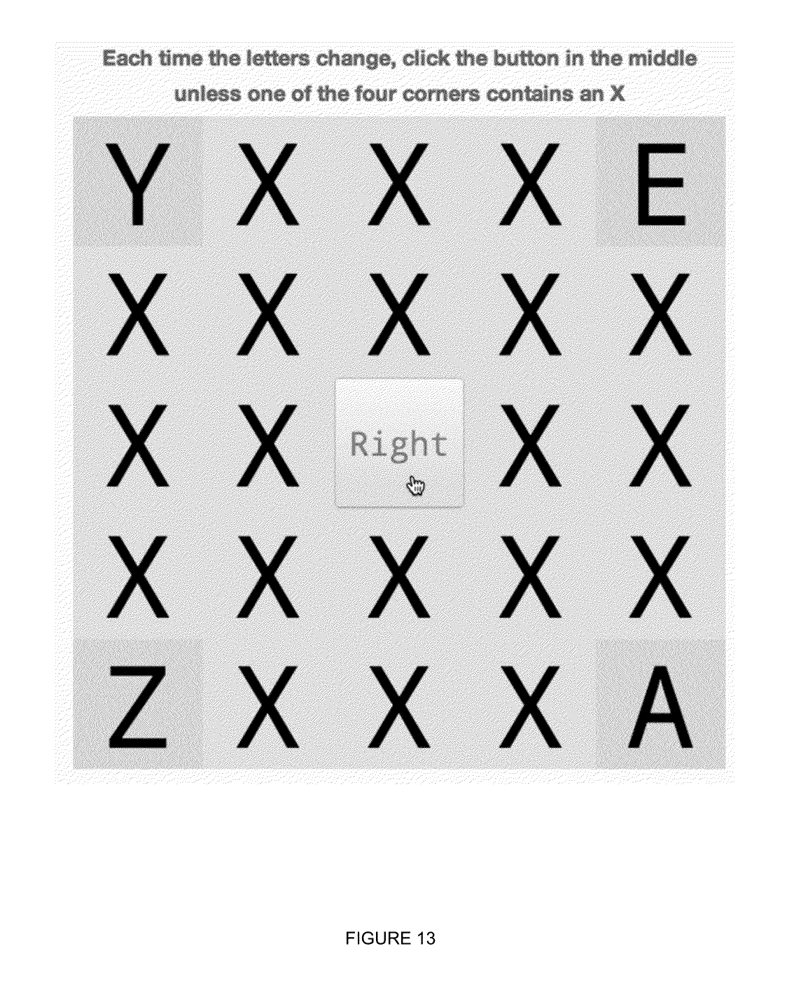

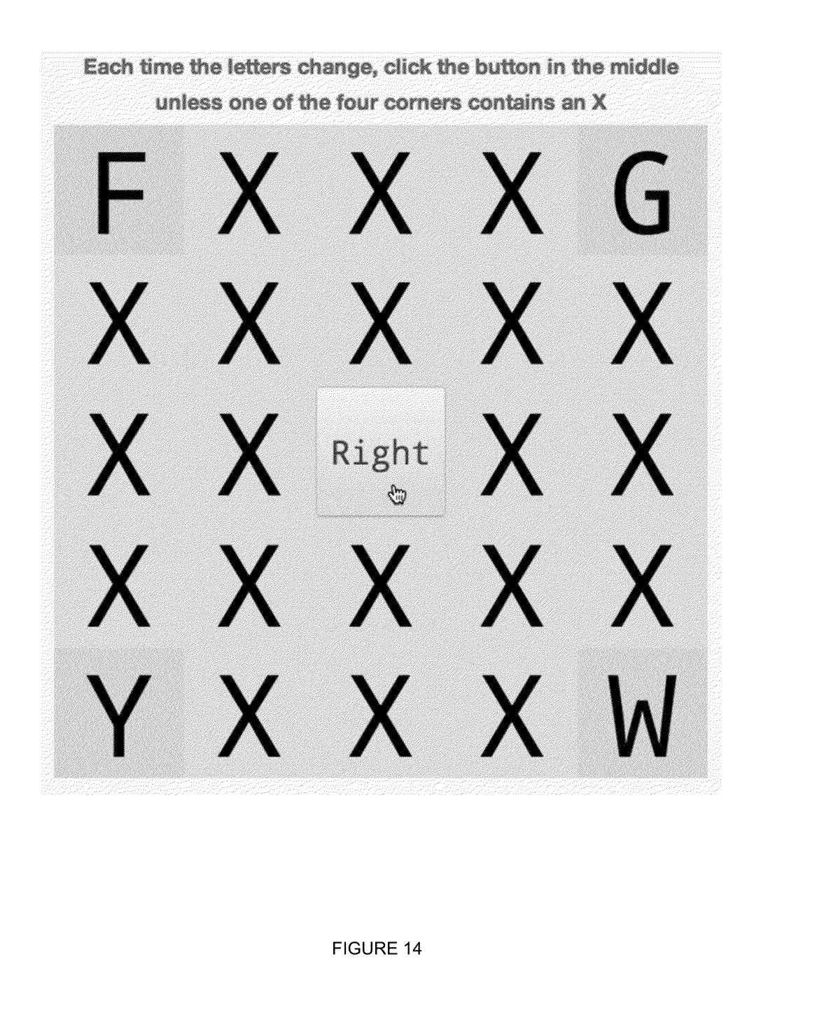

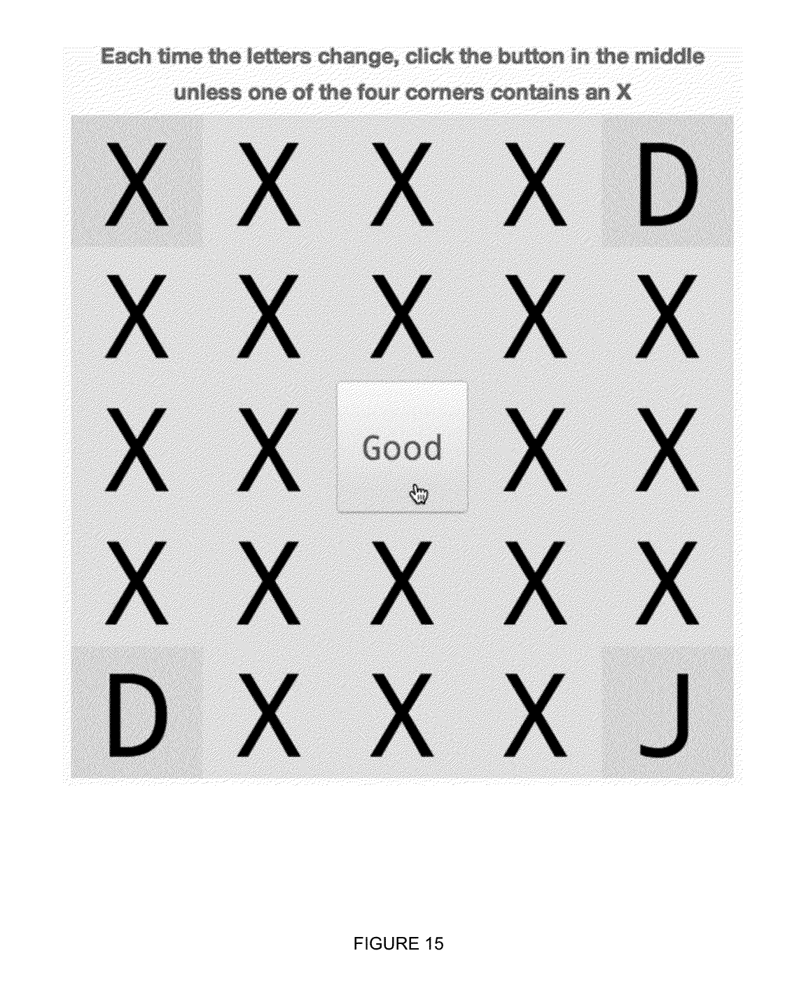

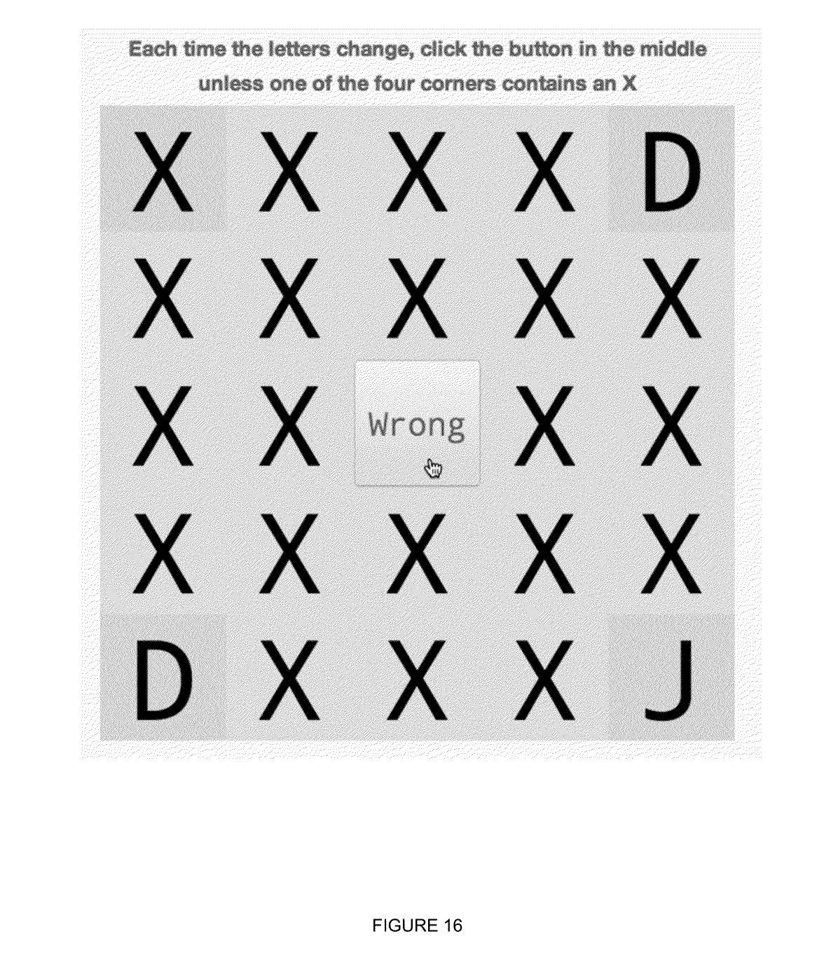

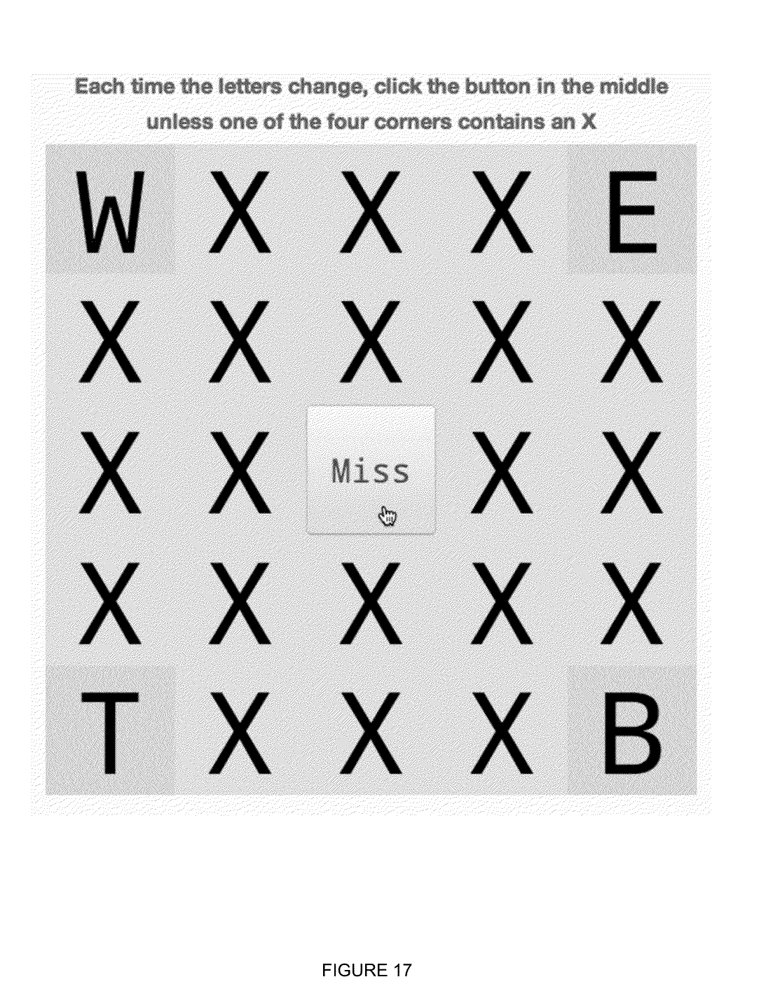

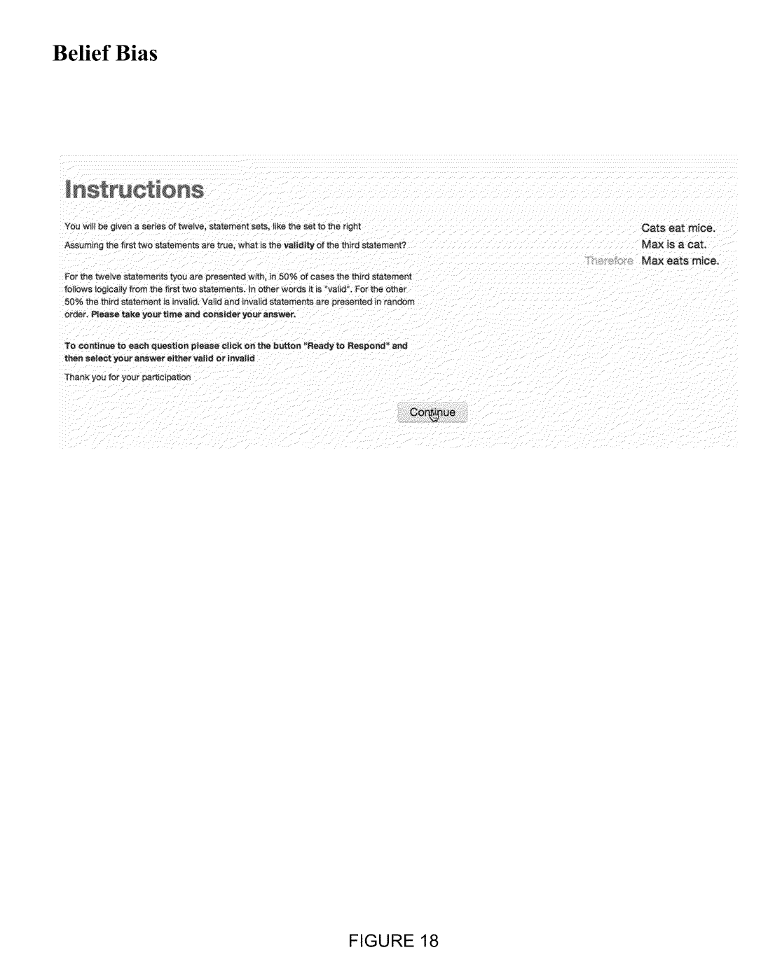

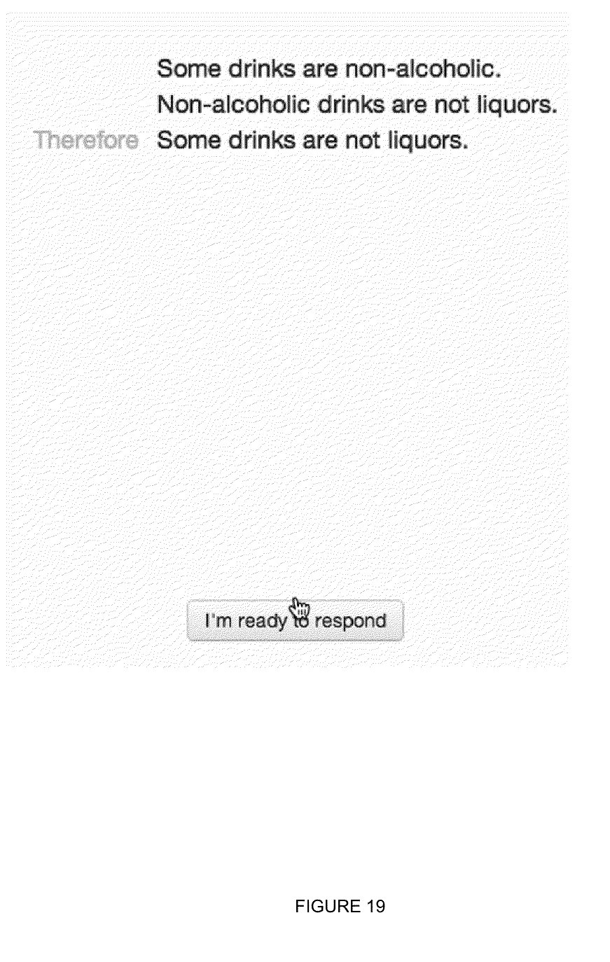

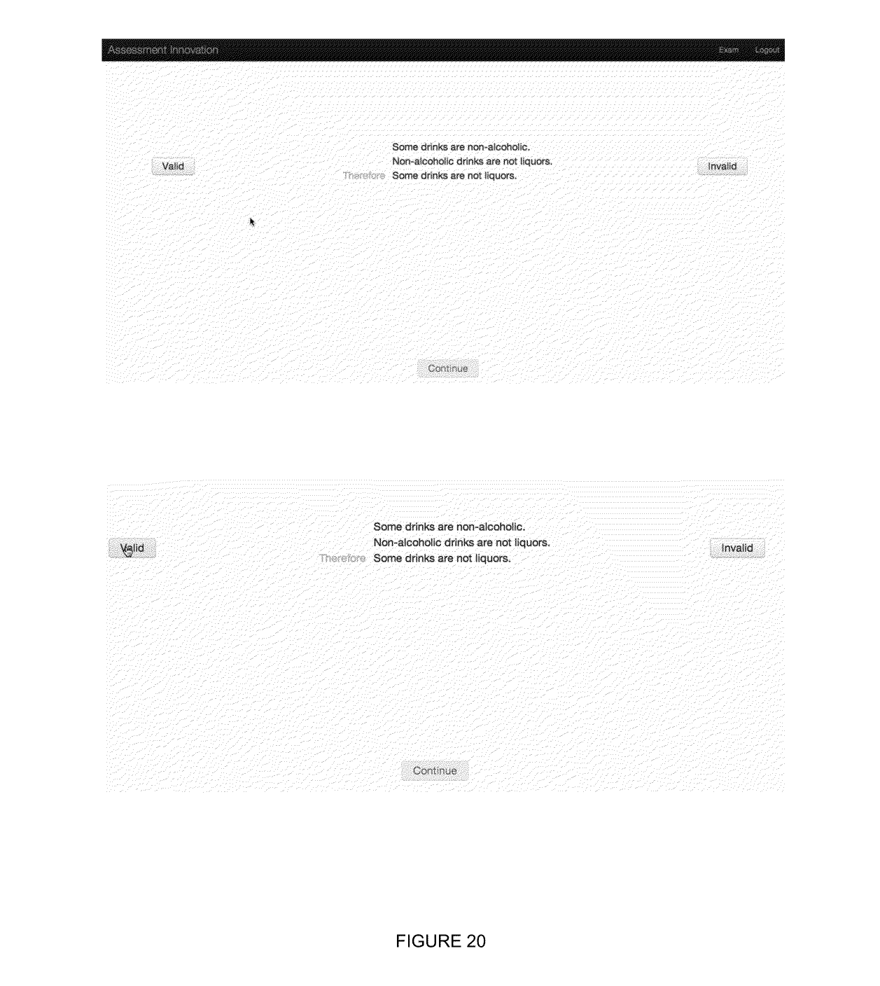

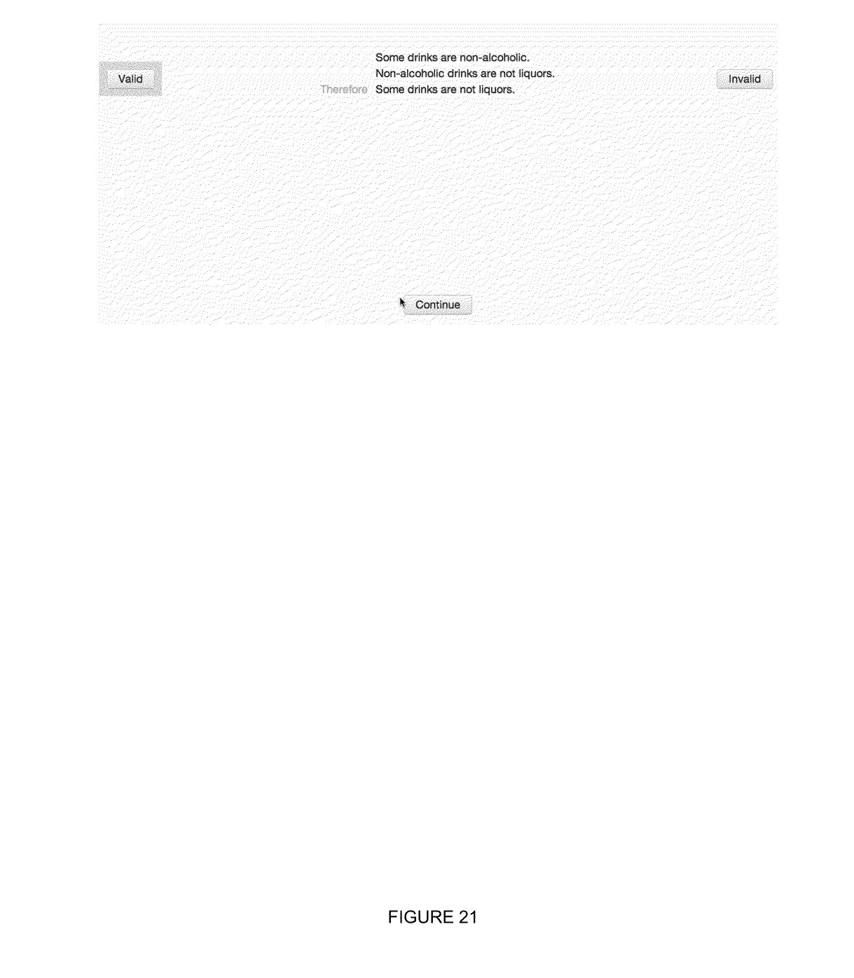

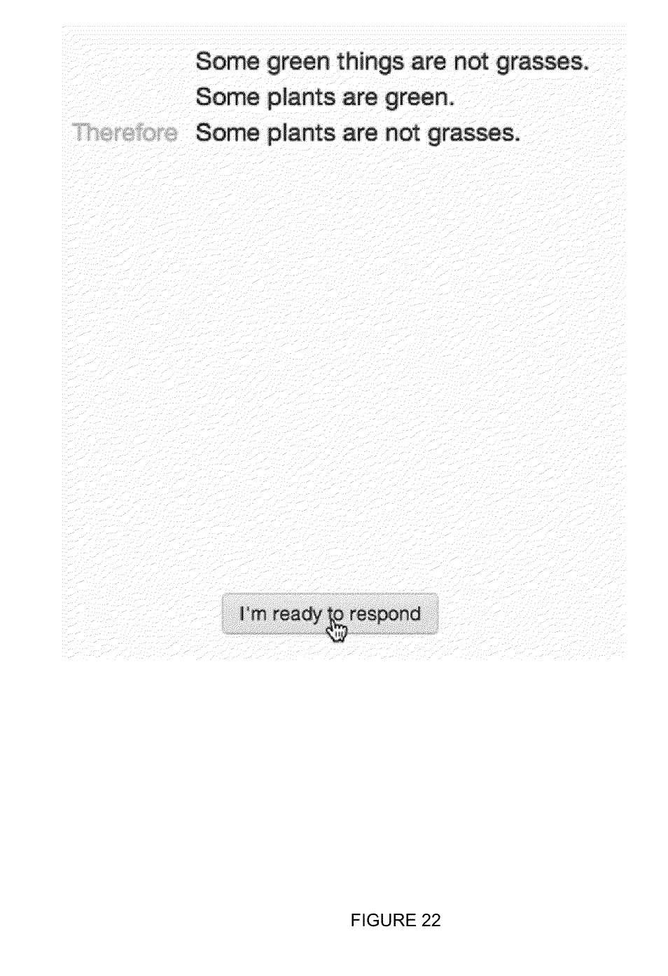

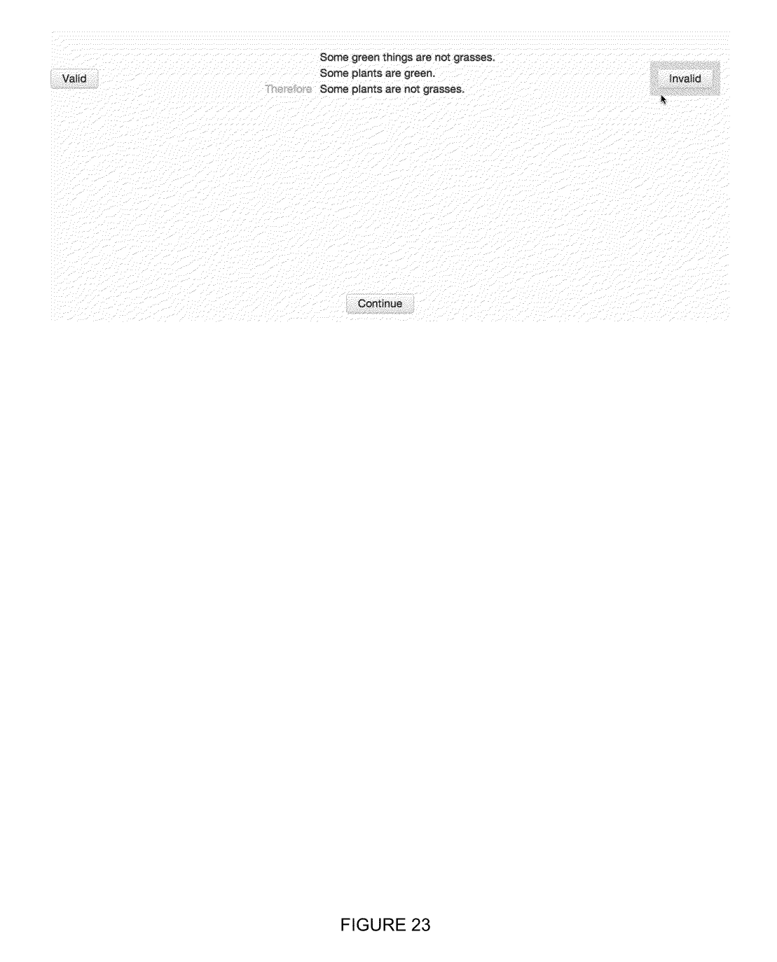

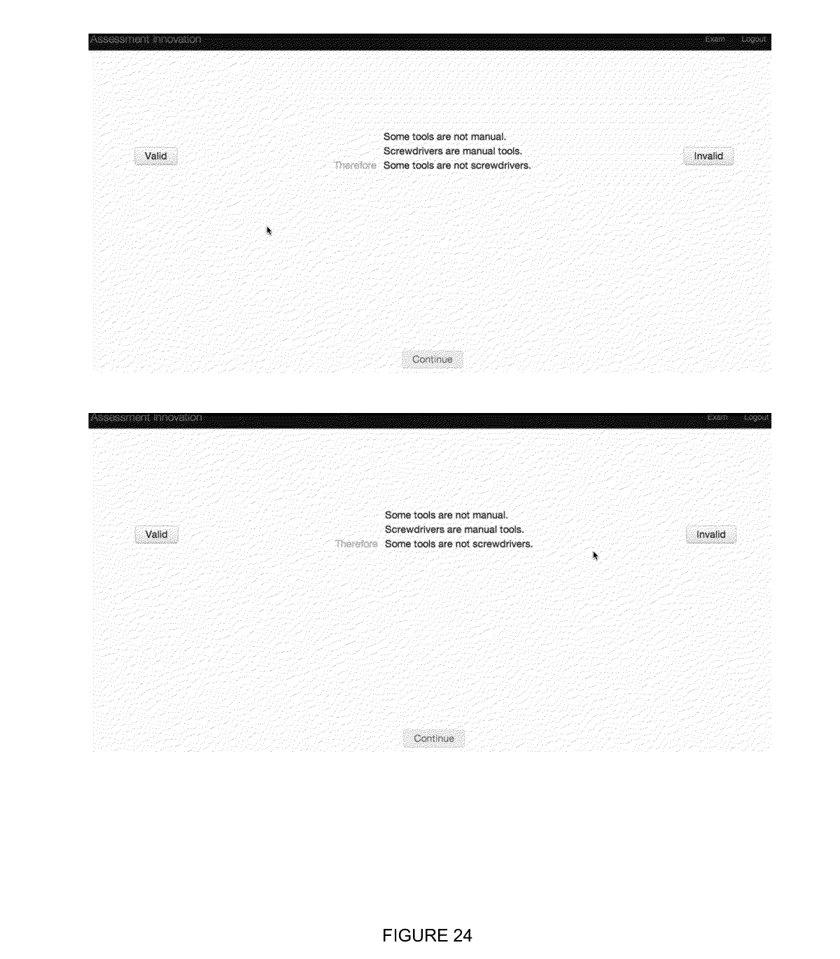

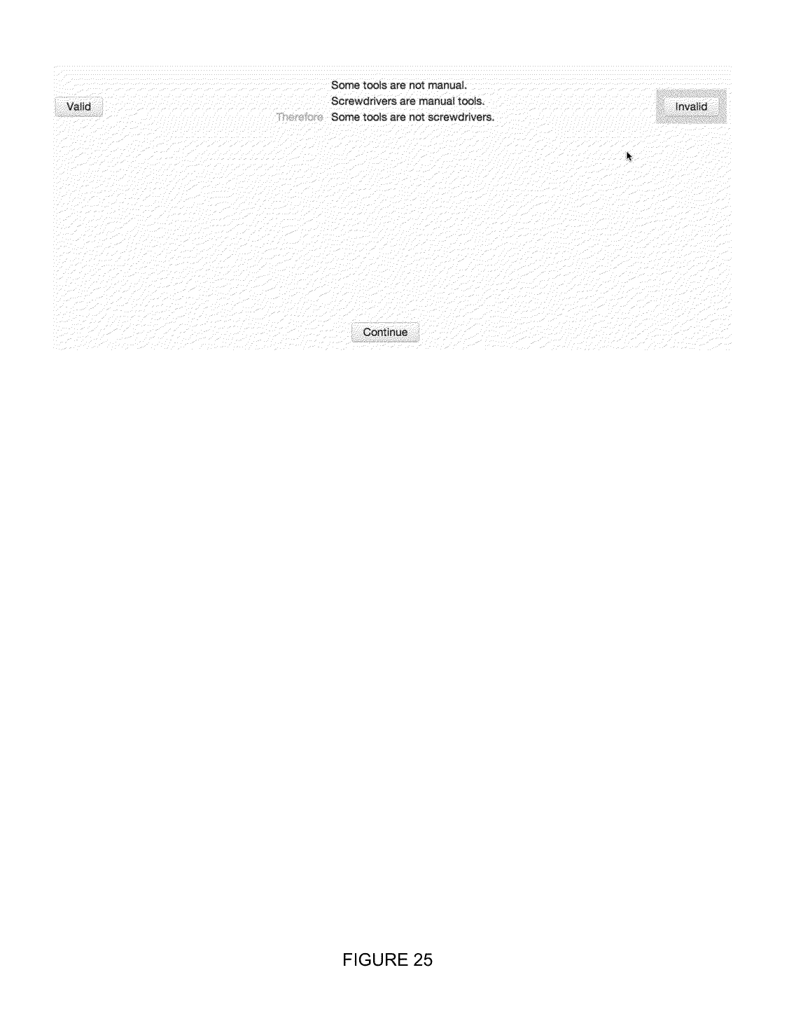

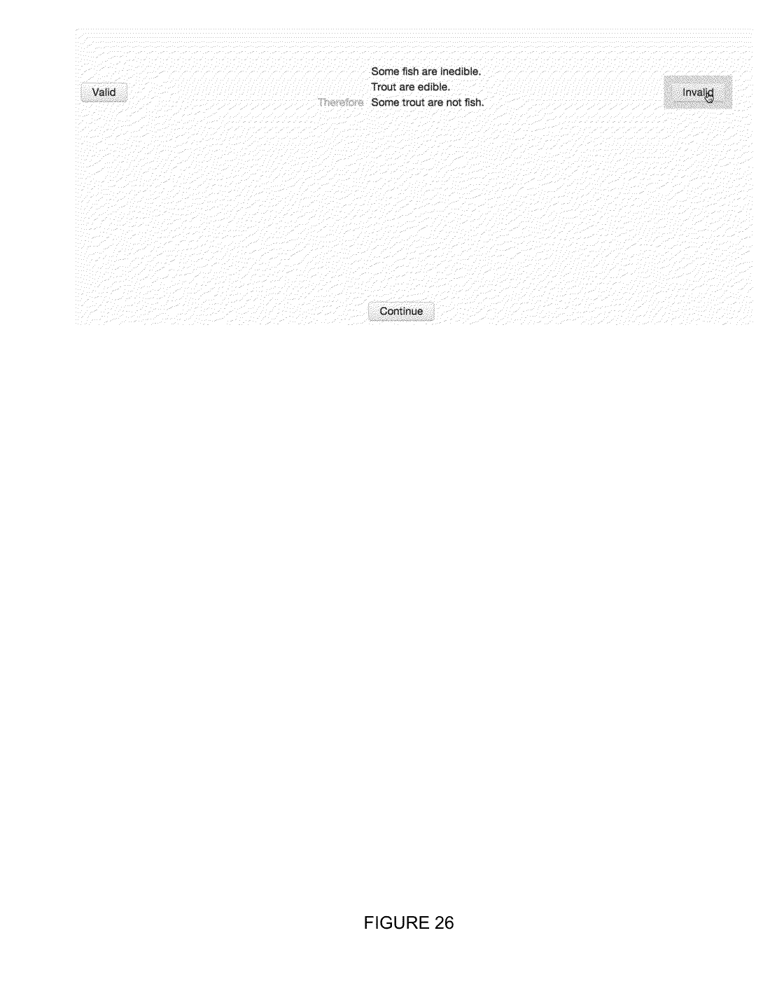

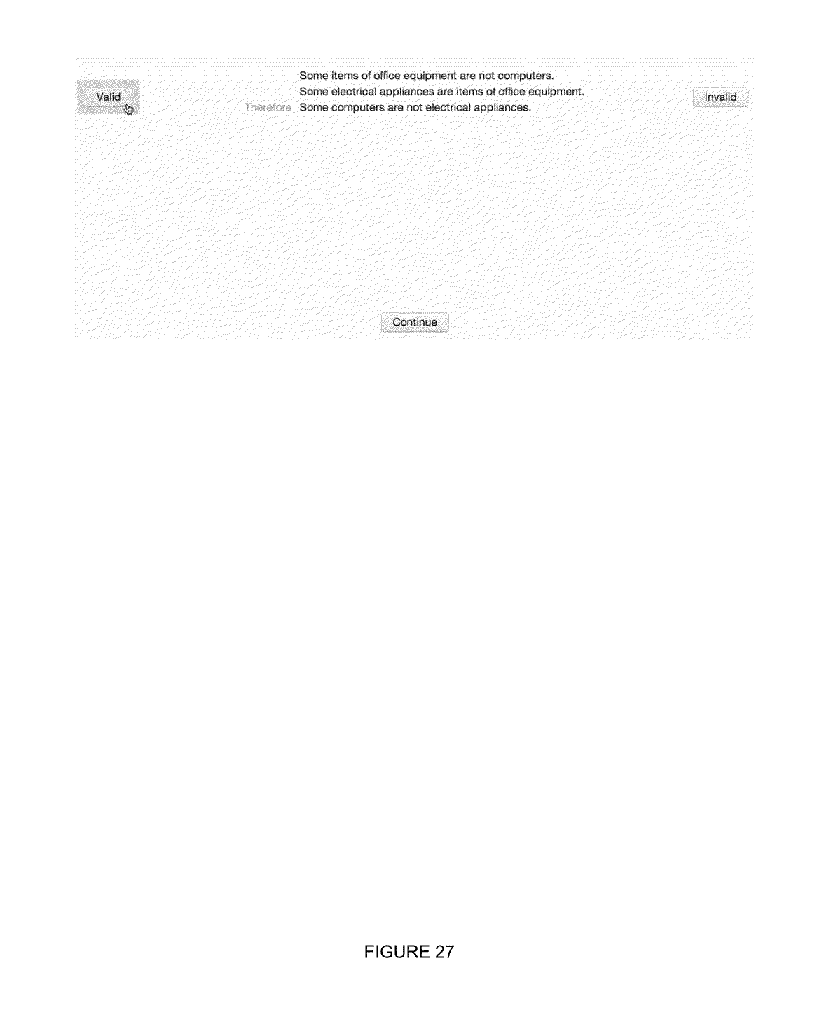

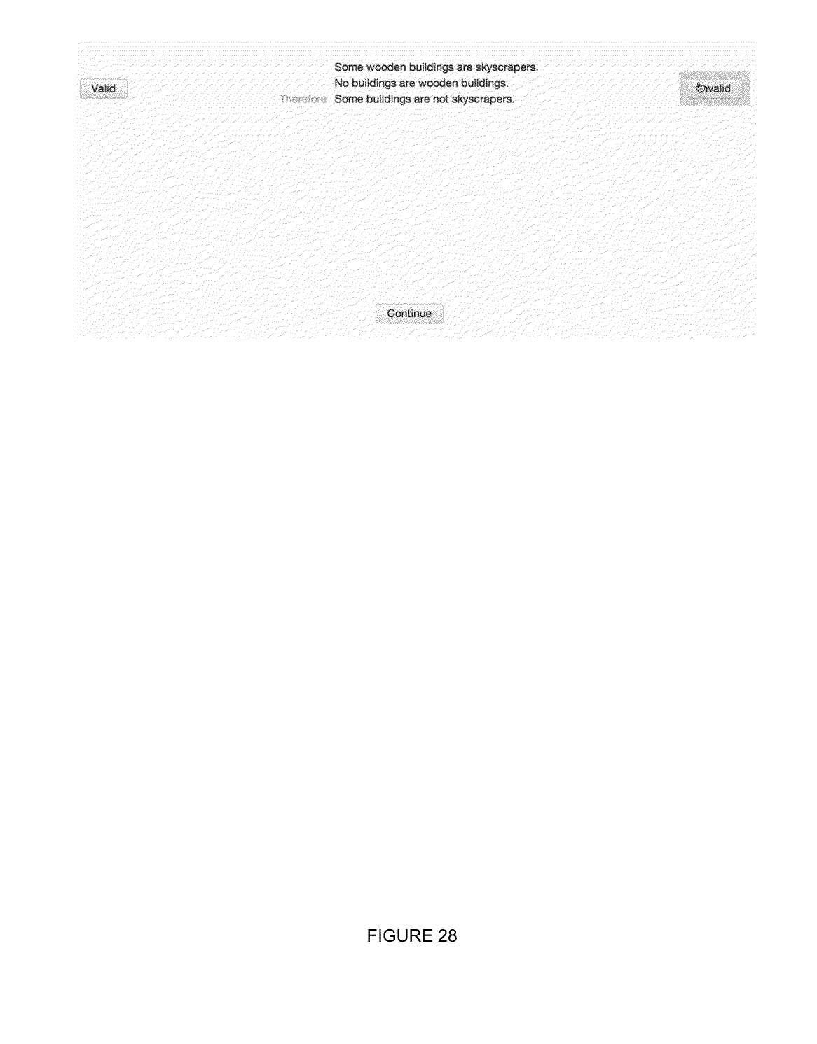

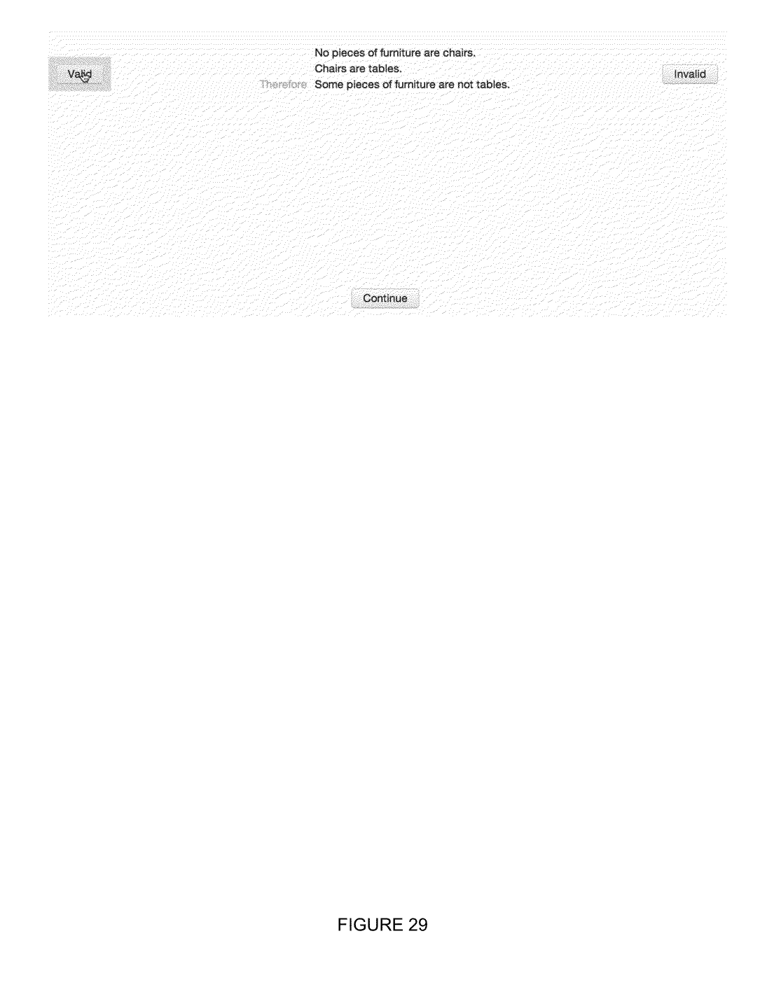

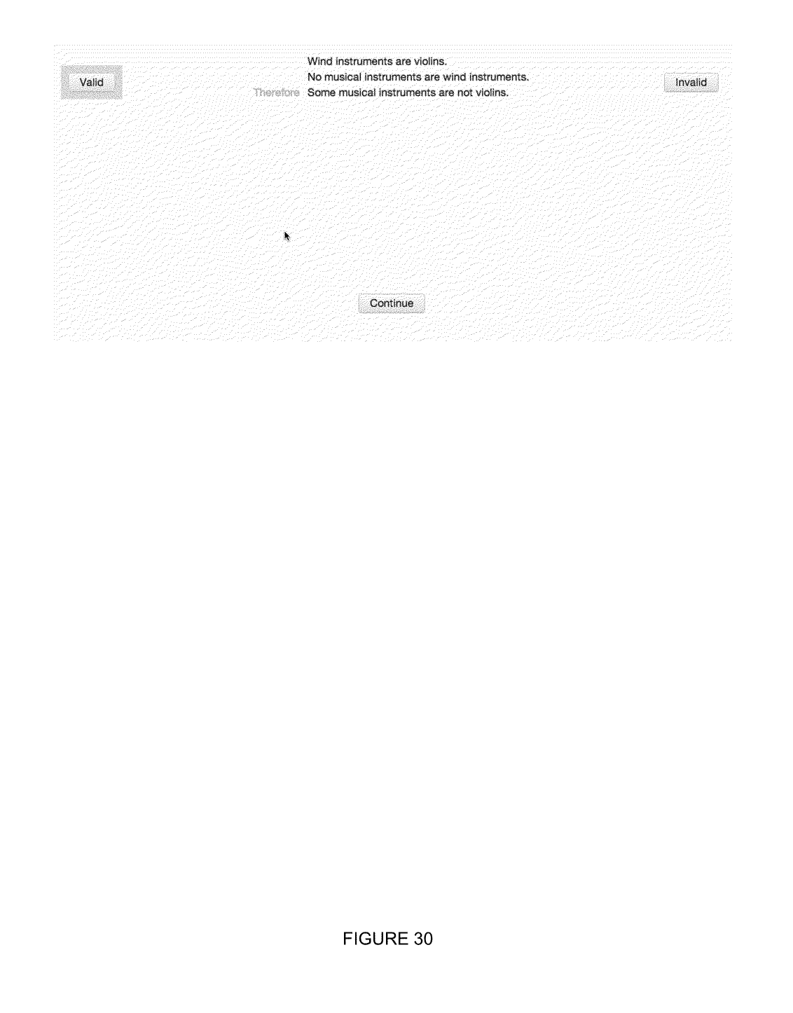

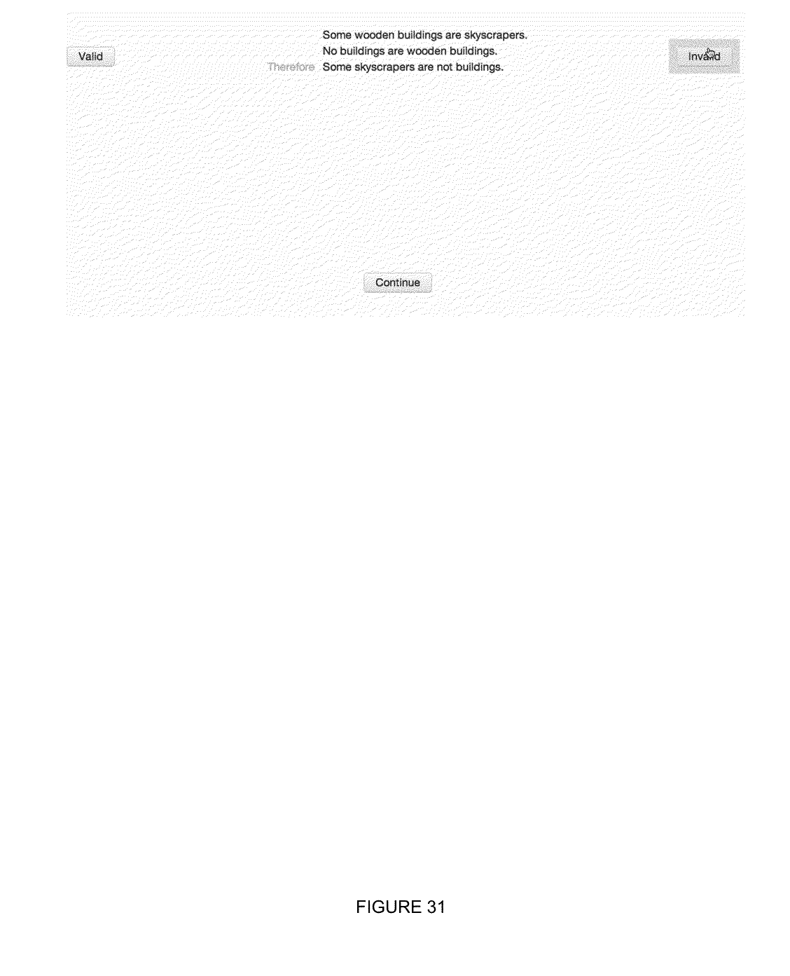

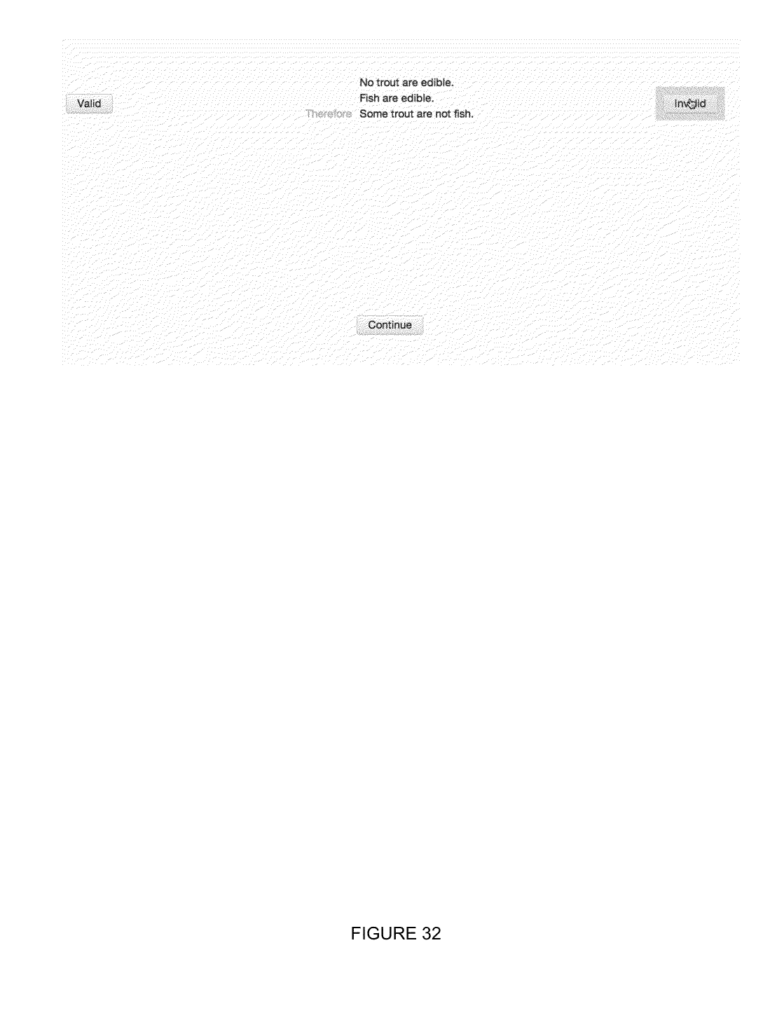

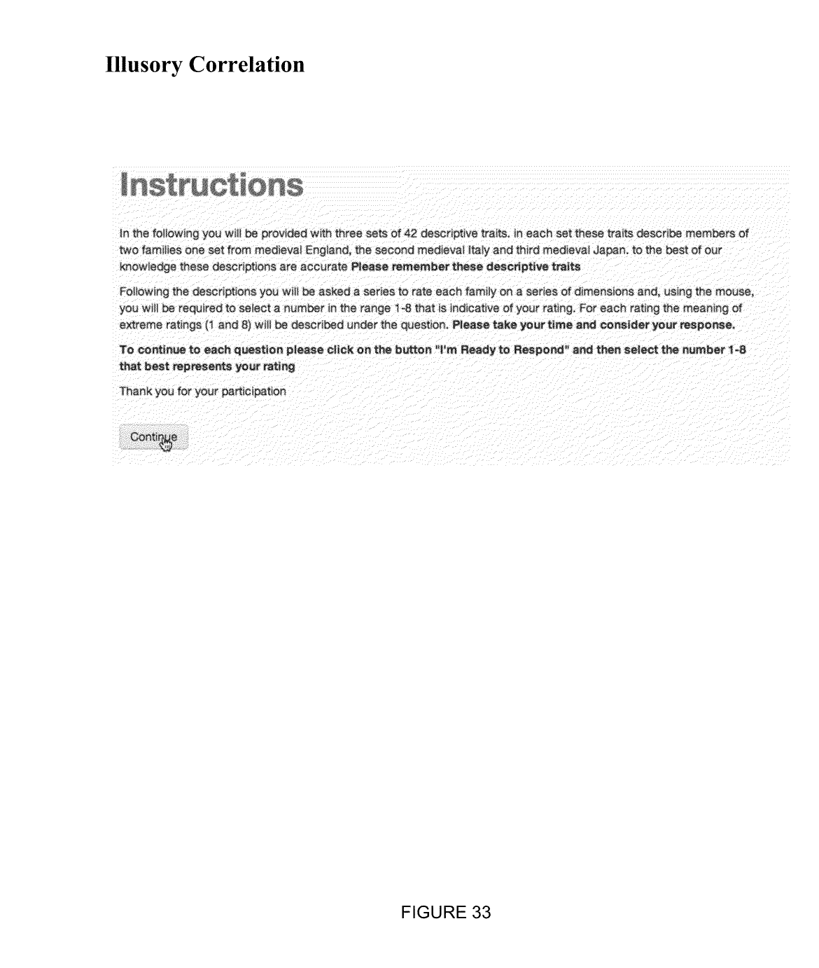

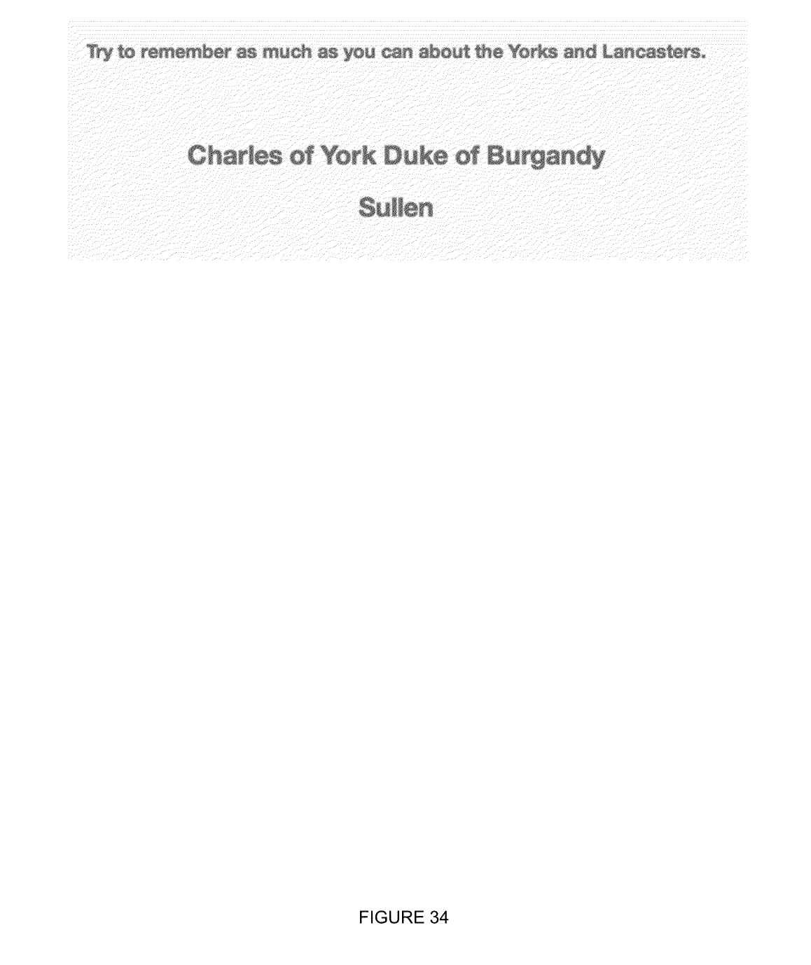

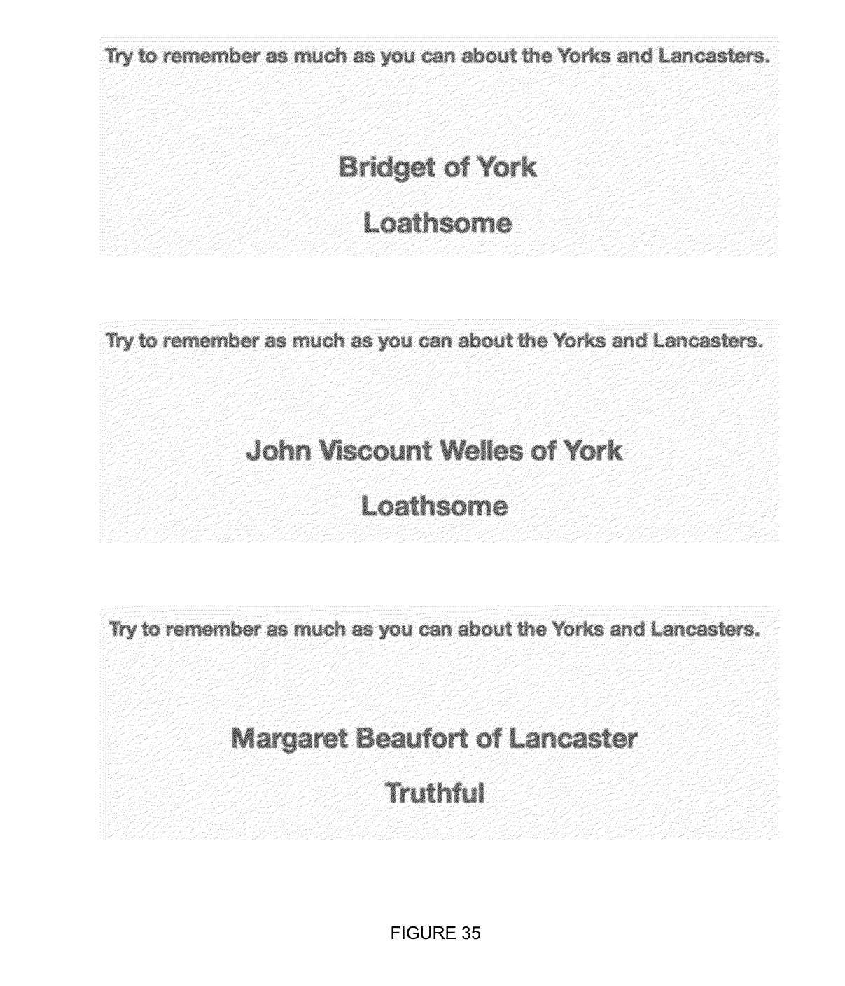

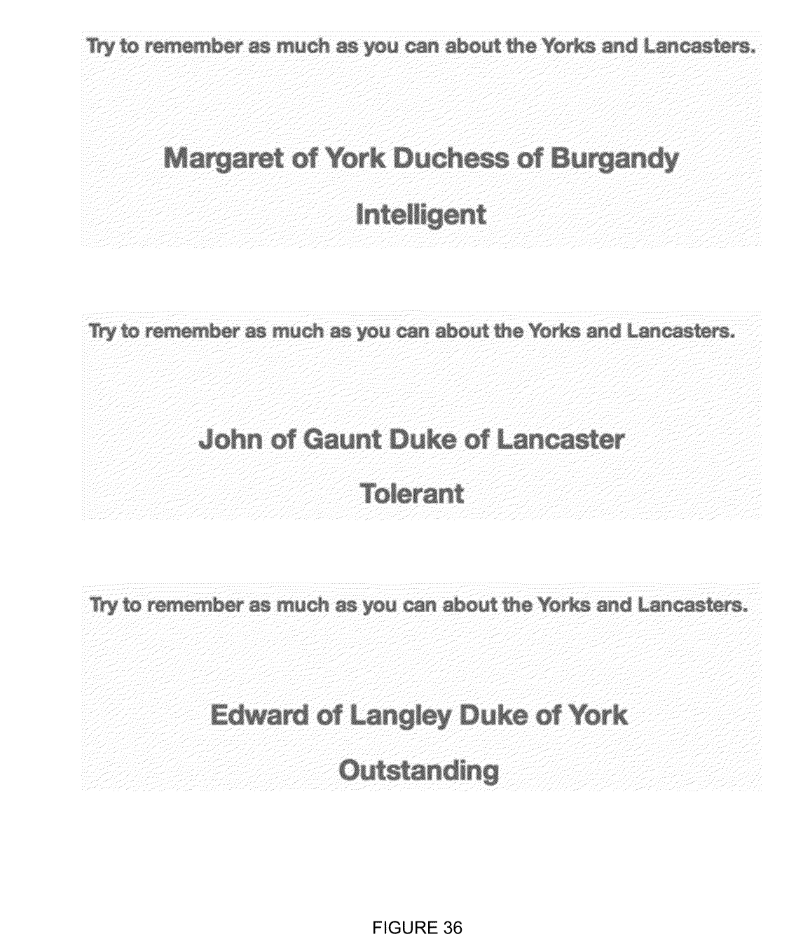

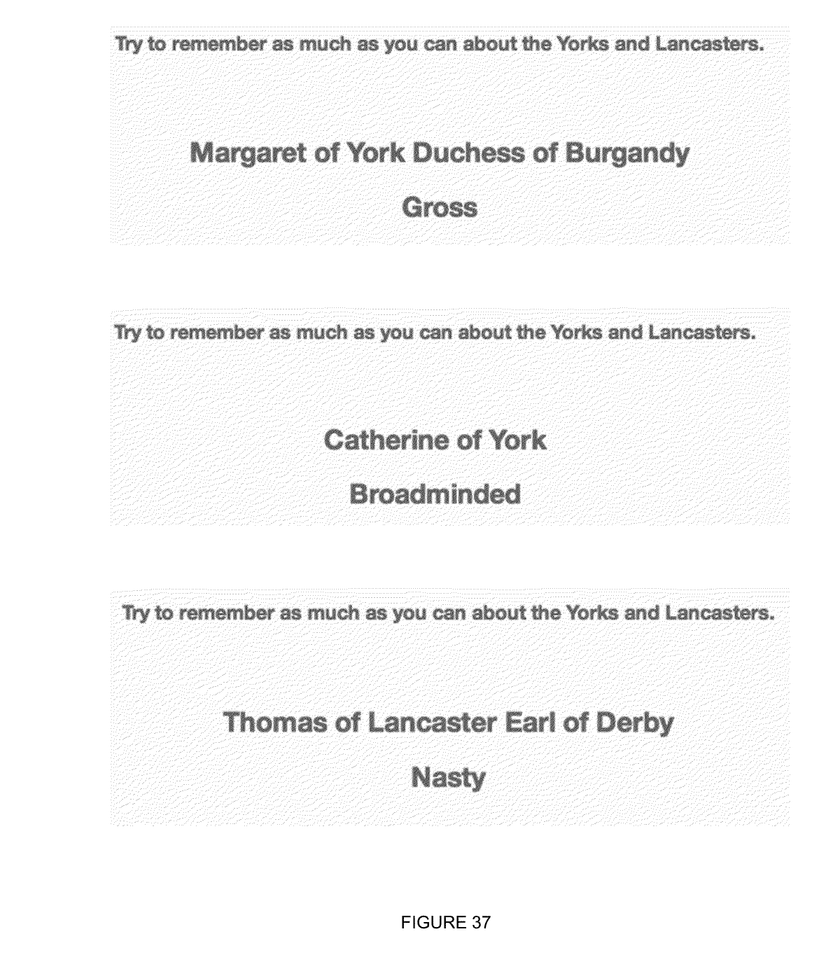

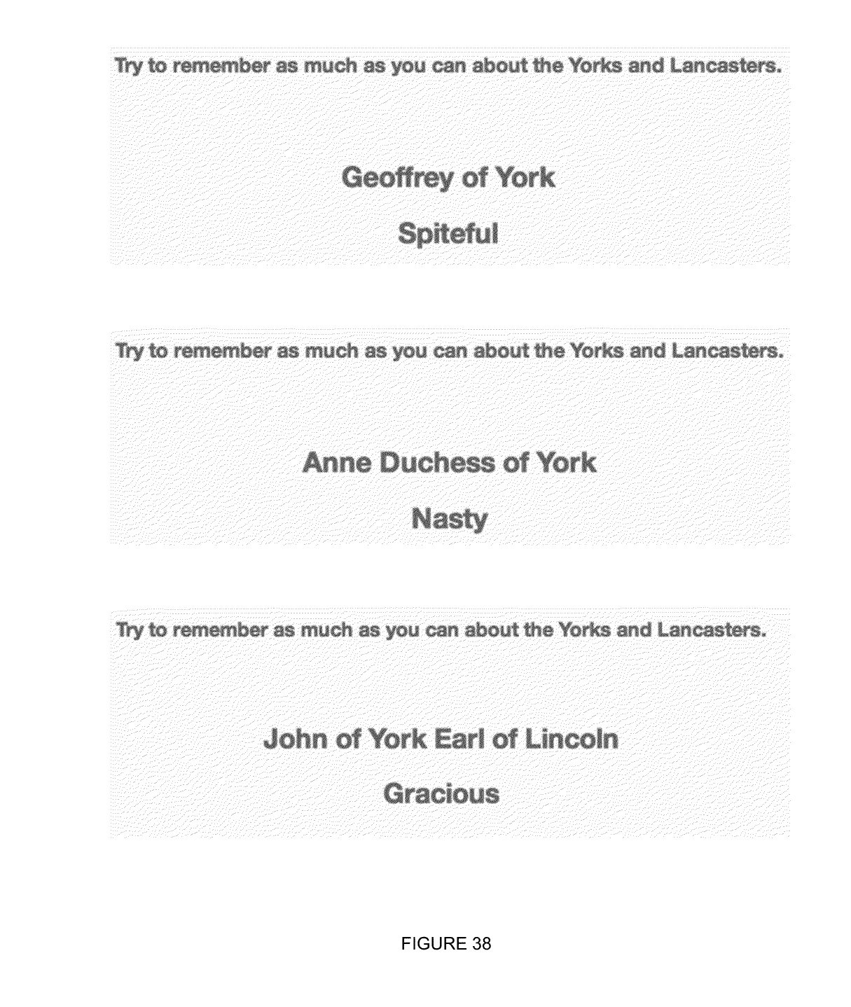

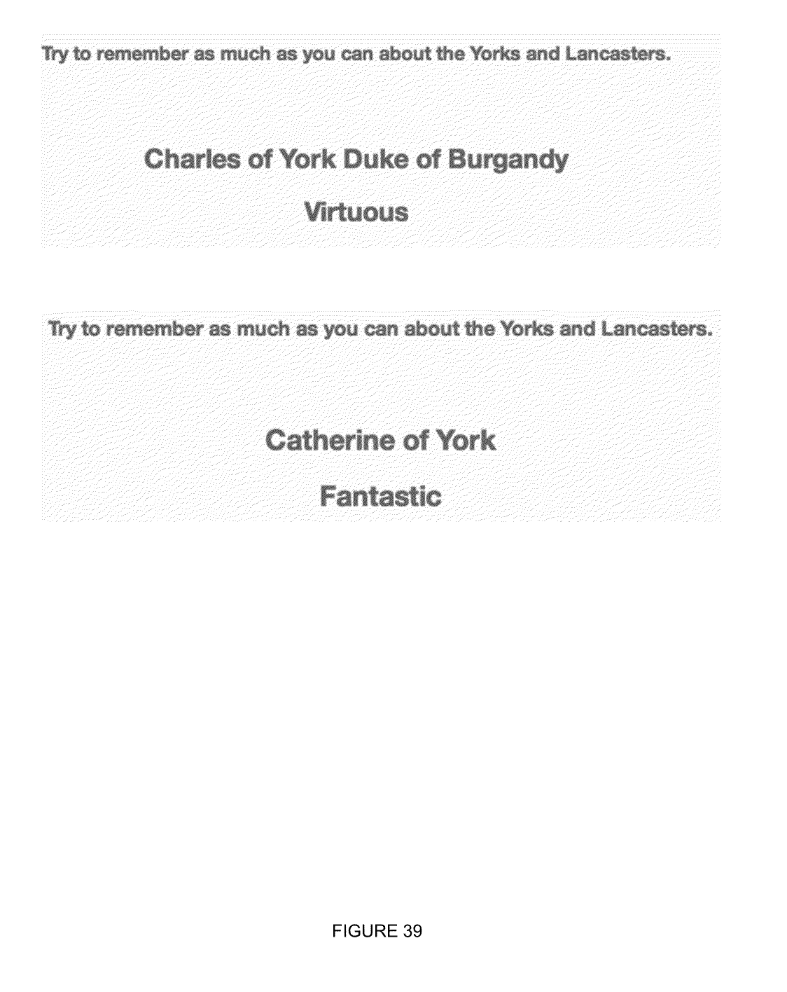

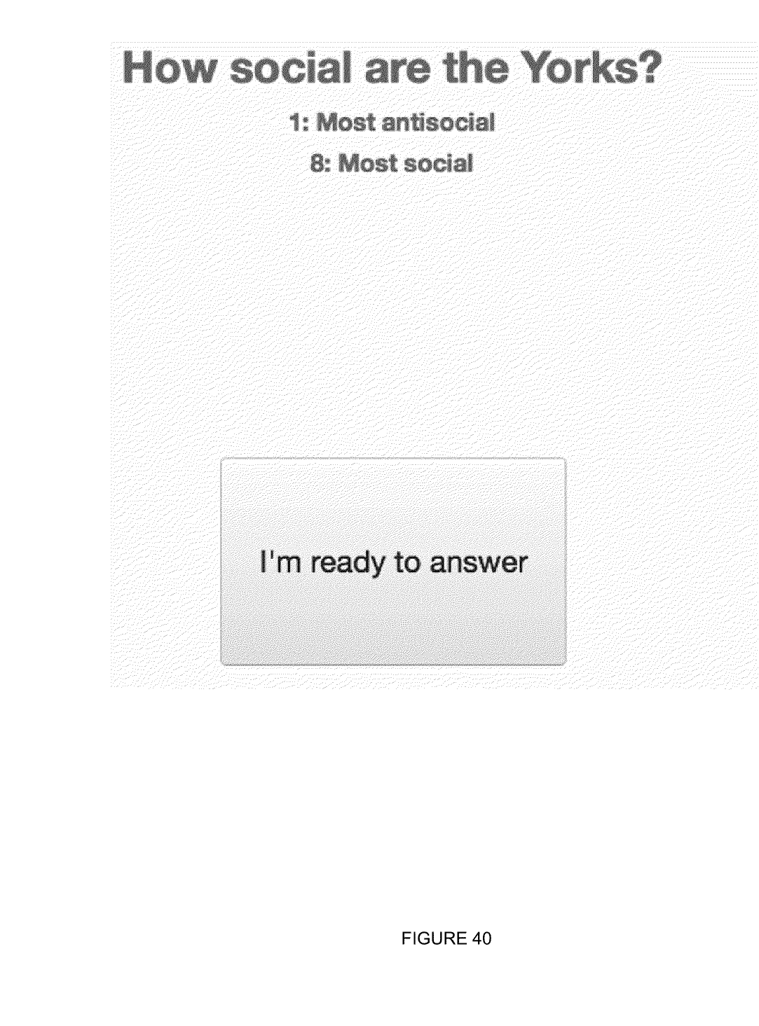

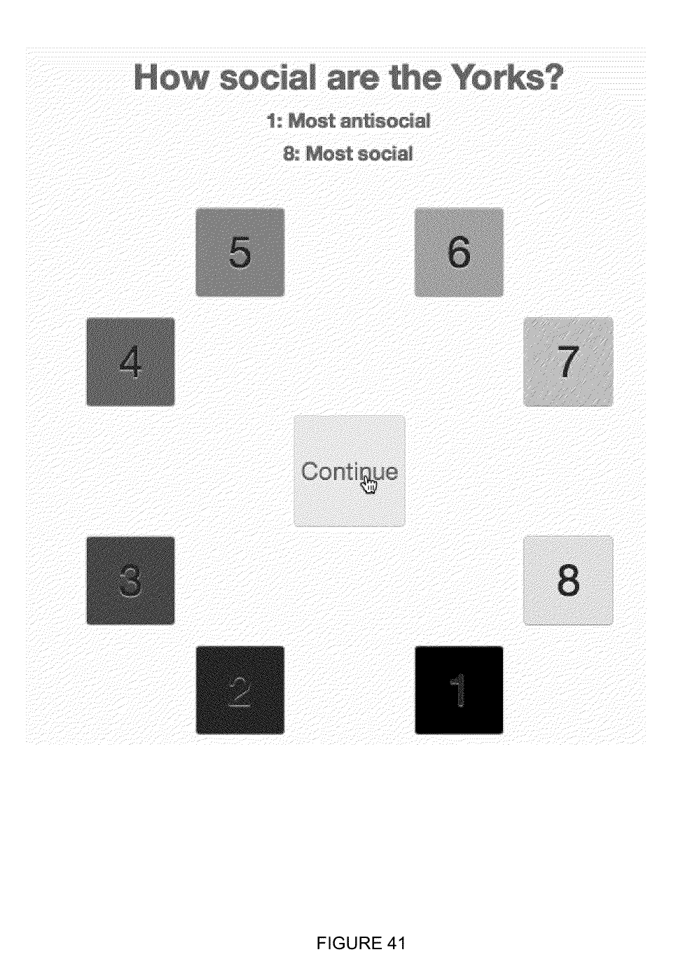

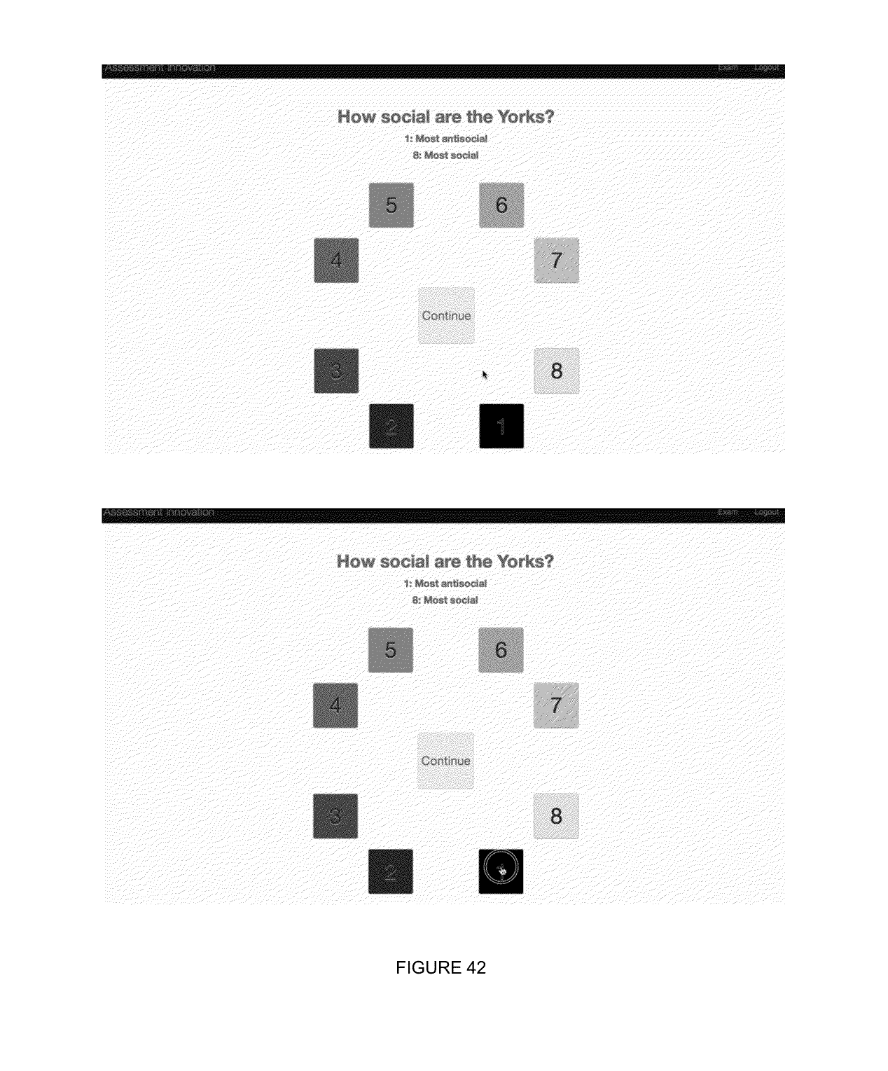

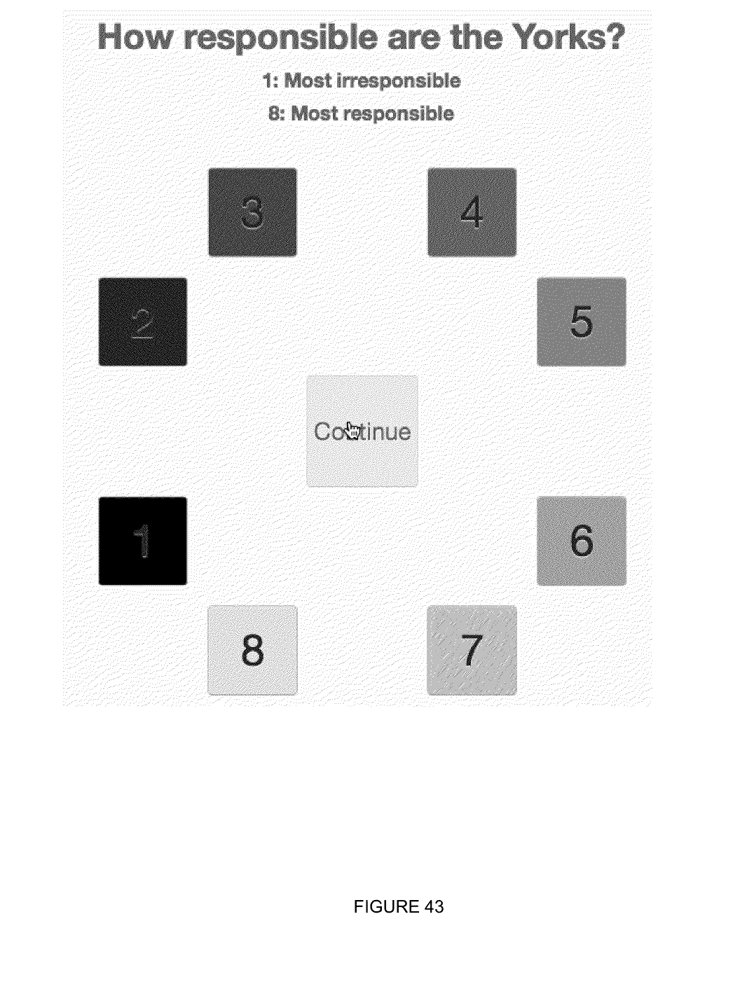

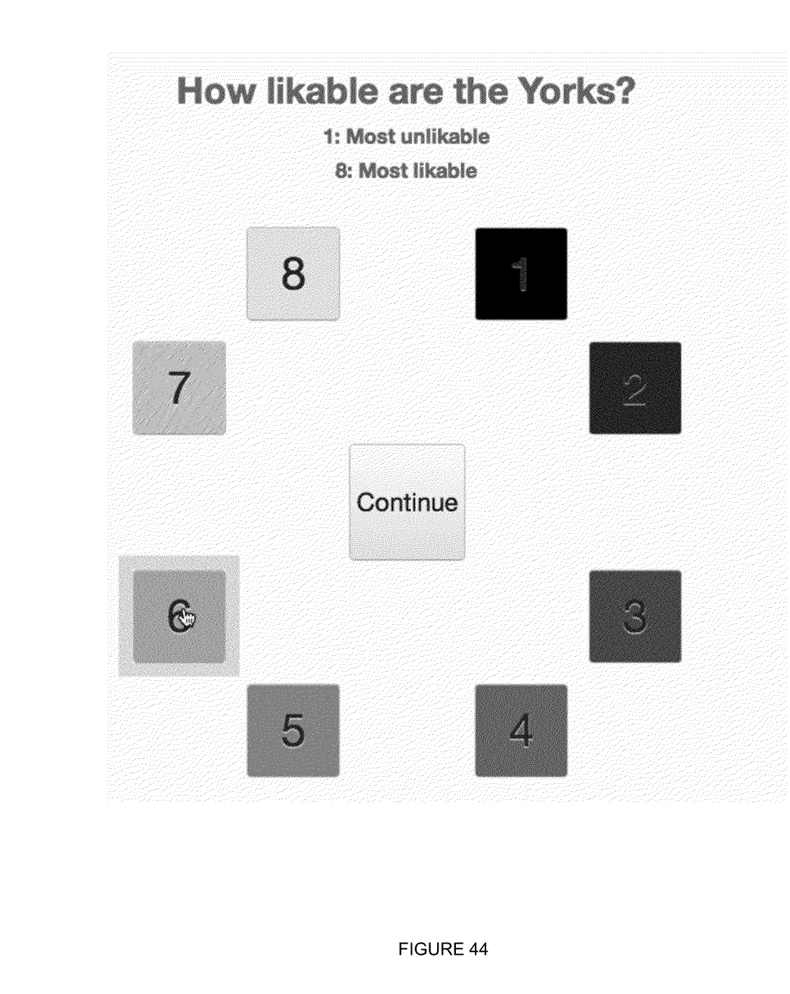

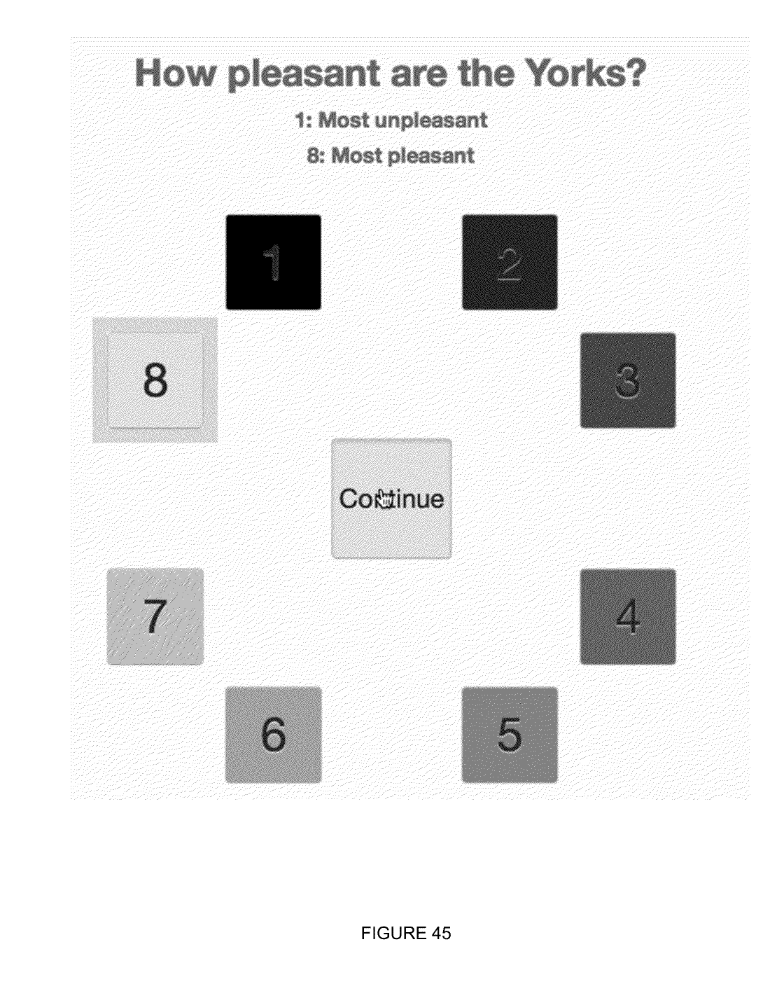

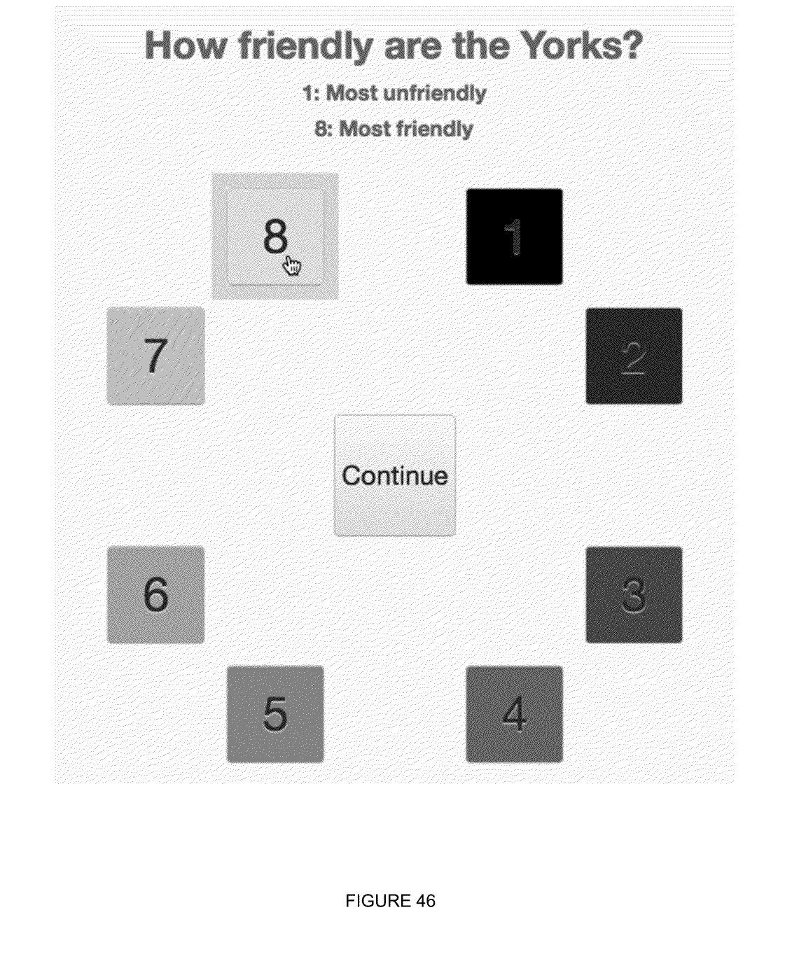

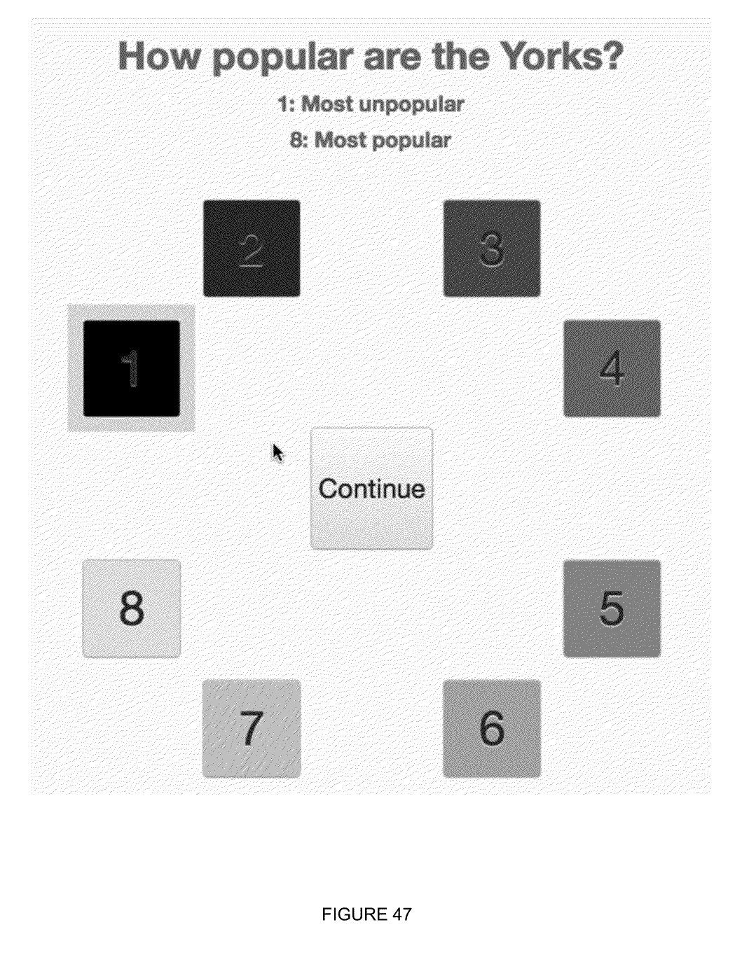

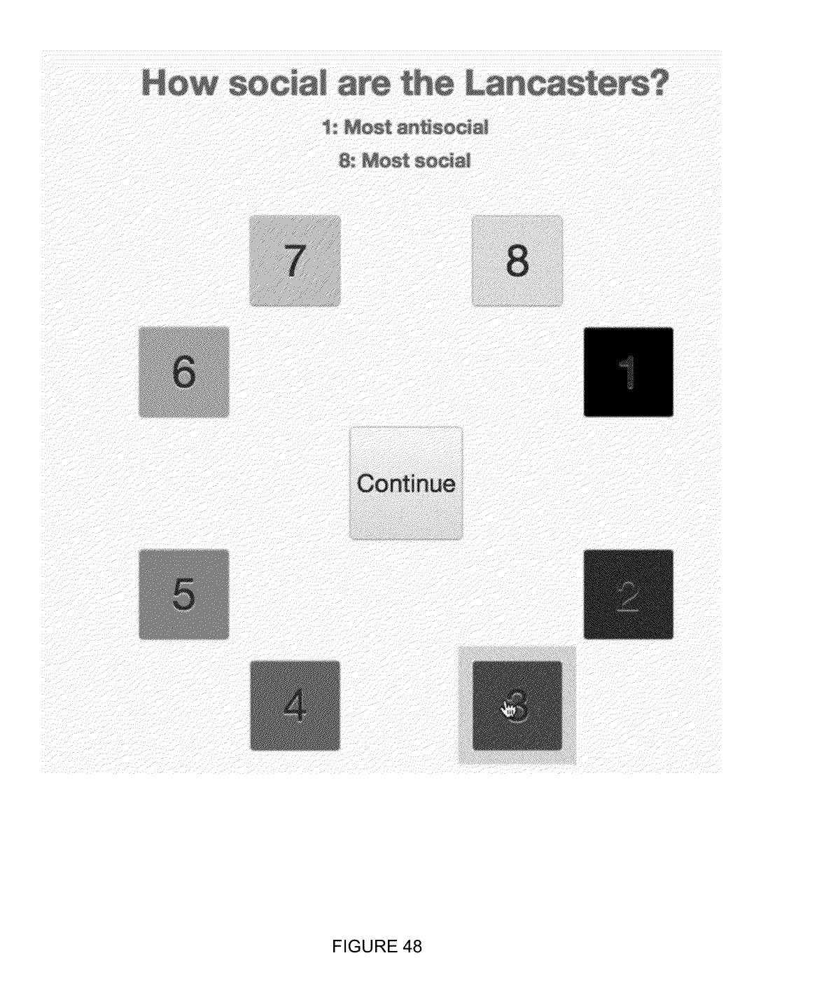

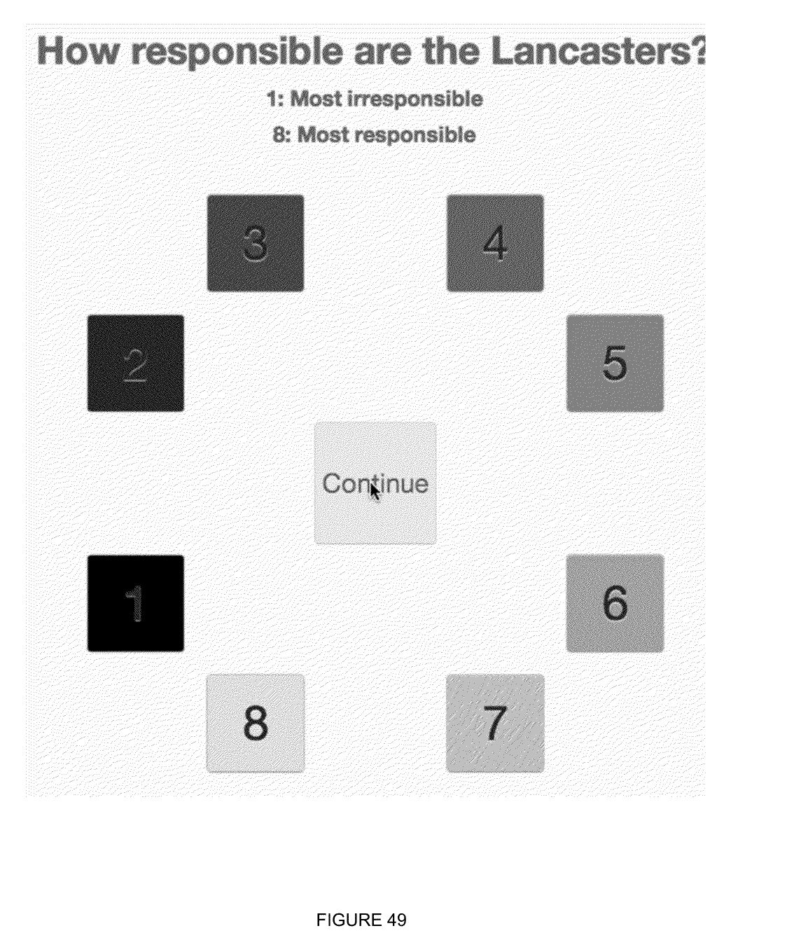

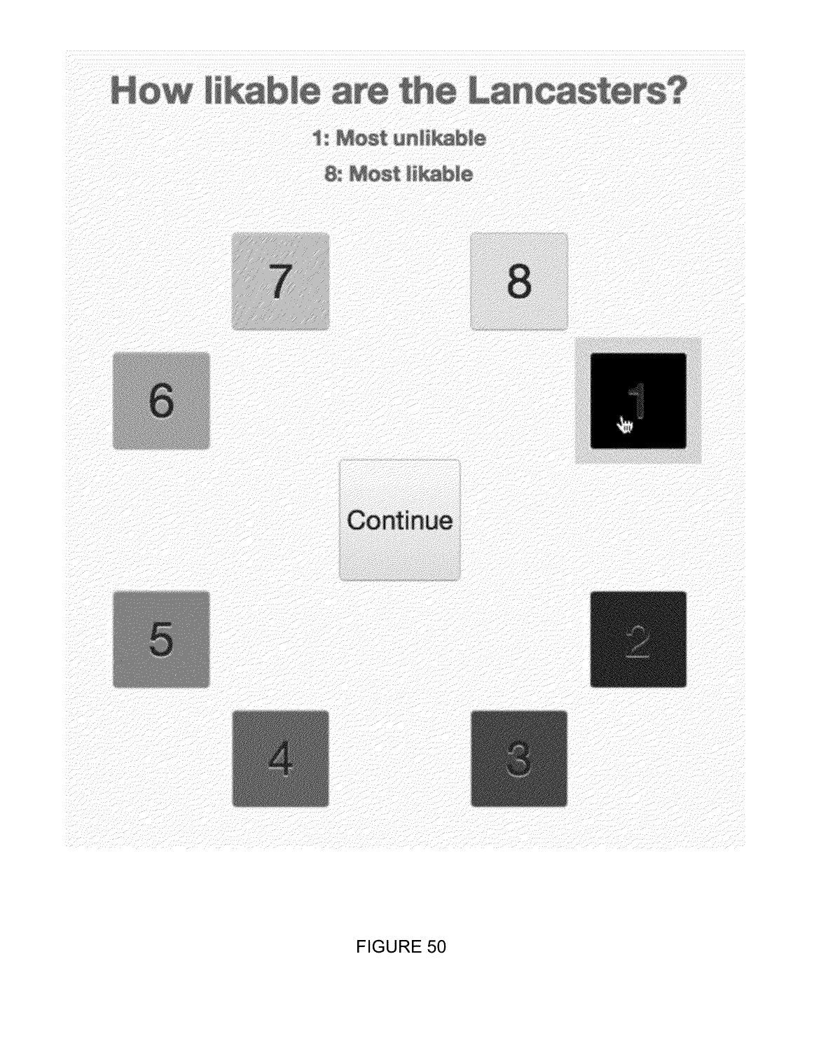

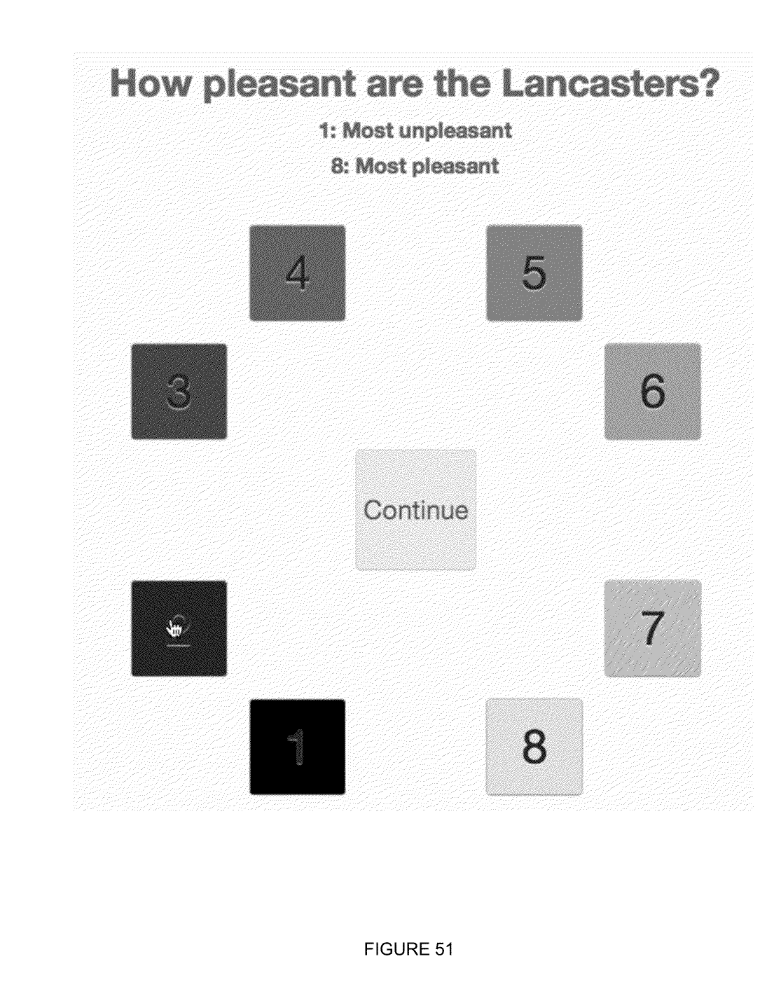

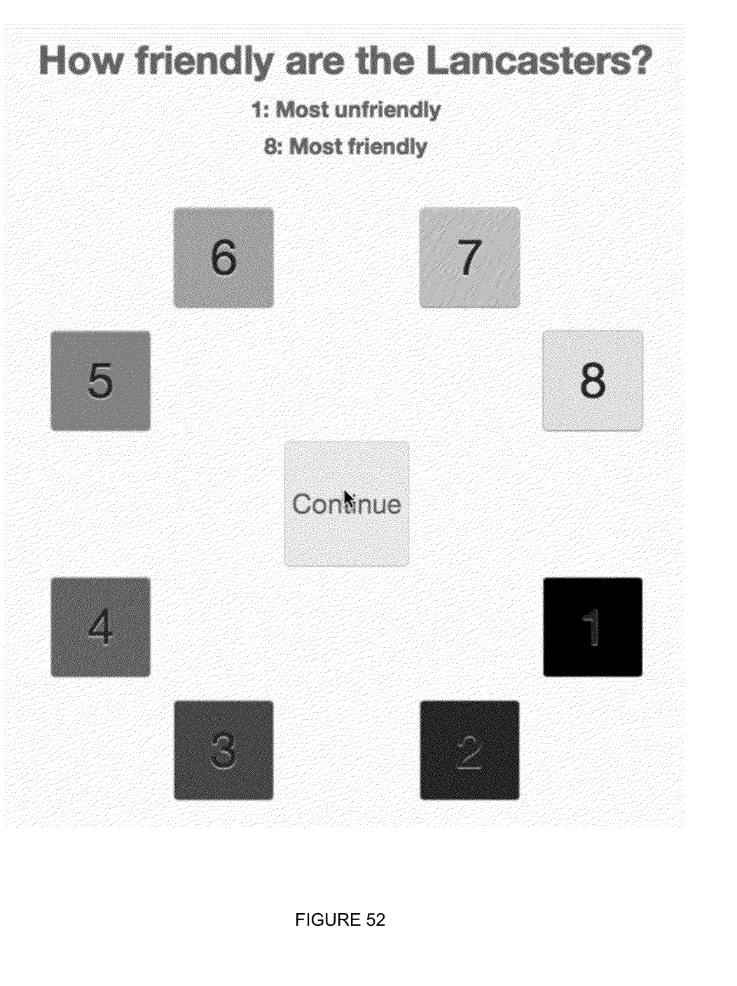

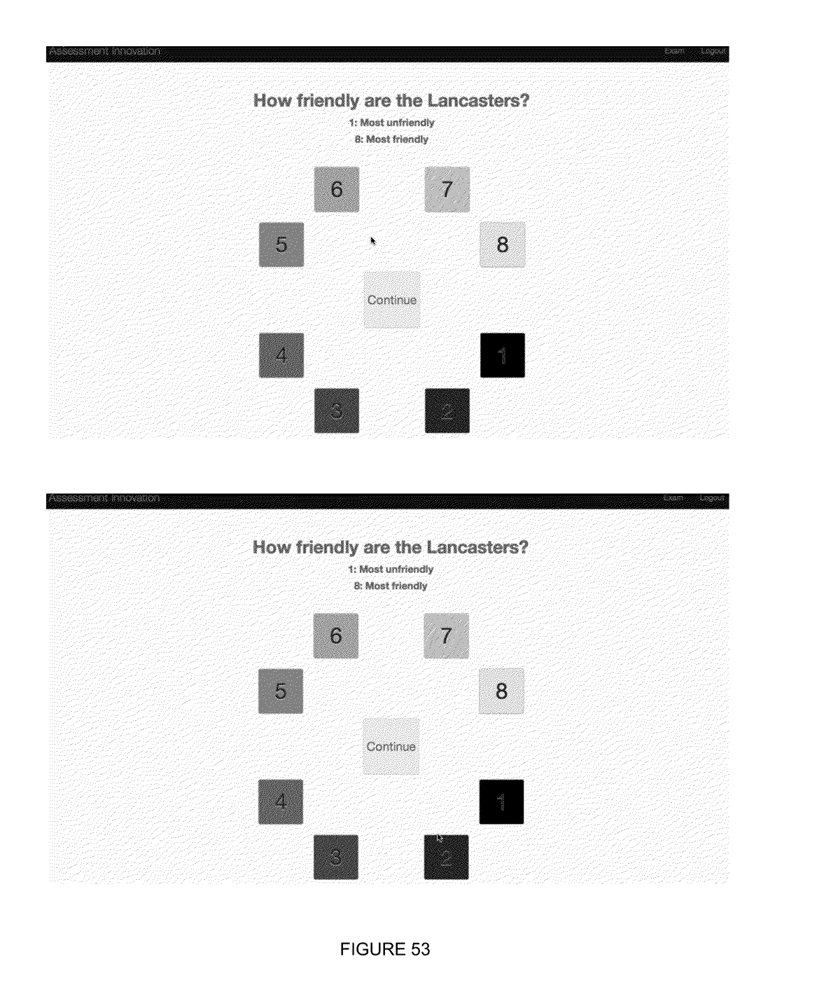

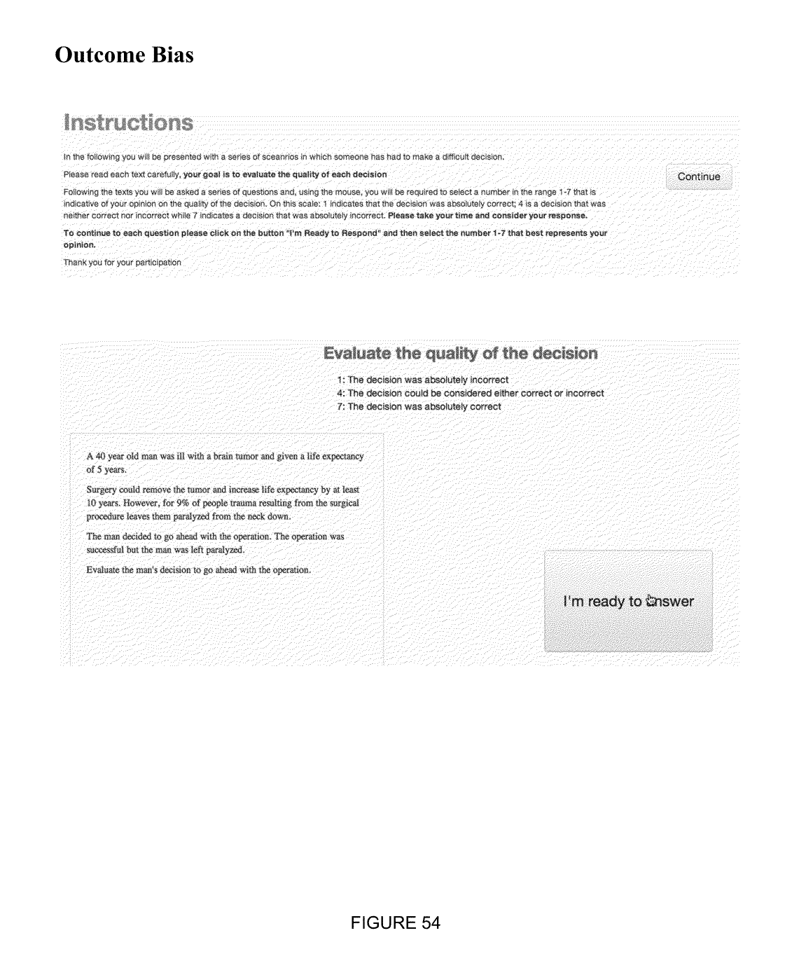

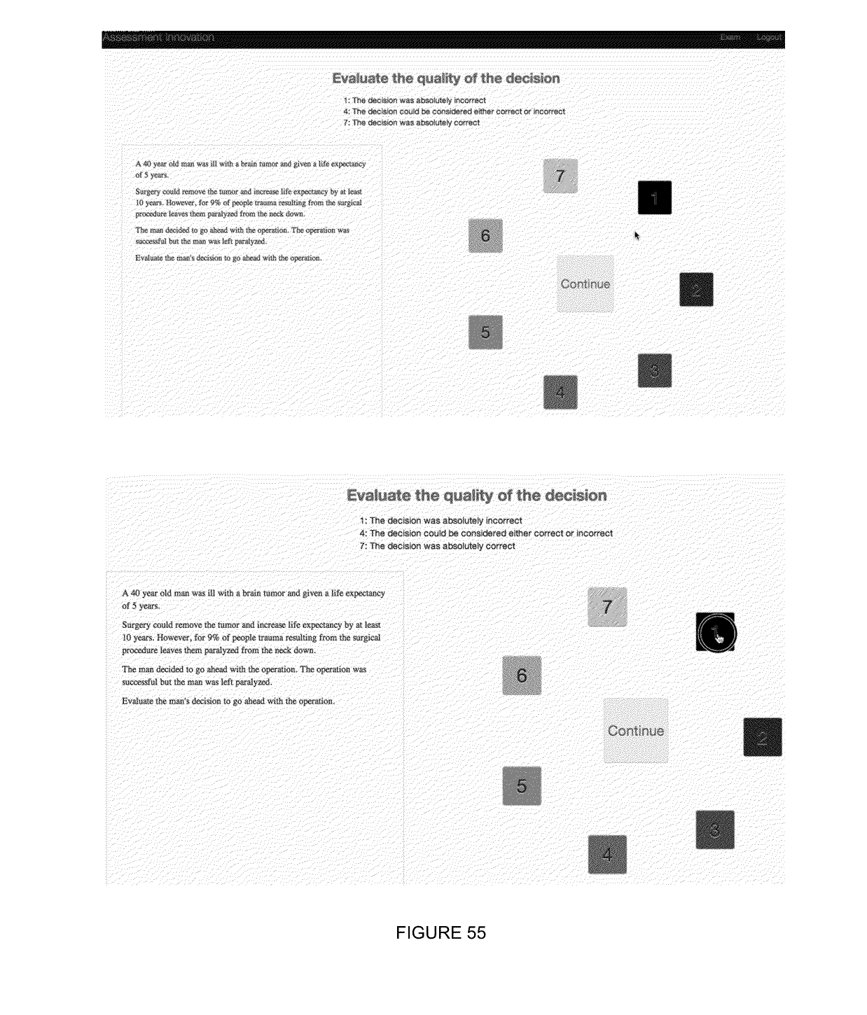

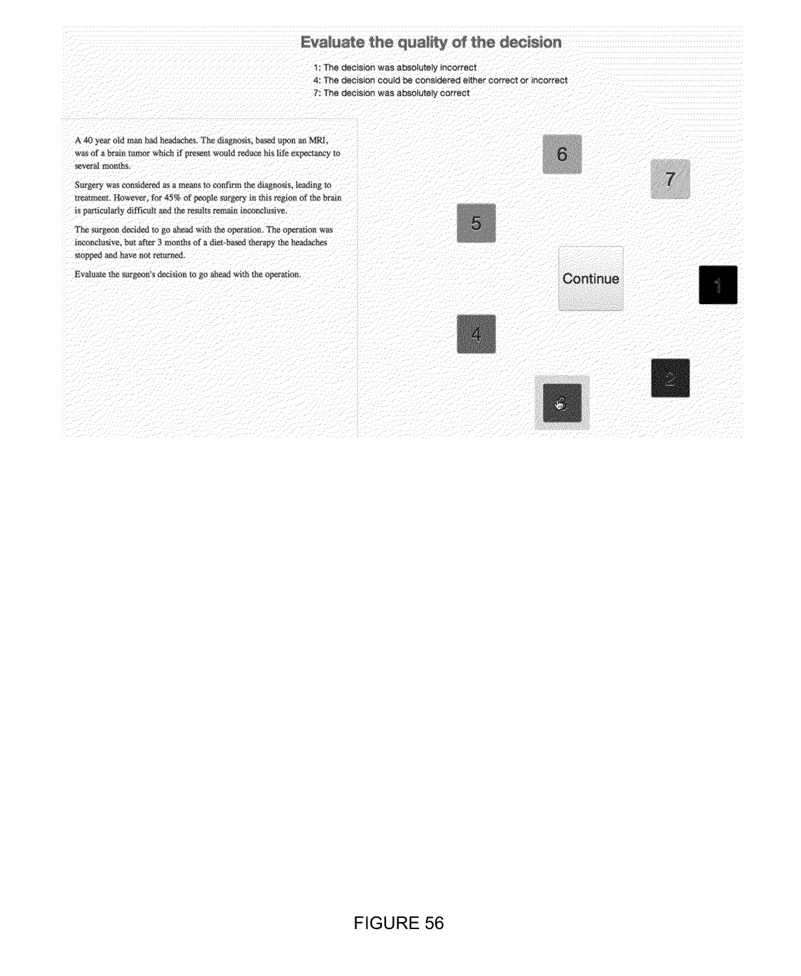

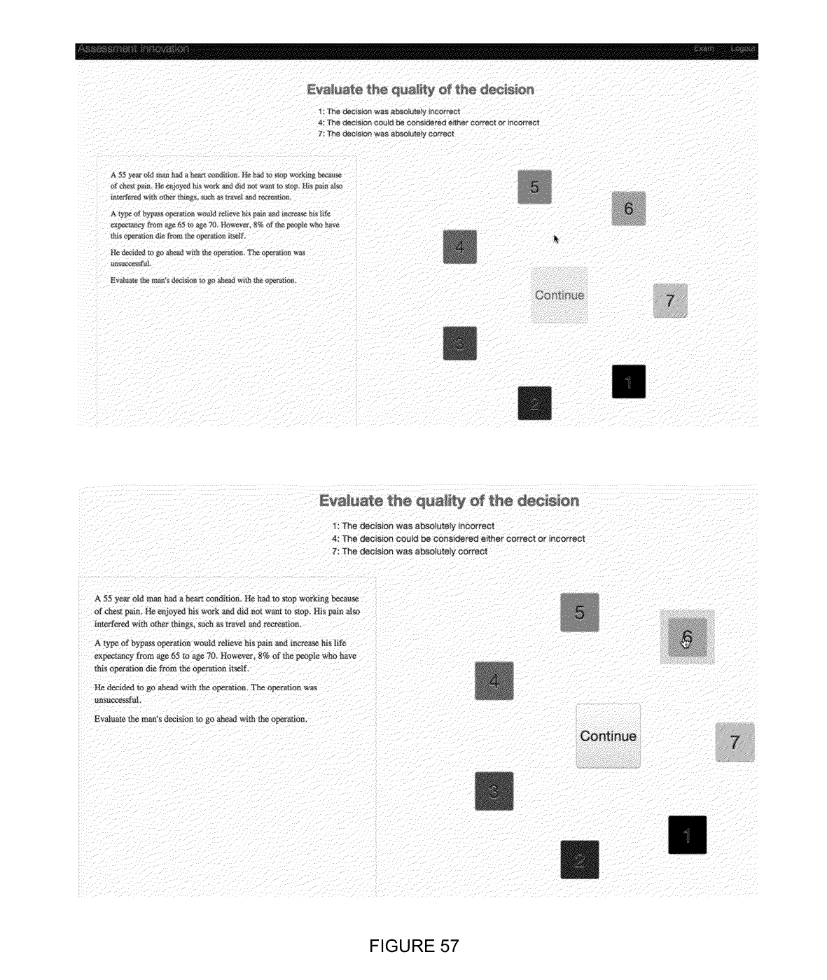

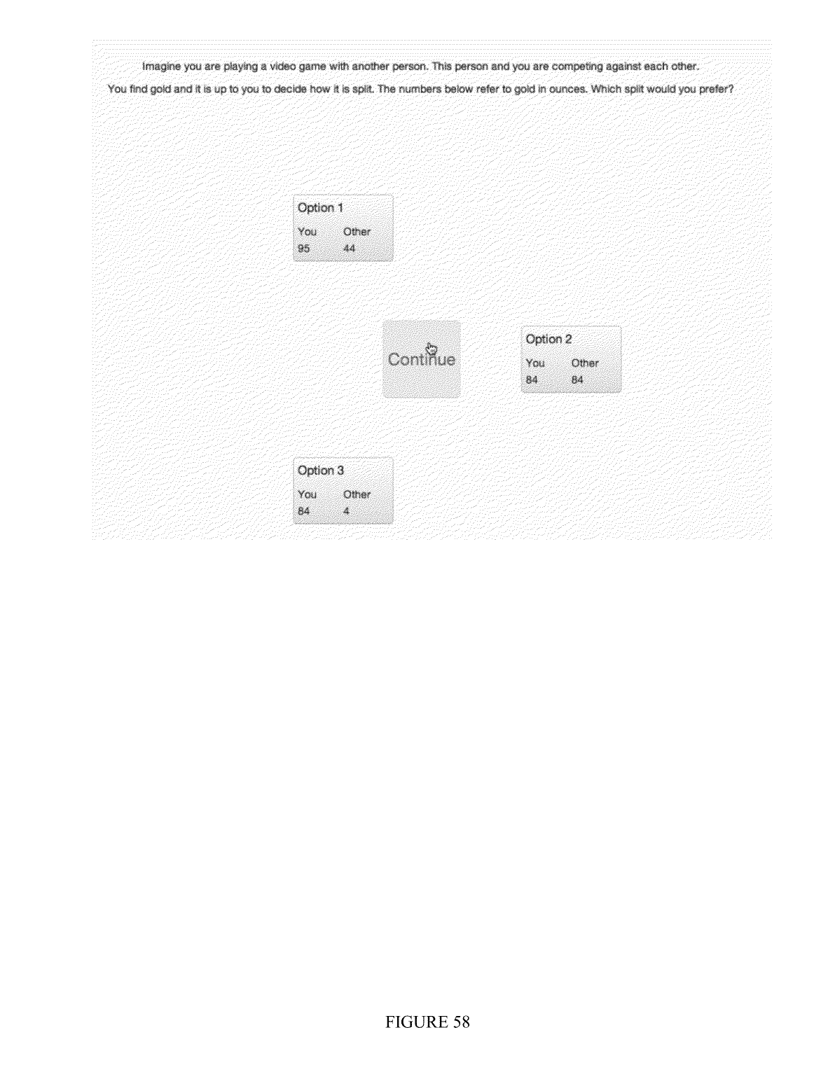

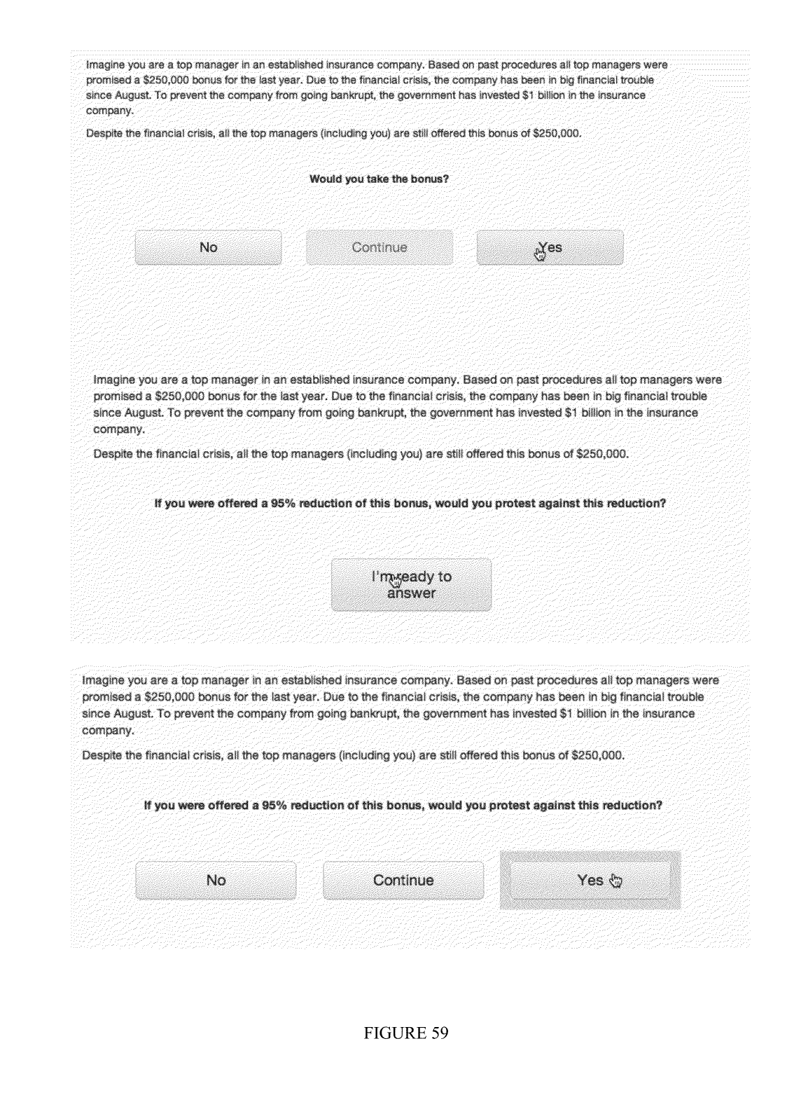

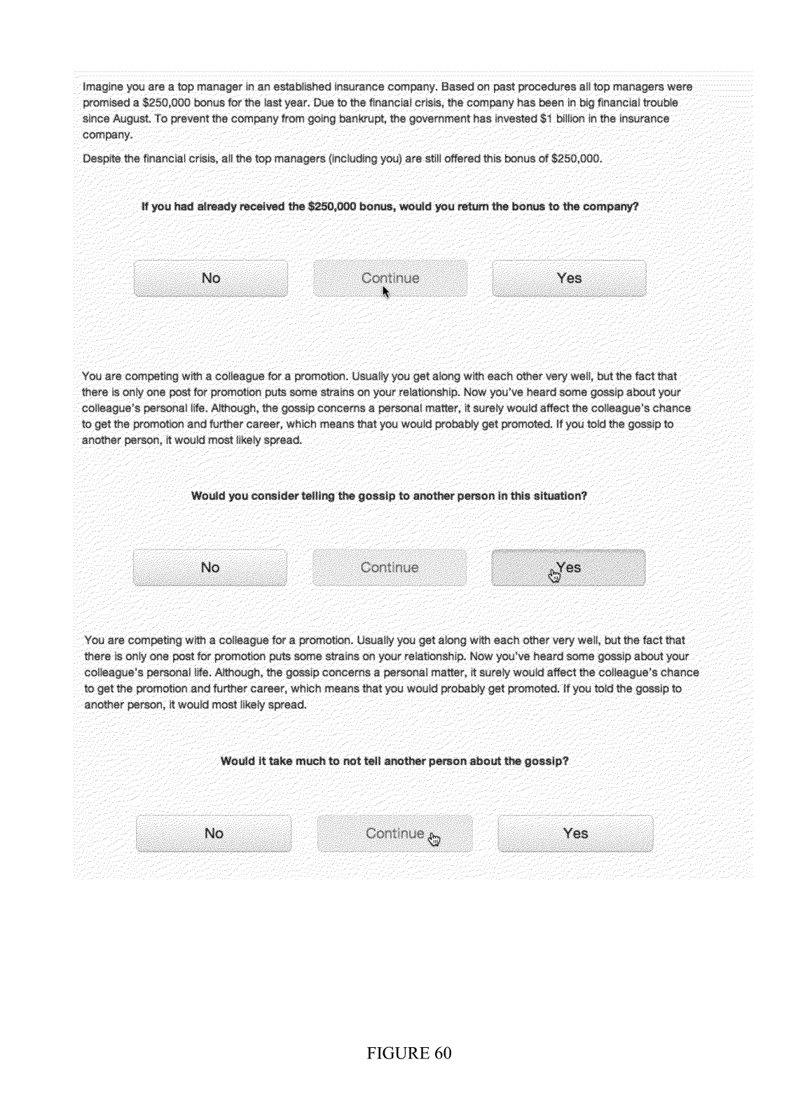

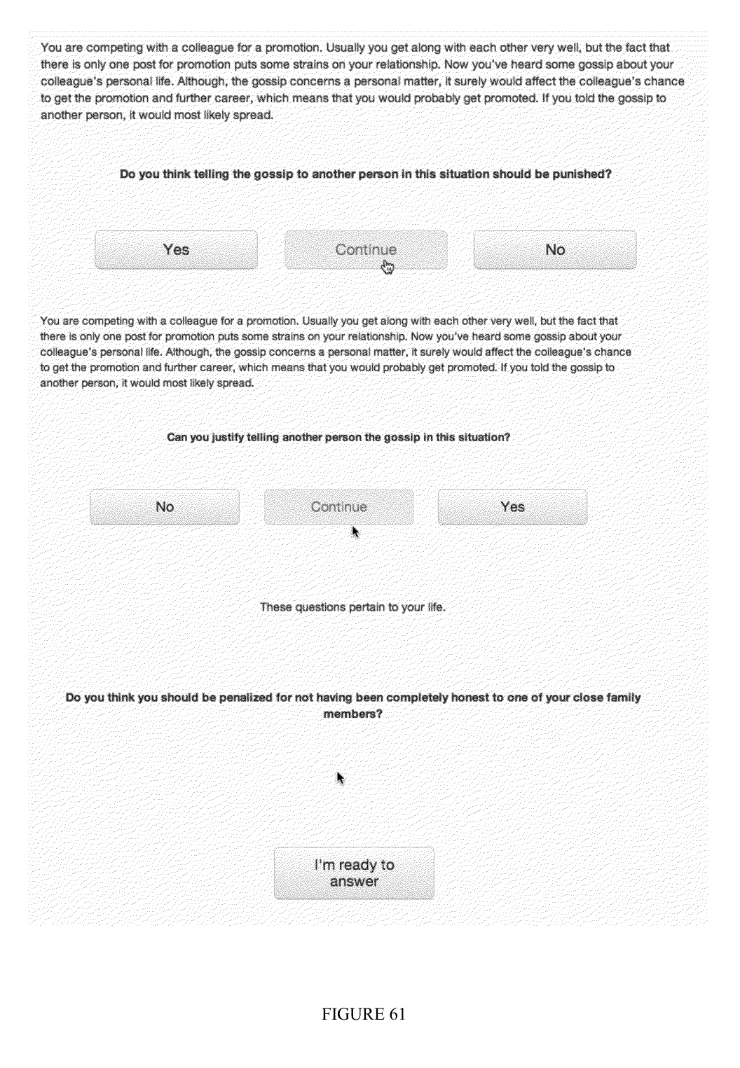

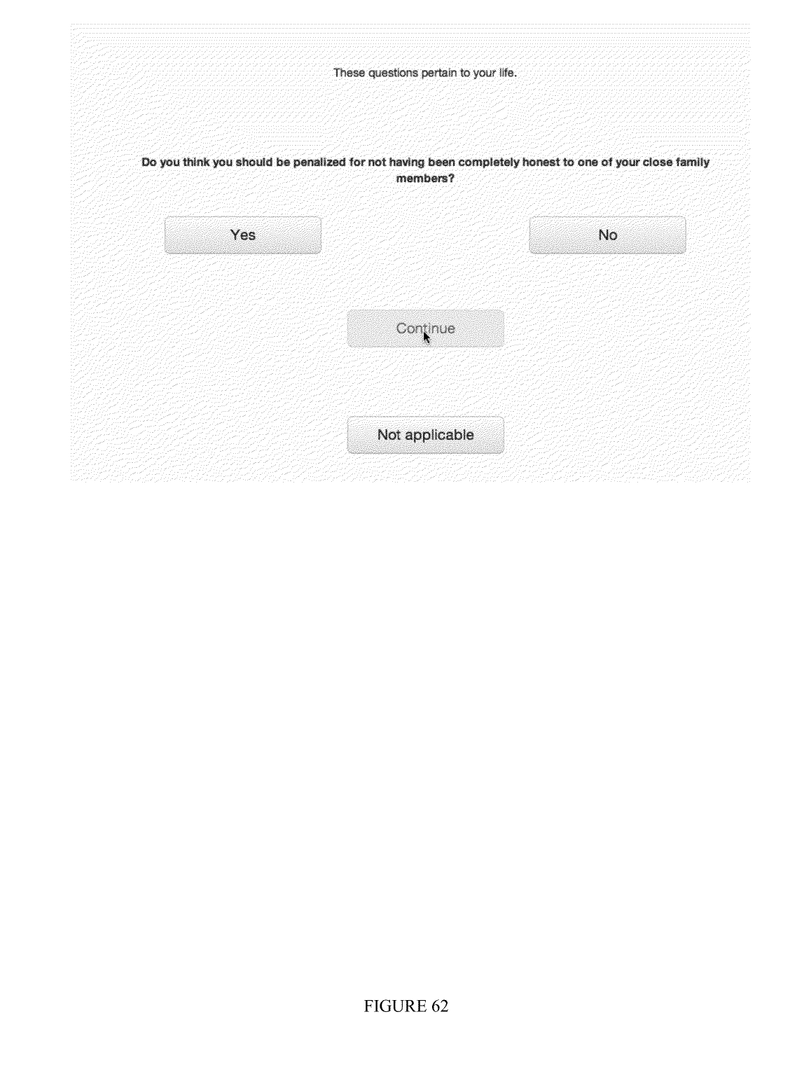

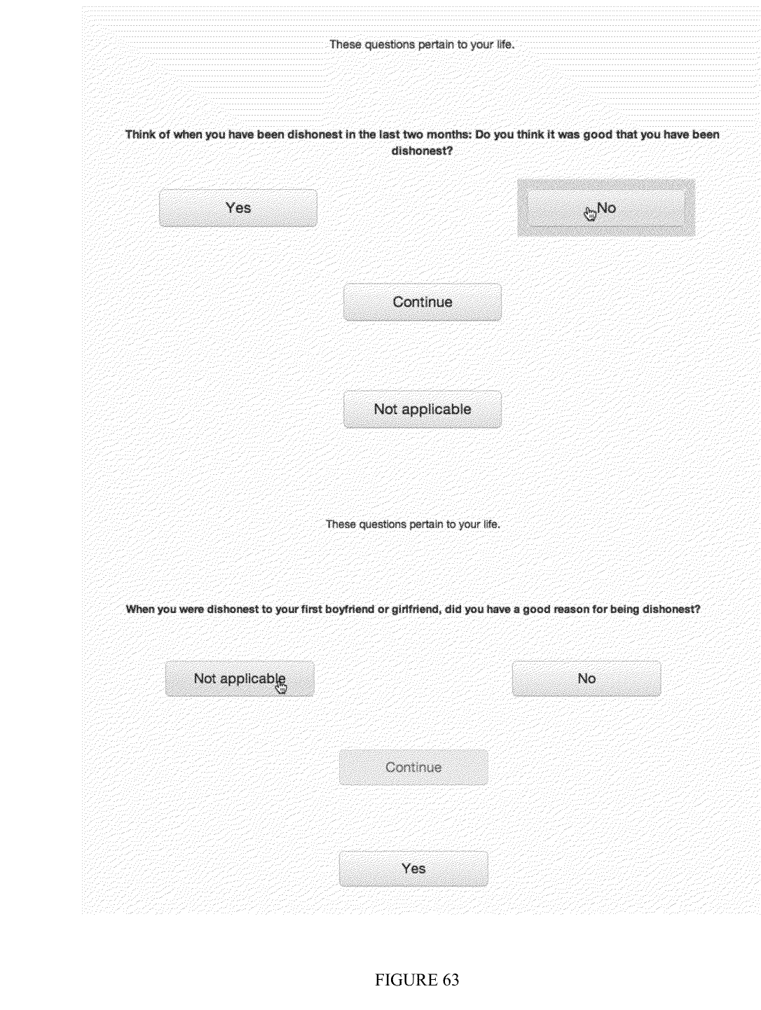

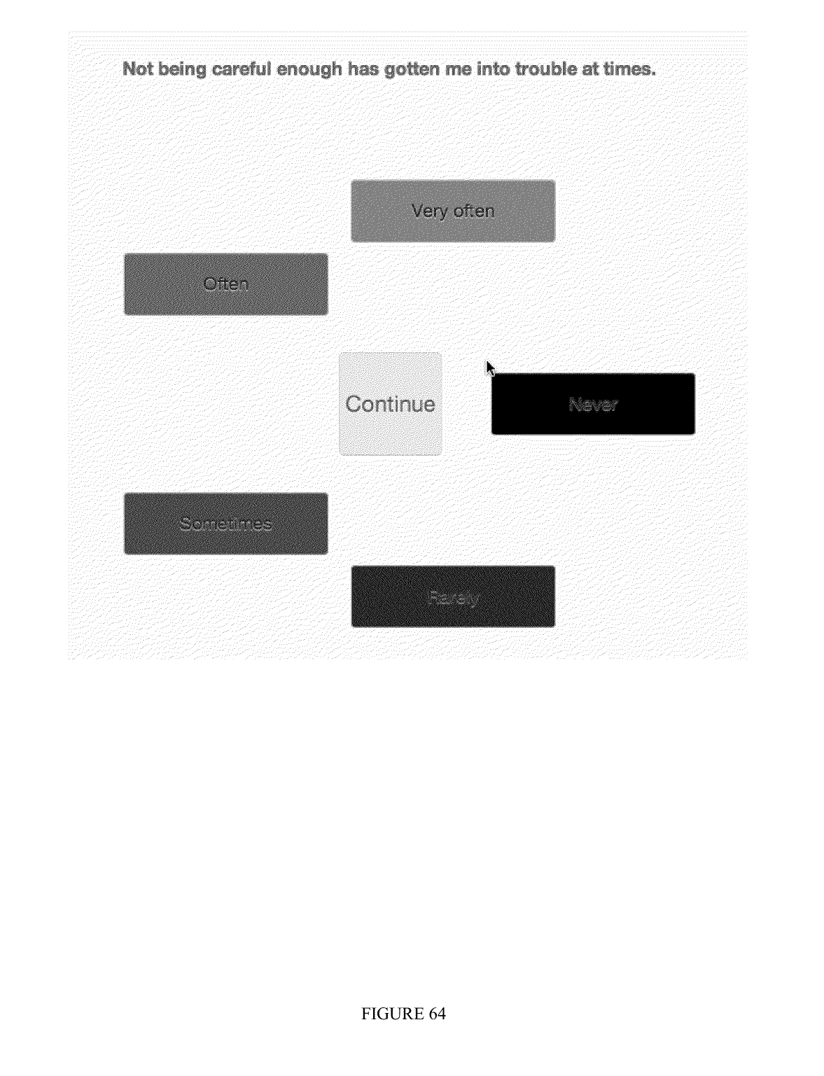

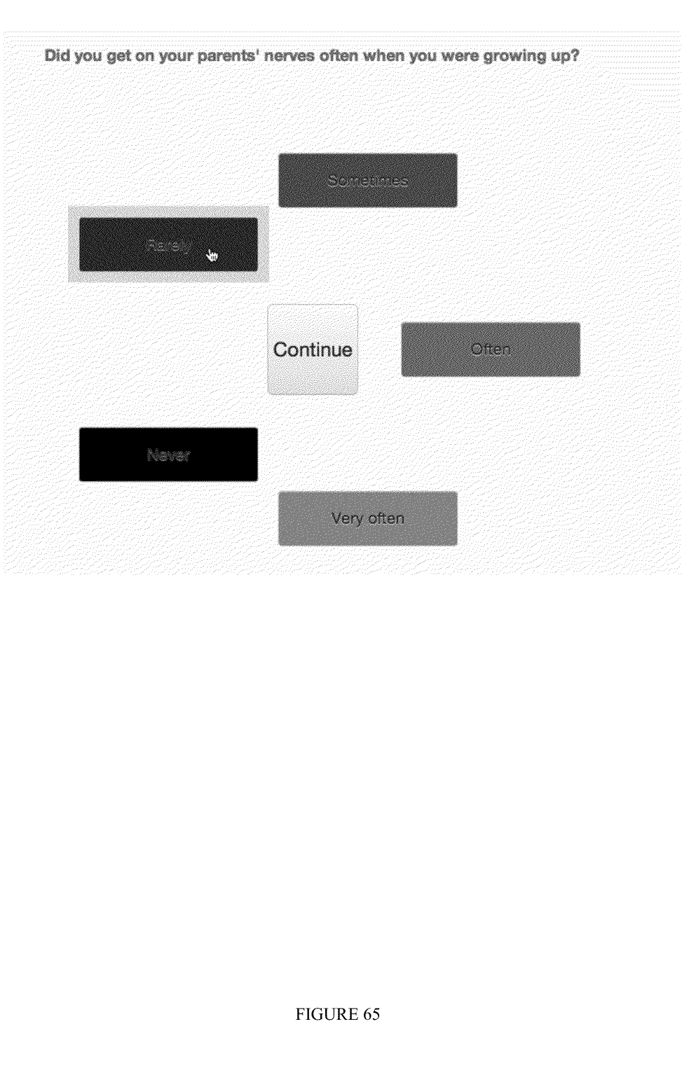

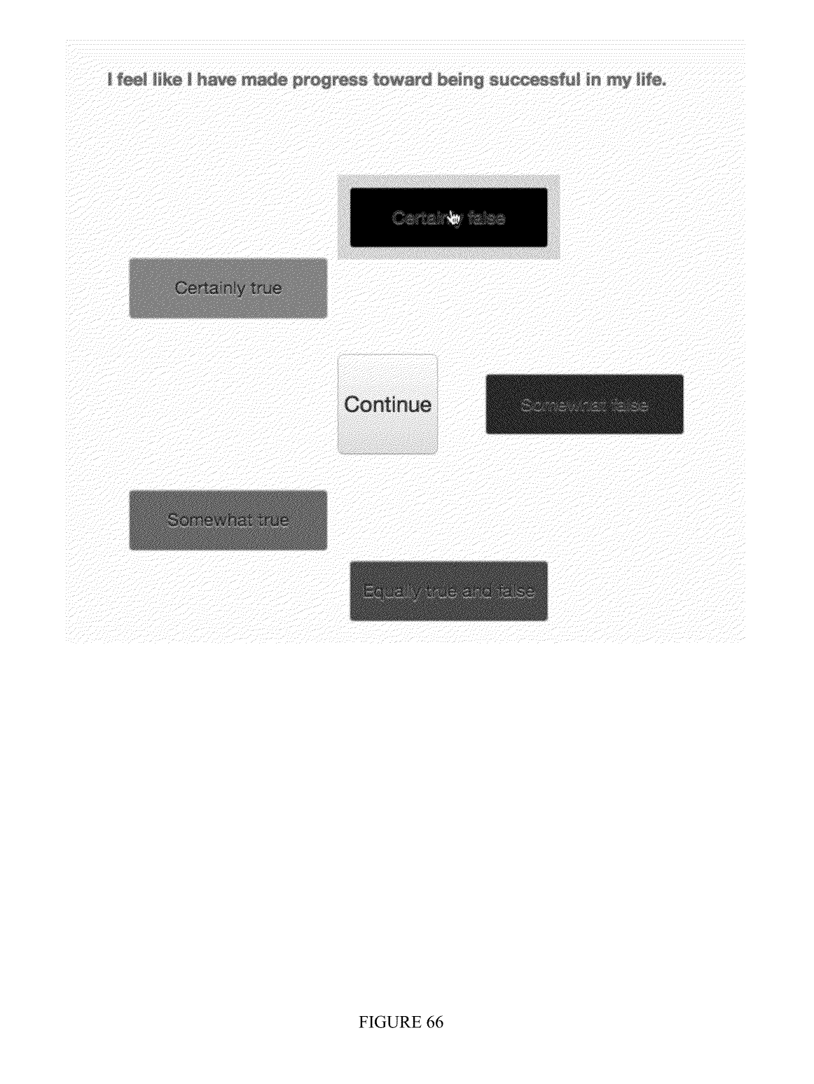

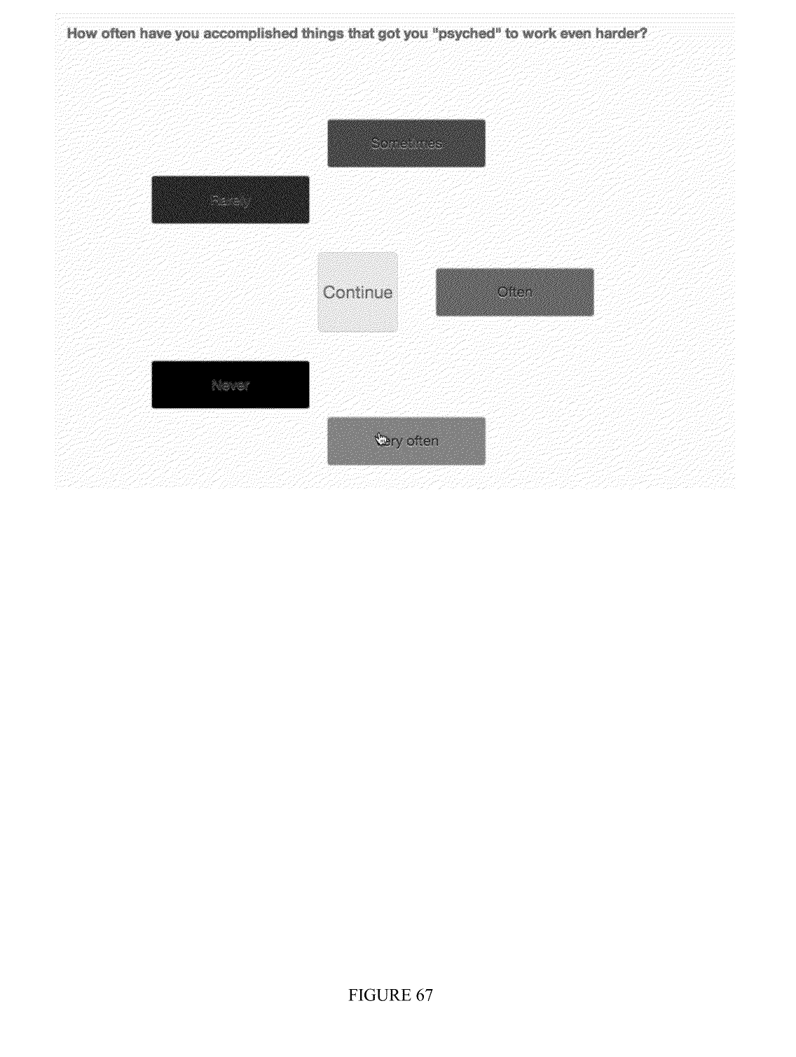

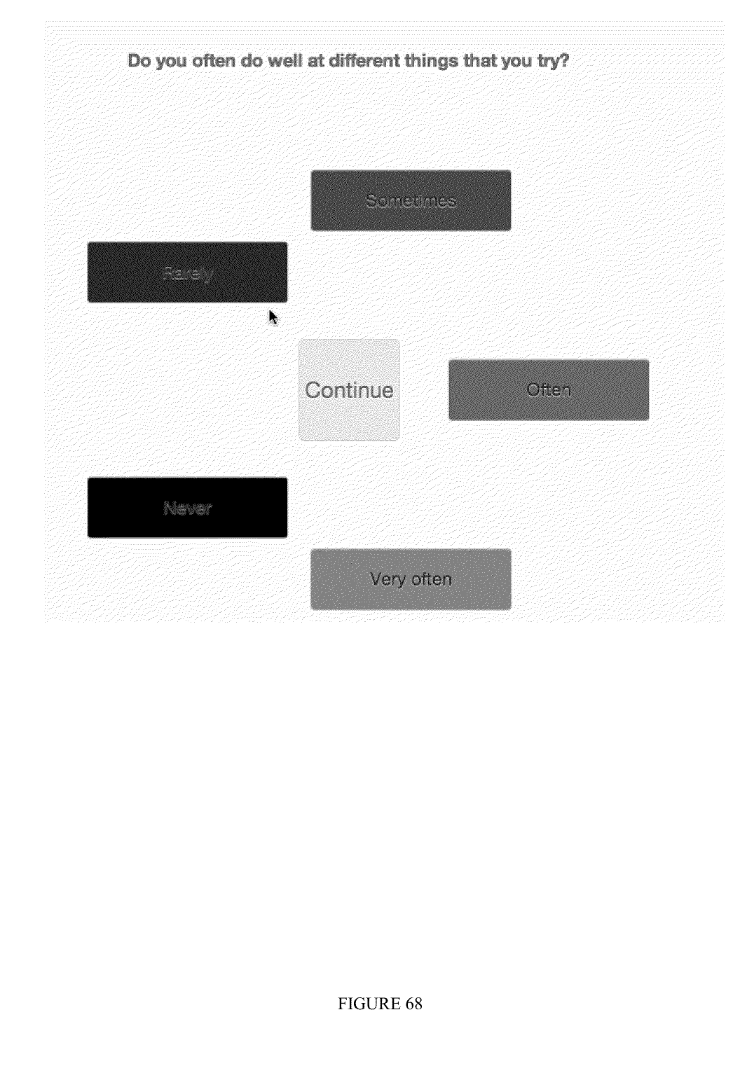

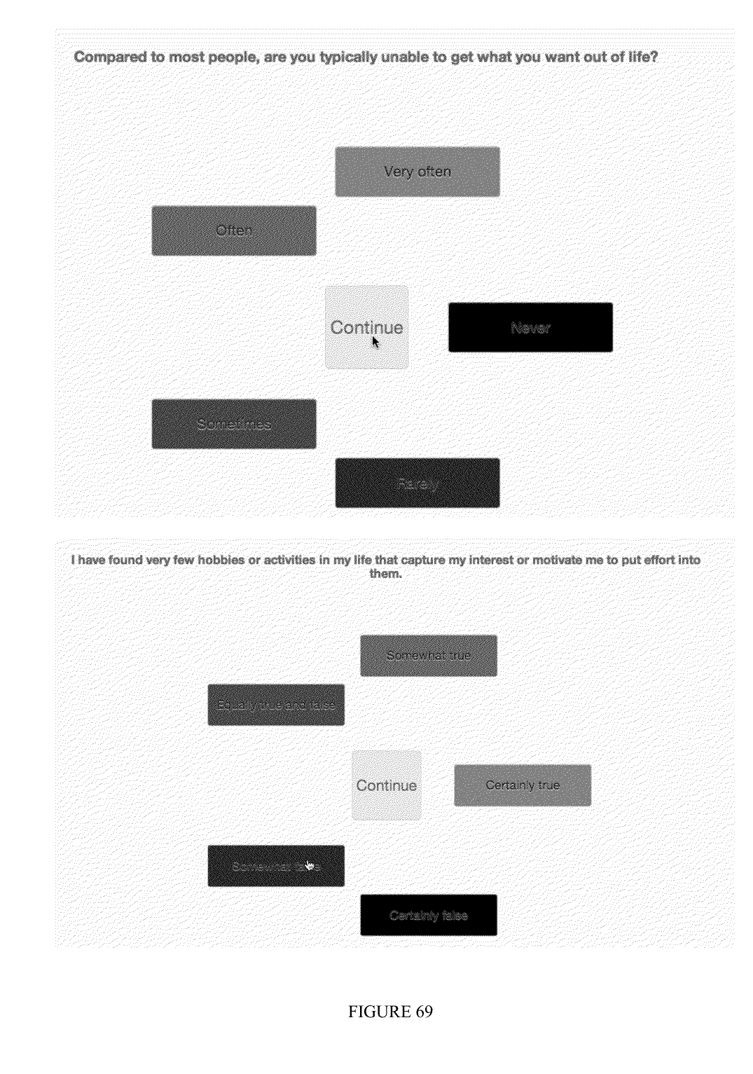

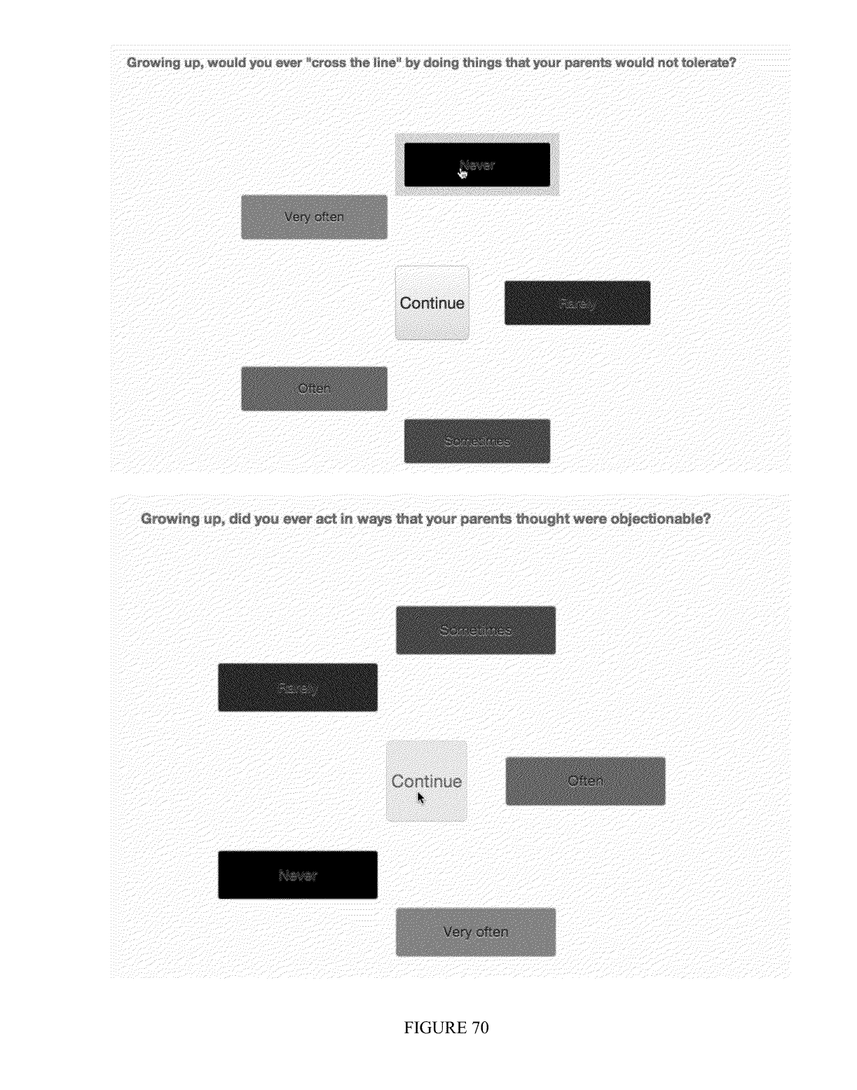

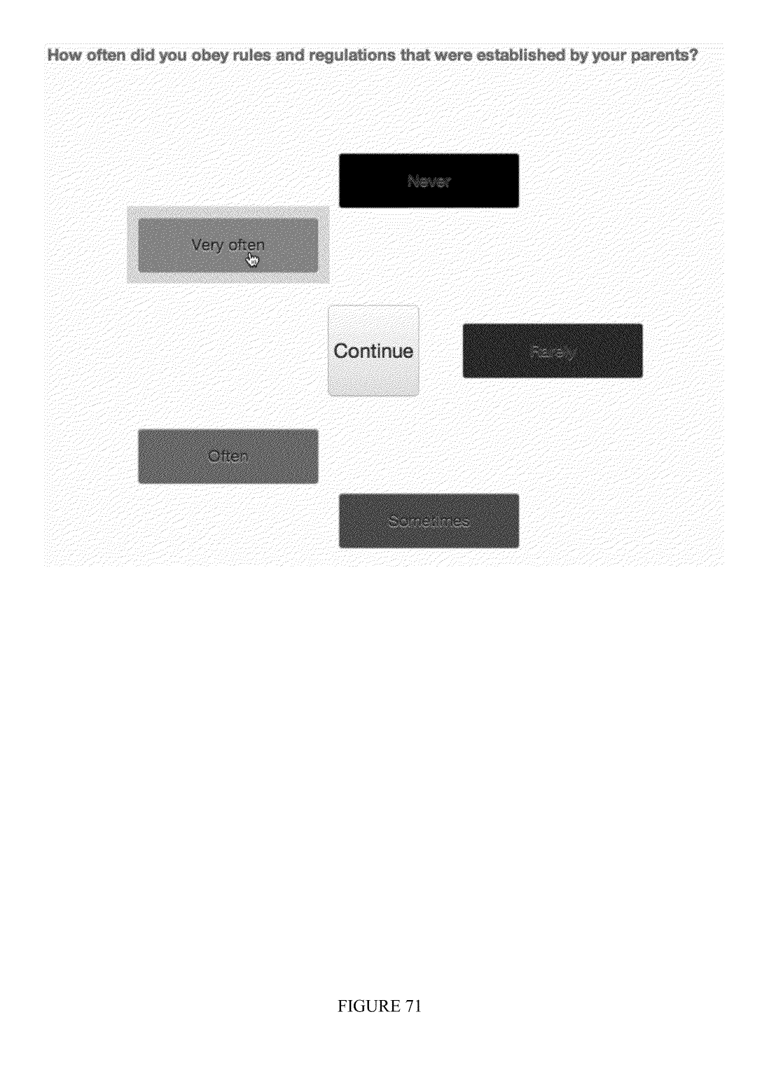

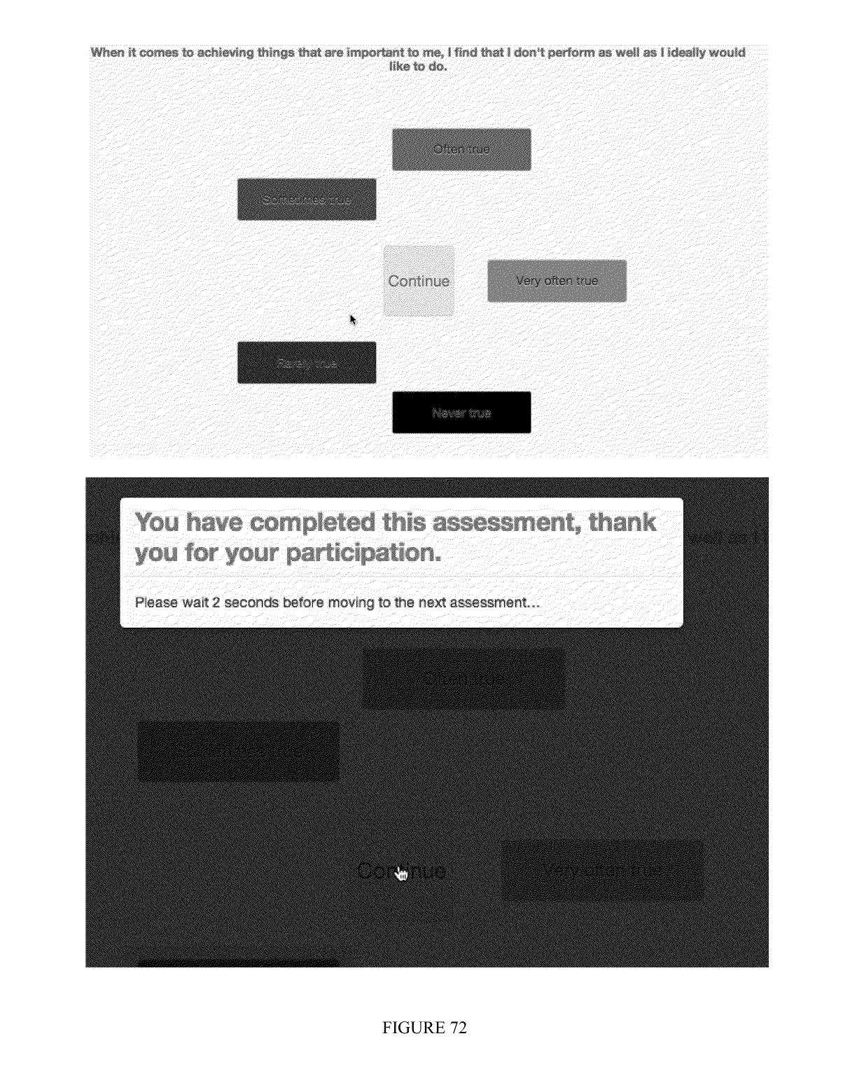

FIG. 11 shows a block diagram illustrating embodiments of an OPA controller. In this embodiment, the OPA controller 1101 may serve to aggregate, process, store, search, serve, identify, instruct, generate, match, and/or facilitate interactions with a computer through behavior assessment technologies, and/or other related data.

Typically, users, which may be people and/or other systems, may engage information technology systems (e.g., computers) to facilitate information processing. In turn, computers employ processors to process information; such processors 1103 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1129 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the OPA controller 1101 may be connected to and/or communicate with entities such as, but not limited to: one or more users from user input devices 1111; peripheral devices 1112; an optional cryptographic processor device 1128; and/or a communications network 1113.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The OPA controller 1101 may be based on computer systems that may comprise, but are not limited to, components such as: a computer systemization 1102 connected to memory 1129.

### Computer Systemization

A computer systemization 1102 may comprise a clock 1130, central processing unit (“CPU(s)” and/or “processor(s)” (these terms are used interchangeable throughout the disclosure unless noted to the contrary)) 1103, a memory 1129 (e.g., a read only memory (ROM) 1106, a random access memory (RAM) 1105, etc.), and/or an interface bus 1107, and most frequently, although not necessarily, are all interconnected and/or communicating through a system bus 1104 on one or more (mother)board(s) 1102 having conductive and/or otherwise transportive circuit pathways through which instructions (e.g., binary encoded signals) may travel to effectuate communications, operations, storage, etc. The computer systemization may be connected to a power source 1186; e.g., optionally the power source may be internal. Optionally, a cryptographic processor 1126 and/or transceivers (e.g., ICs) 1174 may be connected to the system bus. In another embodiment, the cryptographic processor and/or transceivers may be connected as either internal and/or external peripheral devices 1112 via the interface bus I/O. In turn, the transceivers may be connected to antenna(s) 1175, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing OPA controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1129 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the OPA controller and beyond through various interfaces. Should processing requirements dictate a greater amount speed and/or capacity, distributed processors (e.g., Distributed OPA), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the OPA may be achieved by implementing a microcontroller such as CAST's R8051XC2 microcontroller; Intel's MCS 51 (i.e., 8051 microcontroller); and/or the like. Also, to implement certain features of the OPA, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the OPA component collection (distributed or otherwise) and/or features may be implemented via the microprocessor and/or via embedded components; e.g., via ASIC, coprocessor, DSP, FPGA, and/or the like. Alternately, some implementations of the OPA may be implemented with embedded components that are configured and used to achieve a variety of features or signal processing.

Depending on the particular implementation, the embedded components may include software solutions, hardware solutions, and/or some combination of both hardware/software solutions. For example, OPA features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the OPA features. A hierarchy of programmable interconnects allow logic blocks to be interconnected as needed by the OPA system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the OPA may be developed on regular FPGAs and then migrated into a fixed version that more resembles ASIC implementations. Alternate or coordinating implementations may migrate OPA controller features to a final ASIC instead of or in addition to FPGAs. Depending on the implementation all of the aforementioned embedded components and microprocessors may be considered the “CPU” and/or “processor” for the OPA.

### Power Source

The power source 1186 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1186 is connected to at least one of the interconnected subsequent components of the OPA thereby providing an electric current to all subsequent components. In one example, the power source 1186 is connected to the system bus component 1104. In an alternative embodiment, an outside power source 1186 is provided through a connection across the I/O 1108 interface. For example, a USB and/or IEEE 1394 connection carries both data and power across the connection and is therefore a suitable source of power.

### Interface Adapters

Interface bus(ses) 1107 may accept, connect, and/or communicate to a number of interface adapters, conventionally although not necessarily in the form of adapter cards, such as but not limited to: input output interfaces (I/O) 1108, storage interfaces 1109, network interfaces 1110, and/or the like. Optionally, cryptographic processor interfaces 1127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1109 may accept, communicate, and/or connect to a number of storage devices such as, but not limited to: storage devices 1114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1110 may accept, communicate, and/or connect to a communications network 1113. Through a communications network 1113, the OPA controller is accessible through remote clients 1133b (e.g., computers with web browsers) by users 1133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed OPA), architectures may similarly be employed to pool, load balance, and/or otherwise increase the communicative bandwidth required by the OPA controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1110 may be used to engage with various communications network types 1113. For example, multiple network interfaces may be employed to allow for the communication over broadcast, multicast, and/or unicast networks.

nput Output interfaces (I/O) 1108 may accept, communicate, and/or connect to user input devices 1111, peripheral devices 1112, cryptographic processor devices 1128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1111 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1112 may be connected and/or communicate to I/O and/or other facilities of the like such as network interfaces, storage interfaces, directly to the interface bus, system bus, the CPU, and/or the like. Peripheral devices may be external, internal and/or part of the OPA controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the OPA controller may be embodied as an embedded, dedicated, and/or monitor-less (i.e., headless) device, wherein access would be provided over a network interface connection.

Cryptographic units such as, but not limited to, microcontrollers, processors 1126, interfaces 1127, and/or devices 1128 may be attached, and/or communicate with the OPA controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1129. However, memory is a fungible technology and resource, thus, any number of memory embodiments may be employed in lieu of or in concert with one another. It is to be understood that the OPA controller and/or a computer systemization may employ various forms of memory 1129. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1129 will include ROM 1106, RAM 1105, and a storage device 1114. A storage device 1114 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1129 may contain a collection of program and/or database components and/or data such as, but not limited to: operating system component(s) 1115 (operating system); information server component(s) 1116 (information server); user interface component(s) 1117 (user interface); Web browser component(s) 1118 (Web browser); database(s) 1119; mail server component(s) 1121; mail client component(s) 1122; cryptographic server component(s) 1120 (cryptographic server); the OPA component(s) 1135; the Test Generation component 1141, the Assessment component 1142, the Score component 1143, the Environment Intake component 1144, the Report component 1145, and/or the like (i.e., collectively a component collection). These components may be stored and accessed from the storage devices and/or from storage devices accessible through an interface bus. Although non-conventional program components such as those in the component collection, typically, are stored in a local storage device 1114, they may also be loaded and/or stored in memory such as: peripheral devices, RAM, remote storage facilities through a communications network, ROM, various forms of memory, and/or the like.

### Operating System

The operating system component 1115 is an executable program component facilitating the operation of the OPA controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the OPA controller to communicate with other entities through a communications network 1113. Various communication protocols may be used by the OPA controller as a subcarrier transport mechanism for interaction, such as, but not limited to: multicast, TCP/IP, UDP, unicast, and/or the like.

### Information Server

An information server component 1116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the OPA controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the OPA database 1119, operating systems, other program components, user interfaces, Web browsers, and/or the like.

Access to the OPA database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the OPA. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the OPA as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1117 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1118 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the OPA enabled nodes. The combined application may be nugatory on systems employing standard Web browsers.

### Mail Server

A mail server component 1121 is a stored program component that is executed by a CPU 1103. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the OPA.

Access to the OPA mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1122 is a stored program component that is executed by a CPU 1103. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1120 is a stored program component that is executed by a CPU 1103, cryptographic processor 1126, cryptographic processor interface 1127, cryptographic processor device 1128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the OPA may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD₅ hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the OPA component to engage in secure transactions if so desired. The cryptographic component facilitates the secure accessing of resources on the OPA and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The OPA Database

The OPA database component 1119 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the OPA database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the OPA database is implemented as a data-structure, the use of the OPA database 1119 may be integrated into another component such as the OPA component 1135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1119 includes several tables 1119a-1. An employer table 1119a includes fields such as, but not limited to: employer_id, employer_name, employer_address, employer_role_id, employer_role_name, employer_role_description, attributes_ids, weight_values, and/or the like. A candidate table 1119b includes fields such as, but not limited to: candidate_id, employer_id, candidate_name, test_id, assessment_id, score, employer_role_id, and/or the like. A test table 1119c includes fields such as, but not limited to: test_id, test series_id, test questions, attributes_ids, weight_values, widget_id, template_id, and/or the like. An assessment table 1119d includes fields such as, but not limited to: assessment_id, test_id, asseessment_rules, attributes_ids, weight_values, role_id, and/or the like. A score table 1119e includes fields such as, but not limtied to: user_id, client_id, computation_methods, score, test_id, candidate_id, employer_id, employer_role_id, and/or the like. An attributes table 1119f includes fields such as, but not limited to: attributes_id, attributes_name (e.g., criticle thinking, cognitive competencies, team roles and dynamics, motivational orientation, planning and problem solving, attitudes and beliefs, decision making, and/or the like), test_id, weight_values, and/or the like. A candidate template table 1119g includes fields such as, but not limited to: candidate_id, employer_id, test_id, test series_id, result_answer_id, attributes_id, score, and/or the like. A result_answer table 1119h includes fields such as, but not limited to: test_id, candidate_id, test questions, environment_id, test_answers, and/or the like. An environment table 1119i includes fields such as, but not limited to: candidate_id, employer_id, test_id, assessment_id, environment_id, environment_category, environment_score, and/or the like. A role/occupation table 1119j includes fields such as, but not limited to: role_id, employer_id, role_name, role_description, attributes_id, weights values, salary_info, candidate_id, widget_ids, time constrains, and/or the like. A template table 1119k includes fields such as, but not limited to: template_id, widget_ids, template_type, attributes_ids, weight_values, data, role_id, time constrains, and/or the like. A widget table 11191 includes fields such as, but not limited to: widget_id, template_ids, attribute_ids, weight_values, test_id, and/or the like.

In one embodiment, the OPA database may interact with other database systems. For example, employing a distributed database system, queries and data access by search OPA component may treat the combination of the OPA database, an integrated data security layer database as a single database entity.

In one embodiment, user programs may contain various user interface primitives, which may serve to update the OPA. Also, various accounts may require custom database tables depending upon the environments and the types of clients the OPA may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1119a-1. The OPA may be configured to keep track of various settings, inputs, and parameters via database controllers.

The OPA database may communicate to and/or with other components in a component collection, including itself, and/or facilities of the like. Most frequently, the OPA database communicates with the OPA component, other program components, and/or the like. The database may contain, retain, and provide information regarding other nodes and data.

### The OPAs

The OPA component 1135 is a stored program component that is executed by a CPU. In one embodiment, the OPA component incorporates any and/or all combinations of the aspects of the OPA that was discussed in the previous figures. As such, the OPA affects accessing, obtaining and the provision of information, services, transactions, and/or the like across various communications networks.

The OPA transforms candidates occupational test answers and clients occupational goal inputs via OPA components the Test Generation component 1141, the Assessment component 1142, the Score component 1143, the Environment Intake component 1144, the Report component 1145, into candidates occupational assessment outputs.

The OPA component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the OPA server employs a cryptographic server to encrypt and decrypt communications. The OPA component may communicate to and/or with other components in a component collection, including itself, and/or facilities of the like. Most frequently, the OPA component communicates with the OPA database, operating systems, other program components, and/or the like. The OPA may contain, communicate, generate, obtain, and/or provide program component, system, user, and/or data communications, requests, and/or responses.

### Distributed OPAs

The structure and/or operation of any of the OPA node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the OPA controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the OPA controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message do {
  $input = “”;
  $input = socket_read($client, 1024);
  $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENTdatabase
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/Index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

In order to address various issues and advance the art, the entirety of this application for OCCUPATIONAL PERFORMANCE ASSESSMENT APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a OPA individual and/or enterprise user, database configuration and/or relational model, data type, data transmission and/or network framework, syntax structure, and/or the like, various embodiments of the OPA, may be implemented that enable a great deal of flexibility and customization. For example, aspects of the OPA may be adapted for personal financing, new market exploration. While various embodiments and discussions of the OPA have included occupational performance assessment, however, it is to be understood that the embodiments described herein may be readily configured and/or customized for a wide variety of other applications and/or implementations.

What is claimed is:

1. An occupational performance assessment processor-implemented method, comprising:
receiving an occupational psychological assessment request with an occupation profile;
retrieving at least one occupational psychological attribute and a test construction rule with the occupation profile;
retrieving a test template and a test widget that most relevantly match the occupational psychological attribute and the occupation profile;
constructing an occupational psychological assessment test based on the retrieved test template and the test construction rule;
providing the occupational psychological assessment test;
receiving occupational psychological assessment test answers;
calculating an occupational performance score based on the occupational psychological assessment test answers and the occupational psychological attribute; and
generating an occupational performance assessment report including the occupational performance score.

2. The method of claim 1, wherein the occupational psychological assessment request is received from an occupation candidate, a hiring employer, or a social network.

3. The method of claim 1, wherein the occupational psychological attribute includes critical thinking, cognitive competencies, team roles and dynamics, motivational orientation, planning, problem solving, attitudes and beliefs, decision making, cognitive biases executive function, short-term and working memory, reasoning, search and recognition, social cognition, learning, or creativity.

4. The method of claim 1, wherein the occupational psychological attribute includes thinking, engagement, or interaction.

5. The method of claim 1, further comprising:
providing feedback to the occupational psychological assessment test answers during the occupational psychological assessment test;
receiving revised occupational psychological assessment test answers; and
recalculating an occupational performance score and regenerating an occupational performance assessment report based on the revised occupational psychological assessment test answers.

6. The method of claim 1, wherein the at least one occupational psychological attribute is associated with time taken to answer a gamification integrated psychological question.

7. The method of claim 1, further comprising:
receiving a candidate query from an employer to find a candidate that match the occupation profile based on the occupational psychological assessment test answers.

8. The method of claim 1, wherein the occupational psychological assessment test is provided on behalf of an employer.

9. The method of claim 1, wherein the occupational psychological assessment test is aggregated and stored for an employer to search later.

10. The method of claim 1, further comprising:
submitting an occupation application on behalf of a candidate based on the occupational performance assessment report.

11. A processor-readable tangible medium storing processor-issuable digital wallet transaction-related persistent state instructions to:
receive an occupational psychological assessment request with an occupation profile;
retrieve at least one occupational psychological attribute and a test construction rule with the occupation profile;
retrieve a test template and a test widget that most relevantly match the occupational psychological attribute and the occupation profile;
construct an occupational psychological assessment test based on the retrieved test template and the test construction rule;
provide the occupational psychological assessment test;
receive occupational psychological assessment test answers;
calculate an occupational performance score based on the occupational psychological assessment test answers and the occupational psychological attribute; and
generate an occupational performance assessment report including the occupational performance score.

12. The medium of claim 11, further comprising:
receive a candidate query from an employer to find a candidate that match the occupation profile based on the occupational psychological assessment test answers.

13. The medium of claim 11, wherein the occupational psychological assessment test is provided on behalf of an employer.

14. The medium of claim 11, wherein the occupational psychological assessment test is aggregated and stored for an employer to search later.

15. The medium of claim 11, further comprising:
submit an occupation application on behalf of a candidate based on the occupational performance assessment report.

16. The medium of claim 11, further comprising:
provide feedback to the occupational psychological assessment test answers during the occupational psychological assessment test;
receive revised occupational psychological assessment test answers; and
recalculate an occupational performance score and regenerate an occupational performance assessment report based on the revised occupational psychological assessment test answers.

17. An occupational performance assessment processor-implemented system, comprising:
means to receive an occupational psychological assessment request with an occupation profile;
means to retrieve at least one occupational psychological attribute and a test construction rule with the occupation profile;
means to retrieve a test template and a test widget that most relevantly match the occupational psychological attribute and the occupation profile;
means to construct an occupational psychological assessment test based on the retrieved test template and the test construction rule;
means to provide the occupational psychological assessment test;
means to receive occupational psychological assessment test answers;
means to calculate an occupational performance score based on the occupational psychological assessment test answers and the occupational psychological attribute; and
means to generate an occupational performance assessment report including the occupational performance score.

18. The system of claim 17, further comprising:
means to receive a candidate query from an employer to find a candidate that match the occupation profile based on the occupational psychological assessment test answers.

19. An occupational performance assessment processor-implemented apparatus, comprising:
a processor; and
a memory disposed in communication with the processor and storing processor-issuable instructions to:
receive an occupational psychological assessment request with an occupation profile;
retrieve at least one occupational psychological attribute and a test construction rule with the occupation profile;
retrieve a test template and a test widget that most relevantly match the occupational psychological attribute and the occupation profile;
construct an occupational psychological assessment test based on the retrieved test template and the test construction rule;
provide the occupational psychological assessment test;
receive occupational psychological assessment test answers;
calculate an occupational performance score based on the occupational psychological assessment test answers and the occupational psychological attribute; and
generate an occupational performance assessment report including the occupational performance score.

20. The system of claim 19, further comprising:
receive a candidate query from an employer to find a candidate that match the occupation profile based on the occupational psychological assessment test answers.
